(19) United States
(12) Patent Application Publication
(10) Pub. No.: US 2025/0355414 A1
(43) Pub. Date: Nov. 20, 2025

(54) FACILITY CONTROL SYSTEM WITH BLOCK ENERGY HEDGE PROCUREMENT

(71) Applicant: Lineage Logistics, LLC, Irvine, CA (US)

(72) Inventors: Jesse Tootell, San Francisco, CA (US); Elliott Gerard Wolf, San Francisco, CA (US); Alexander James Woolf, San Francisco, CA (US); Nathan Addy, Oxnard, CA (US); Phillip N. Price, Oakland, CA (US); Shawn R. Roberts, Woodinville, WA (US); Clay Campaigne, Oakland, CA (US)

(21) Appl. No.: 19/212,142

(22) Filed: May 19, 2025

Related U.S. Application Data
(60) Provisional application No. 63/649,693, filed on May 20, 2024.

(51) Int. Cl. G05B 13/04; G06Q 40/04; G06Q 50/06

(52) U.S. Cl. CPC G05B 13/048; G06Q 40/04; G06Q 50/06

(57) ABSTRACT

Disclosed are techniques for system for controlling components in a facility based on energy hedges. The system can include a controller to control the components in the facility. The controller can perform a process including: receiving pre-purchased energy hedge information for a period of time, monitoring real-time energy market conditions based on real-time energy information from an energy grid data source, generating component control instructions based on current operating conditions, energy capacity of the facility, the pre-purchased energy hedge information, and the monitored real-time energy market conditions, and executing the component control instructions to cause the components in the facility to perform the operational tasks. The pre-purchased energy hedge information can be determined based on predicting block energy hedges for the period of time and purchasing at least a portion of the predicted block energy hedges for that time.

### INCORPORATION BY REFERENCE

This application claims the priority benefit of U.S. Provisional Patent Application No. 63/649,693, filed May 20, 2024, the entirety of which is incorporated by reference herein.

### TECHNICAL FIELD

This document generally describes devices, systems, methods, computer-automated techniques, and graphical user interfaces (GUIs) related to controlling components in a facility based on modeling block energy hedges (e.g., fixed-price forward energy contracts) and facility loads in energy markets.

### BACKGROUND

Facilities, such as buildings, warehouses, factories, storage facilities, and others can consume significant amounts of energy as part of their operation. For example, storage facilities, such as warehouses, distribution centers, or other type of facilities that manage, maintain, and/or move various types of items, cases of items, and/or pallets of cases or items, may use energy to regulate temperature and to operate machinery (e.g., automated and robotic systems, forklifts) within the storage facility. The items stored in the storage facility can be temperature-sensitive, and can include goods and/or products including but not limited to fresh produce, meats, vegetables, other food items, perishable and/or non-perishable food items, and/or other types of non-food items (e.g., furniture, clothes, home products). The storage facility can have an automated implementation (e.g., operations within the facility are performed by robots and other autonomous vehicles), a manual implementation (e.g., operations are performed by human workers), and/or a semi-automated implementation (e.g., operations are performed by both autonomous vehicles and human workers). The storage facility can include various components that allow for operations to be performed therein. For example, the components can include energy sources, including but not limited to solar arrays, generators, batteries, and/or electrical power from one or more grids. The storage facility can include components that consume energy, including but not limited to compressors, cooling systems, other refrigeration systems, and/or vehicles and/or human workers that perform operations in the facility more generally. The storage facility can produce and consume energy in order to perform operations.

The facility can buy and sell energy in one or more energy markets. That energy can be used by components or assets in the facility to perform operations, including but not limited to loading and unloading trucks of items, routing the items around the facility to respective storage locations, preparing orders of items to be delivered to respective customers, and maintaining adequate temperatures for storage of items. The facility can buy and/or sell energy that is derived from natural gas, an energy grid, and/or renewable or nonrenewable resources. The resources used to generate power at the utility scale may be volatile. The volatility of such energy resources can cause volatility in the energy market, such as unpredictable swings in energy price and/or supply. Energy price and/or supply can also vary over time based on known and/or unknown factors (e.g., temperature, wind output, fuel costs, power plant availability, tariffs, wars, weather conditions, storms, changes in demand, changes in supply, grid infrastructure congestion). Sometimes, energy price and/or supply can suddenly change in the market without warning, which can impact an ability of the facility, and other energy consumers more generally, to fulfill its operations and maintain overall operations at a desired or expected performance level for the facility or operate the facility at acceptable cost.

### SUMMARY

The document generally describes technology for modeling block energy hedges (e.g., energy futures contracts) over one or more period of times as an optimization tool to procure energy for a facility (e.g., storage facility, cold storage facility, warehouse, distribution center). The disclosed optimization tool can be used to quantify risk associated with purchasing and/or consuming block energy hedges over the one or more periods of time. Such risk analysis can be used to determine whether, when, and to what extent to purchase block energy hedges. Recommendations for purchasing block energy hedges can further and optionally be used by the facility for use in controlling components and adjusting operational schedules in the facility to attain operational, energy, and cost efficiency objectives of the facility.

More particularly, a variety of data and information about the facility, operational schedules, customers, weather patterns and conditions, historic energy market information, current energy market information, forward energy prices, etc. can be provided as input to a machine learning, statistical, and/or time-series model, and/or Bayesian methods. The model can be trained to generate output indicating forecasted or projected energy market conditions, such as block energy hedge premiums and/or amounts over one or more periods of time (e.g., past, current, and/or upcoming days, weeks, months, and/or years). The model output can be used by a computer system to determine preferred and/or recommended block energy hedge amounts to purchase and/or sell for the facility over the periods of time such that the facility may achieve its operational and/or energy efficiency objectives over such periods of time. Additionally, these models can provide insight into best times to purchase said energy hedges as the price of forward commodity markets fluctuate through time.

The disclosed technology may also be extended to improve operational and energy efficiencies in the facility in some implementations. For example, the computer system (or another computer system associated with the facility) can determine that particular components in the facility, such as batteries, should be charged in advance of anomalously high energy market prices, such as those resulting from an energy crisis, projected using the disclosed optimization tool so that if and when the energy crisis occurs, the facility can sell back stored energy to an energy market (e.g., energy grid) and make revenue off that sale.

As another illustrative example, the computer system can use outputs from the disclosed optimization tool to determine whether or not the facility should deactivate particular components (e.g., refrigeration systems, blast cells, other cooling systems) during hottest peak hours at the facility (e.g., during summer afternoons in Texas when energy prices are highest or otherwise high) and then reactivate those components during coolest off peak hours at the facility (e.g., at the middle of the night, early mornings during the week and/or weekend). Various other determinations can be made by the computer system and based on output, recommendations, or other information generated using the disclosed optimization tool.

The model output, the recommendations, and/or the determinations made by the computer system can be provided in graphical user interfaces (GUIs) presented at computing devices of relevant users associated with the facility (or other facilities). The GUIs can provide visual and graphical elements indicating the forecasted/projected energy market trends, operations and/or energy efficiencies of the facility, recommended block energy hedge purchases (and/or sales), and/or one or more recommended component controls and/or schedule/operational adjustments. The GUIs can also provide user-selectable features to allow the relevant users to interact with the information presented in the GUIs and/or to make adjustments to forecasted or other determined information, such as by adjusting a particular facility's risk tolerance level, energy price parameter, energy load parameter, price-load correlation parameter, etc.

The disclosed techniques can be related to various types of energy, including but not limited to renewable energy (e.g., wind, solar) and/or deregulated energy markets. Renewables can play a role in hedging those markets. The disclosed techniques may also be applied to grid energy, which can include a mix of different energy/fuel sources, including but not limited to natural gas, nuclear, wind, solar, and/or coal.

One or more embodiments described herein can include a system for controlling components in a facility based on energy hedges. The system can include a controller that can be configured to control the components in the facility. The controller can include processors and memory storing instructions that, when executed by the processors, may cause the controller to perform a process that can include: receiving pre-purchased energy hedge information for a period of time, monitoring real-time energy market conditions based on real-time energy information from an energy grid data source, generating component control instructions based on current operating conditions, energy capacity of the facility, the pre-purchased energy hedge information, and the monitored real-time energy market conditions, and executing the component control instructions to cause the components in the facility to perform the operational tasks.

The system can optionally include one or more of the following features. For example, the controller can generate the pre-purchased energy hedge information based on: receiving facility information and energy market conditions information for a predetermined period of time, retrieving, from a data store, a model that was trained to predict energy market conditions over a future period of time, providing, to the model, at least a portion of the received information as input, receiving, from the model, output indicating the predicted energy market conditions over the future period of time, the model having been trained to predict block energy hedges over the future period of time and quantify energy prices based on the predicted block energy hedges, generating, based on the output, recommendations for purchasing or selling a portion of the predicted block energy hedges over the future period of time, and returning the recommendations for purchasing the portion of the predicted block energy hedges over the future period of time. Returning the recommendations can include: transmitting, to a user device, the recommendations and at least a portion of the predicted energy market conditions, the user device being configured to present, in the GUIs, the recommendations, the at least portion of the predicted energy market conditions, and a recommendation to purchase a predetermined quantity of the predicted block energy hedges over the future period of time. Based on the model output, the process further can include: determining, based on identifying that the facility is operating at or below a facility operational set point, (i) a quantity of the predicted block energy hedges to buy in the energy market and (ii) a segment of time over the future period of time at which to buy the quantity of the predicted block energy hedges.

Sometimes, the model could have been further trained to generate output indicating predicted facility load over the future period of time. The process can also include determining (i) timing, (ii) quantity, and (iii) cost for purchasing the predicted block energy hedges based at least in part on a joint probability of block energy hedge price and facility load distributions over the future period of time. Sometimes, the process can include determining at least one of (i) a facility operational setpoint to reduce facility load over the future period of time and (ii) component operational setpoints to reduce respective component loads over the future period of time. As another example, the process can include determining, based on monitoring the real-time energy market conditions, an upcoming energy event, the upcoming energy event being at least one of an energy shortage and an energy surplus in the energy market, generating, based on the upcoming energy event and the current operating conditions, a recommendation for a facility adjustment to maintain facility operations at or below a predetermined facility operational setpoint during a time corresponding to the upcoming energy event, and returning the recommendation to a centralized controller of the facility for automatic execution by components in the facility. Generating the recommendation can include determining a threshold amount of energy usage to cut during the time corresponding to the upcoming energy event. Generating the recommendation can include determining a threshold quantity of energy hedges of the facility to sell back to the energy market while maintaining execution of the facility operations at or below the predetermined facility operational setpoint. Generating the recommendation can include determining a threshold quantity of energy hedges to store during the time corresponding to the upcoming energy event to maintain execution of the facility operations at or below the predetermined facility operational set point.

In some implementations, the pre-purchased energy hedge information can be based on historic energy hedges that were purchased for the facility over a past period of time, operational tasks and facility energy consumption during the past period of time, and energy market conditions during the past period of time. The process further can include determining instructions to purchase or sell energy hedges based on the current operating conditions, the energy capacity of the facility, the pre-purchased energy hedge information, and the monitored real-time energy market conditions. Sometimes, the instructions further can include a duration of time for which the energy hedges are purchased or sold. Generating the component control instructions can include determining a duration of time for controlling the components at a threshold level of the energy capacity of the facility.

The controller can also be configured to receive facility information and energy market conditions information, the facility information indicating an amount of energy that was used to control the components in the facility to perform the operational tasks, determine a quantity of energy hedges to sell back to the energy market based on the amount of energy that was used to control the components in the facility to perform the operational tasks and the market conditions information, and return a recommendation to sell the quantity of the energy hedges back to an energy market over a future period of time. Executing the component control instructions can include adjusting a cooling unit of a refrigeration system to maintain temperature in a first set of storage locations in the facility at or below a threshold temperature level for the period of time. The refrigeration system can also be configured to draw a quantity of energy that is stored by an energy storage system of the facility based on the pre-purchased energy hedge information. Sometimes, executing the component control instructions can include controlling a refrigeration system using energy that can be stored by an energy storage system to maintain ambient threshold temperature conditions in the facility in response to predicting an energy shortage over a future period of time. Executing the component control instructions can include activating a blast cell to perform item freezing operations using energy that may be stored by an energy storage system in response to detecting an energy surplus in the energy market.

One or more embodiments described herein can include a method, process, and/or system for quantifying risk of block energy hedge pricing for a facility using computer-based modeling of energy market conditions. The system, for example, can include: a data store that can be configured to store information about a facility, and a computer system in network communication with the data store. The computer system can include processors that can be configured to execute instructions that cause the computer system to perform a process including: receiving, from at least one of a controller in the facility, the data store, an energy market computing system, or a user device, facility information and energy market conditions information for a predetermined period of time, retrieving, from the data store, at least one model that was trained to predict energy market information over a future period of time, providing, to the at least one model, at least a portion of the received information as input, receiving, from the at least one model, output indicating the predicted energy market information over the future period of time, the at least one model having been trained to predict block energy hedges over the future period of time and quantify energy price risks based on the predicted block energy hedges, generating, based on the output, one or more recommendations for purchasing at least a portion of the predicted block energy hedges over the future period of time, and returning at least the one or more recommendations for purchasing the at least a portion of the predicted block energy hedges over the future period of time.

In some implementations, the embodiments described herein can optionally include one or more of the following features. Returning at least the one or more recommendations can include: transmitting, to a user device, the one or more recommendations and at least a portion of the predicted energy market information, the user device being configured to present the recommendations and the at least portion of the predicted energy market information in the GUIs. In response to presenting the output in the GUIs, the user device can further be configured to receive user input indicating instructions to buy a predetermined quantity of the predicted block energy hedges over the future period of time. The process performed by the computer system further can include: determining, based on the model output and identifying that the facility is operating at or below a facility operational set point, (i) a quantity of the predicted block energy hedges to buy in the energy market and (ii) a time period over the future period of time at which to buy the quantity of the predicted block energy hedges. The at least one model can be trained to generate output indicating predicted facility load over the future period of time based on the input.

As another example, the process performed by the computer system further can include: determining, based on the model output and facility operational information received from at least the controller in the facility, one or more recommended actions for the facility over the future period of time. Determining the one or more recommended actions for the facility over the future period of time can include: determining (i) timing, (ii) quantity, and (iii) cost for purchasing the predicted block energy hedges based at least in part on analyzing joint probability of block energy hedge price and facility load distributions over the future period of time. Determining the one or more recommended actions for the facility over the future period of time can be based on determining at least one of (i) a facility operational set point to reduce facility load over the future period of time and (ii) component operational set points to reduce respective component loads over the future period of time.

The process performed by the computer system further may include: receiving, from a user device and based on presenting the one or more recommendations in the GUIs, user input indicating one or more optimization parameters or adjustments to the output from the at least one model, and providing the user input as additional inputs to the at least one model to generate updated output indicating updated predicted energy market information over the future period of time. The at least one model can be iteratively trained based on at least one of the user input and the updated output. The optimization parameters can include at least one of: user-determined energy price tolerance ranges, user-determined load forecasting tolerance ranges, user-determined price uncertainty tolerance ranges, user-determined load uncertainty tolerance ranges, user-determined price-load correlation tolerance ranges, or user-determined risk tolerance ranges.

As another example, the computer system can further be configured to perform a process including: determining, based on the received information, an upcoming energy event, the upcoming energy event being at least one of an energy shortage or an energy surplus, determining, based on the upcoming energy event and the received information, at least one recommendation for a facility adjustment to maintain facility operations at or below a predetermined facility operational set point during a time corresponding to the upcoming energy event, and returning the at least one recommendation to a centralized controller of the facility. Sometimes, determining at least one recommendation for a facility adjustment can include determining a recommendation for a threshold amount of energy consumption to cut during the time corresponding to the upcoming energy event. Determining at least one recommendation for a facility adjustment may include determining a threshold quantity of the predicted block energy hedges of the facility to sell back to the energy market at a profit while maintaining the facility operations at or below the predetermined facility operational set point. Determining at least one recommendation for a facility adjustment may include determining a threshold quantity of the predicted block energy hedges of the facility to keep during the time corresponding to the upcoming energy event to maintain the facility operations at or below the predetermined facility operational set point.

As another example, the at least one model can be a state-based model. The energy market conditions information can include at least one of energy supply data, energy demand data, energy price data, or energy generation data. The energy market conditions information can correspond to at least one of a present period of time or a past period of time. The computer system can include a centralized controller of the facility that may be configured to generate controls for completing operations in the facility based on the one or more recommendations. The facility information and the energy market conditions information can include at least one of historic facility operational data, historic energy market data, block hedge energy prices, future commodity procurement information, facility load profiles, optimization parameters, or weather data. In some implementations, the optimization parameters can include user-inputted information indicating at least a risk tolerance level of the facility, the risk tolerance level identifying a predetermined amount of risk that the facility can take in buying the predicted block energy hedges during volatile energy market conditions.

In some implementations, the facility information and the energy market conditions information can be received from a user device as user input, and the facility information and the energy market conditions information can include the future period of time, the future period of time being defined by the user input. Sometimes, returning the one or more recommendations can include presenting, in a GUI at a user device, the predicted energy market information over the future period of time in a graph, the graph indicating historic energy market information for the facility and the predicted energy market information. Presenting the graph in the GUI can include: receiving user input indicating a hovering action over a portion of the graph, and in response to receiving the user input, presenting, in the GUI, a pop-out window outputting information that can correspond to the hovered-over portion of the graph. The information that may correspond to the hovered-over portion of the graph can include a month corresponding to the hovered-over portion of the graph, a block energy hedge price corresponding to the hovered-over portion of the graph, a day having maximum cost per usage of energy, a day having minimum cost per usage of energy, and a day having median cost per usage of energy. In some implementations, the information that may correspond to the hovered-over portion of the graph can include a block energy hedge price corresponding to the hovered-over portion of the graph, an expected cost per usage of energy, and predicted percentiles of cost per usage of energy for a time corresponding to the hovered-over portion of the graph.

The devices, system, and techniques described herein may provide one or more of the following advantages. For example, the disclosed technology enables a facility to maximize its operational resiliency. Predictively forecasting fluctuations in the energy market can also be used as inputs to intelligently and automatically control energy assets in the facility to help the facility proactively plan for potential volatility or other unexpected changes in the energy market (e.g., blackouts and/or brownouts, changes in supply and/or demand, changes in price).

The disclosed technology also provides technical improvements to how energy procurement and facility operations are managed. The disclosed technology solves at least the following technical problems: (i) inaccuracies in forecasting energy procurement needs where traditional procurement systems do not account for facility operations and/or real-time risks, (ii) inefficiencies in energy usage in complex facilities such as warehouses or cold storage facilities having fluctuating energy needs, and/or (iii) manual or heuristic block energy purchasing, which lacks precision and does not adapt to changing operational and/or market conditions. The disclosed technology provides at least the following technical solutions to said technical problems: (i) a dynamic optimization model that integrates time-based modeling of energy consumption and external conditions, uses quantifiable risk metrics for improved and accurate decision-making, and aligns purchasing recommendations with actual facility operations, (ii) an automated control feedback loop, where recommendations are used for controlling facility components and optimizing operational schedules, thereby tying together physical operations with modeled outcomes, and/or (iii) improved energy efficiency, in which this technology impacts how hardware systems run, thereby reducing energy waste through better-timed operations in a real-world technical outcome.

In addition to providing technical improvements to technical problems, the disclosed technology provides additional computer hardware improvements. For example, the disclosed technology can include specialized risk-analysis modules, which can include custom algorithms for energy futures modeling that improves computational efficiency in simulating real-time procurement decisions and generating recommendations for not only purchasing or selling energy hedges, but also controlling components in a facility based on the energy hedges. The disclosed technology also provides integration with facility control systems and facility components, including but not limited to sensors, actuators, warehouse management systems (WMSs), refrigeration units, blast cells, cooling units, heating units, forklifts, automated machines, lifts, cranes, etc. Moreover, the disclosed technology provides a real-time performance feedback loop such that the disclosed technology can self-adjust based on observed consumption versus predicted energy consumption, thereby resulting in an adaptive system that is more than simply generic computing.

Moreover, the disclosed technology can be extended to allow for coordination of component operations in the facility to achieve performance (e.g., energy consumption, energy production, energy cost, carbon emission) efficiencies in the facility over various different timeframes (e.g., short, medium, long). Facility-level controllers can control respective components in the facility in real-time based on predictions and/or forecasts of energy prices and/or availability over the various different timeframes. Signals associated with these control schemes can be transmitted to a computer system or centralized controller, which can process the signals using machine learning techniques to determine or recommend operations for optimizing the control schemes of the facility components relative to each other and in light of balancing short, medium, and/or long-term optimization goals of the facility as a whole. The computer system or centralized controller associated with the facility can instruct any of the facility-level controllers to adjust their control schemes accordingly. Furthermore, controls can be generated that leverage the facility itself as an active energy asset, thereby treating the facility and its components as thermal batteries to charge and discharge within safe operating temperatures and other operating conditions based on predicted or forecasted energy market conditions. The components in the facility can be transformed into energy prosumers (consumes and produces power). With the disclosed technology, control operations of the components in the facility can be streamlined and balanced to achieve short, medium, and/or long-term optimization goals of the facility as a whole.

Similarly, the disclosed technology provides for the processing and analysis of various different signals to be outsourced to a computer system, thereby permitting facility-level controllers to continue performing lightweight processing and real-time control scheme/operation determinations (e.g., turning on a refrigeration system when a particular location in the facility reaches a threshold temperature value, charging a battery array when the battery array reaches a charge that is less than a threshold charge value). As a result, the facility-level controllers can maintain the components in the facility at predetermined or expected performance levels in real-time to ensure optimization and continuous operation of the facility. The computer system can perform heavyweight processing as signals are received in real-time and/or near real-time from the facility-level controllers or other sources described herein. The computer system can adaptively predict and forecast energy market conditions and, accordingly, determine control scheme/operations updates for any of the components in the facility that balance performance optimization of the individual components, performance optimization of the facility as a whole, and the predicted or forecasted energy market conditions over various different timeframes. Furthermore, latency can be minimized by employing an hierarchical architecture of multiple computer systems and/or controllers, where each computer system and/or controller can be responsible for some quadrant of predictions, forecasting, and/or control schemes at the facility. As a result, tasks can be bifurcated and processing power can be offloaded to the various system components to improve proficiency, efficiency, accuracy in determinations being made for the facility during the various timeframes.

The disclosed technology also provides for iterative model generation and training using machine learning and/or statistical modeling techniques to improve accuracy of the determinations being made by the disclosed computer systems and/or controllers. The computer system, for example, can iteratively improve the models and/or algorithms that are used to predict block energy hedge prices and/or generate recommendations for when to purchase the block energy hedges.

Similarly, model output and user input in response to the model output can be used to iteratively adjust determined recommendations and/or projected conditions in the energy market. User inputs can be used as weights to dynamically adjust one or more predictions and/or recommendations made using the techniques described herein. Using the user input as weights can advantageously and efficiently utilize available compute resources and processing power so that determinations can be made in real-time or near real-time as conditions change in the facility, energy grid, and/or energy markets. As a result, the facility can readily adapt to such changes to continue operating as efficiently as possible.

The architecture of the disclosed technology also may allow for the technology to be easily adapted and/or retrofitted to wide variations of facilities without requiring additional customization of the architecture. For example, the computer system can be easily fitted into existing control systems architecture at the facilities to accurately and efficiently predict energy market conditions while also communicating with facility-level controllers to receive control signals and manage operations in the facility as a whole. The disclosed technology can be easily and quickly plugged into existing facilities for realization of immediate and/or long-term performance optimization goals. The architecture of the disclosed technology also can allow for collaboration of multiple software stacks that can be hosted independently at various levels of control and operation of the facility. For example, through API communications, tools such as energy cost and demand prediction models and other forecasting models/software tools can be seamlessly integrated to control and optimize operations in the facility.

The disclosed technology may employ state-space modeling techniques and/or statistical/time-series modeling techniques to efficiently and accurately predict and forecast volatile energy market conditions. Such modeling techniques can also be used to quantify risk associated with projected energy market conditions, which can be used by relevant users and/or the computer system to determine how best to avoid or manage such risk. Because state-space modeling can be performed based on initial conditions, such modeling does not require additional inputs, such as all conditions or variables associated with the facility. By knowing and analyzing the initial conditions of the facility, such modeling techniques can advantageously estimate future values, outputs, and/or conditions of the facility. These modeling techniques can process less information than other models, thereby improving processing time, reducing use of compute resources, and providing for fast and efficient determinations to be made. Statistical and/or time-series modeling can also provide more insight into controllability of the facility, which can further improve ability to generate accurate recommendations for controlling the facility in ways that optimize performance and efficiency of the facility. The model output can provide insight into how much and to what extent aspects and/or functionality of the facility are controllable. State-space modeling can also apply to a variety of types of dynamic facilities. This means that the state-space modeling techniques can be used to analyze various dynamic facilities like linear systems, non-linear systems, time-variant systems, and/or time-invariants systems. Accordingly, such modeling techniques provides improved ability to accurately assess facilities and energy markets to generate accurate recommendations and controls for optimizing performance, operations, and energy usage in a respective facility.

To provide robust predictions and risk quantification, the disclosed technology can use a complex collection of algorithms, models, and/or machine learning to analyze data related to at least one parameter (e.g., conditions of a facility) for a facility to inform users associated with the facility of trending market conditions and/or energy consumption. This complex collection of algorithms, models, and/or machine learning can provide an unconventional solution to the problem of trying to predict volatile energy market conditions and risk. This unconventional solution can be rooted in technology and provides information that was not available in conventional systems. This unconventional solution also represents an improvement in the subject technical field otherwise unrealized by conventional systems. Specifically, unlike conventional systems, the disclosed technology may dynamically predict, quantify, and iteratively update predictions of market conditions, effects of the market conditions on facilities, etc.

After the disclosed technology predicts energy market conditions and quantifies risk associated with the conditions and/or hedges, the disclosed technology can display relevant information and data using a GUI on a display of computing devices of the relevant users in a unique and easy to understand format. Conventional systems may not provide the disclosed solutions for at least the following reasons: (i) the significant processing power required for to continuously predicting market conditions and risk in further light of facility operations in real-time or near real-time, (ii) the considerable data storage requirements for maintaining information collected and determined by the disclosed technology, (iii) a large enough pool of parameter data to provide accurate thresholds for the disclosed algorithms, models, and/or machine learning, (iv) algorithms, models, and/or machine learning that allow for the thresholds to be self-updated in light of additional data that can be added to the pool of relevant parameter data, and/or (v) other hardware and software features discussed herein.

Additionally, translation of outcomes from these complex algorithms, models, and/or machine learning through the GUI onto information displayed for a user improves comprehension of considerable quantities of highly processed data. For example, an exemplary algorithm from this complex collection of algorithms can require: taking inputs from multiple sensors, selecting some data provided by the sensors, ignoring some of the data that was provided by the sensors, performing multiple calculations on a selected subset of the data, combining the data from these multiple calculations and then outputting that data within a short amount of time (e.g., preferably less than a minute), all for multiple relevant users. Similarly, the disclosed techniques can require analyzing millions of data points to find similarities amongst market conditions, hedges, and/or facilities, determining the parameters associated with the different market conditions, hedges, and/or facilities, determining how these parameters change over time to identify severity and/or risk associated with the different market conditions, obtaining additional data for determining how facility operations may be impacted by (or otherwise impact) the different market conditions, generating and outputting information to the relevant users based on the parameters, the different market conditions, the quantified risk, etc., and then repeating the above operations over a relatively short time period (e.g., every day, every half day, every hour, every 10 minutes, every 5 minutes, every 1 minute) and for many different facilities.

The details of one or more implementations are set forth in the accompanying drawings and the description below. Other features and advantages will be apparent from the description and drawings, and from the claims.

### BRIEF DESCRIPTION OF THE DRAWINGS

FIG. 1A is a conceptual diagram of a system for forecasting, purchasing, and selling block energy hedges.

FIG. 1B is a conceptual diagram of a system for forecasting block energy hedges and optionally determining facility controls based on the forecasting.

FIG. 1C is a conceptual diagram of a system for automated control and assessment of operations in a facility to achieve performance optimization objectives of the facility.

FIG. 1D is a conceptual diagram of a system for controlling a facility based on forecasting, purchasing, and selling block energy hedges.

FIGS. 2A and 2B are system diagrams of one or more components that can be used to perform the disclosed techniques.

FIGS. 3A, 3B, and 3C is a flowchart of a process for forecasting block energy hedges and generating recommended facility controls based on the forecasting.

FIGS. 3D and 3E is a flowchart of a process for controlling a facility based on forecasted block energy hedges.

FIG. 4 is a flowchart of a process for forecasting block energy hedges based on user-inputted optimization parameters.

FIG. 5 is a flowchart of a process for adjusting schedules for purchasing and selling block energy hedges based on continuous identification of current and/or upcoming events associated with a facility.

FIGS. 6A, 6B, and 6C illustrate example graphical user interfaces (GUIs) that can be generated and provided at relevant users' computing devices to present information about forecasted block energy hedges.

FIGS. 7A and 7B illustrate example graphical fields for optimization parameters that can be inputted by a relevant user to adjust forecasting block energy hedges.

FIG. 8 illustrates an example GUI for presenting forecasted multi-month energy exposure of a particular facility.

FIGS. 9A and 9B illustrate example GUIs for presenting energy price forecasts for a particular facility.

FIG. 10 illustrates an example GUI for presenting load forecasting information for a particular facility.

FIG. 11 illustrates an example GUI for presenting energy hedge trends for a particular facility.

FIGS. 12A and 12B illustrate example use cases of energy loads, hedges, and energy cost during an energy crisis.

FIG. 13 is a schematic diagram that shows an example of a computing device and a mobile computing device.

Like reference symbols in the various drawings indicate like elements.

### DETAILED DESCRIPTION OF ILLUSTRATIVE EMBODIMENTS

This document generally relates to systems, methods, technology, and techniques for modeling energy hedges over one or more periods of time, which can be used as an optimization tool for any facility (e.g., storage facility, warehouse, distribution center, cold storage facility) to determine hedging strategies, and optionally control facility components and operational schedules to achieve energy efficiency and/or operational objectives. The disclosed technology can provide these techniques through a tool that can be launched in GUIs at a relevant user's computing device. The GUIs can present graphical and other visual elements indicating forecasted or projected energy market trends, recommendations for hedging strategies, and other determinations made using the disclosed technology.

As described herein, a computer system can provide various data to a machine learning model, including but not limited to historic and/or current block energy prices, hedges bought against market volatility, forward energy market curves, future commodity procurements ahead of time for one or more future periods of time, historic energy information for a particular facility, historic energy load profile(s) for the facility, facility schedules and/or operations, and/or energy resource information (e.g., wind, solar, natural gas). The model can be any type of model, such as a state-space model, statistical/time-series model, optimization model, and/or forecasting model that is trained and iteratively trained with machine learning techniques to process the data from the computer system and generate output indicating forecasted or projected energy market trends (e.g., block energy hedges, energy prices, energy market trends, weather conditions) for one or more periods of time. Insights derived from the model can be used by the computer system and/or the relevant user(s) to determine actions such as when to buy and/or sell block energy hedges, when and/or how to adjust controls of components in the facility in light of the energy market trends, and/or when and/or how to adjust facility operations and/or schedules in light of the forecasted energy market trends.

In an illustrative example, if a facility buys a block hedge, they can buy a month of power in advance at a fixed price. During that month, any time the facility uses more than the hedged power, they may be buying additional power on the spot market, and any time they are using less than the hedge, they can be effectively selling power on the spot market. Buying a hedge can protect the facility against high spot prices, but may cost more if the spot price turns out to be lower than the hedge price. If the facility does not buy a hedge then they may be exposed to the risk that the spot price in the month in question might be very high. The facility can eliminate this risk by buying a large spot price that may be guaranteed to cover their power needs for the month. However, this may also expose the facility to risk in the opposite direction: the spot price might end up being lower than the price they paid for the hedge. The optimal hedge quantity can depend on the cost of the hedge (per megawatt-hour); a statistical distribution of possible mean spot prices for the month (cost per megawatt-hour), a statistical distribution of possible electricity demand during the month (the number of megawatt-hours), and the facility's risk tolerance.

Additionally, an optimal decision can depend on a statistical relationship between electricity consumption and spot price within the month. Suppose the facility has anticipated their electricity consumption over the course of the month and bought a block hedge that covers that amount. Any time the facility uses more than that purchased amount, they are buying extra; any time they uses less they are selling. Thus, in addition to the statistical distribution of mean monthly spot prices and mean monthly electricity consumption for the month being considered, how the prices and consumption might vary within the month may also be important. Statistical distributions can therefore be determined by fitting statistical models to historical data and using the results to generate futures. For example, the disclosed technology provides a statistical model for forecasting energy consumption (e.g., electric load). This can be a time series model, in some implementations, that can extrapolate from the electric load in the past. The model can automatically make use of annual patterns (e.g., if the electric load is usually higher in the summer than in the winter when this pattern will be assumed to continue into the future). The disclosed technology also can provide a statistical model for forecasting spot prices. This model can combine a time series model with an explanatory variable(s). The hedge price, for example, can be treated as a forecast of the spot price.

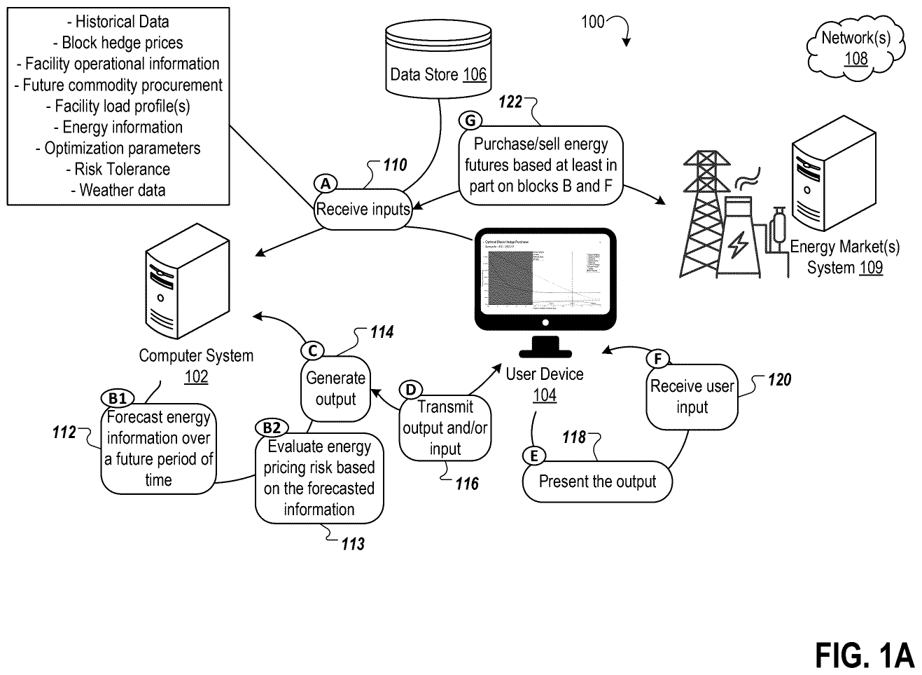

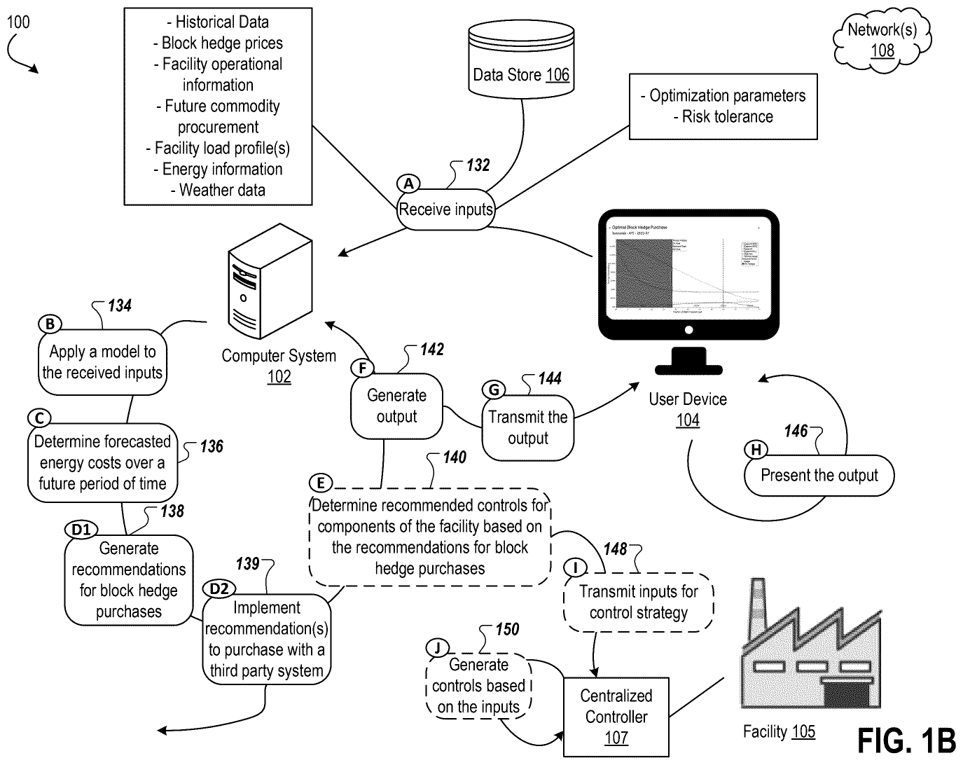

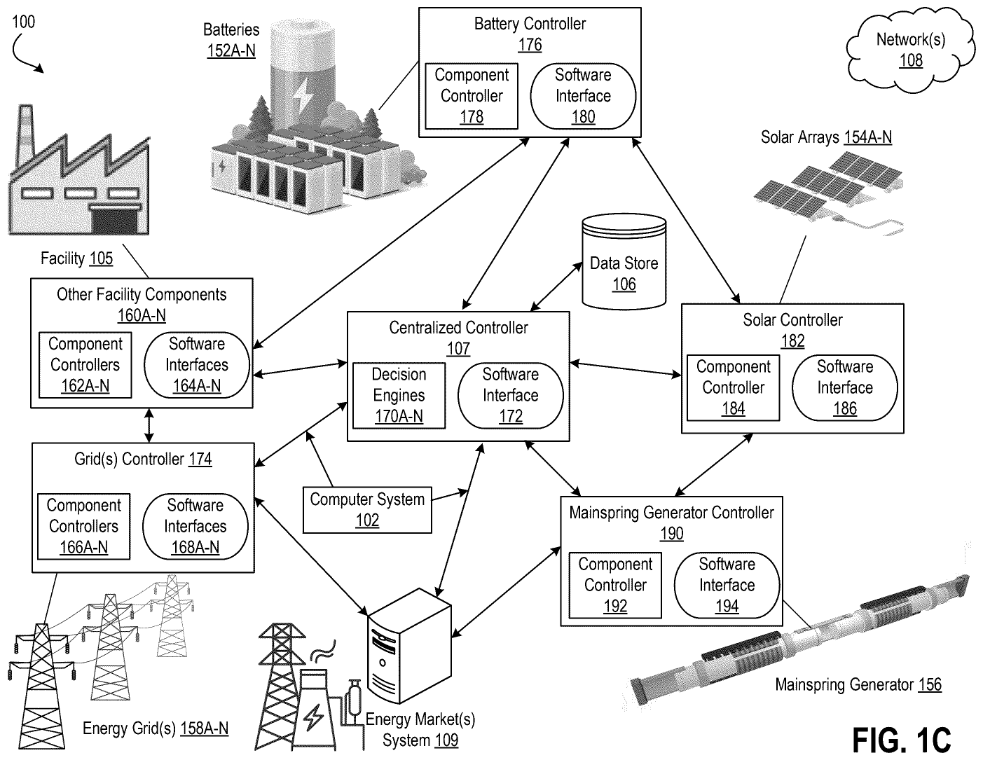

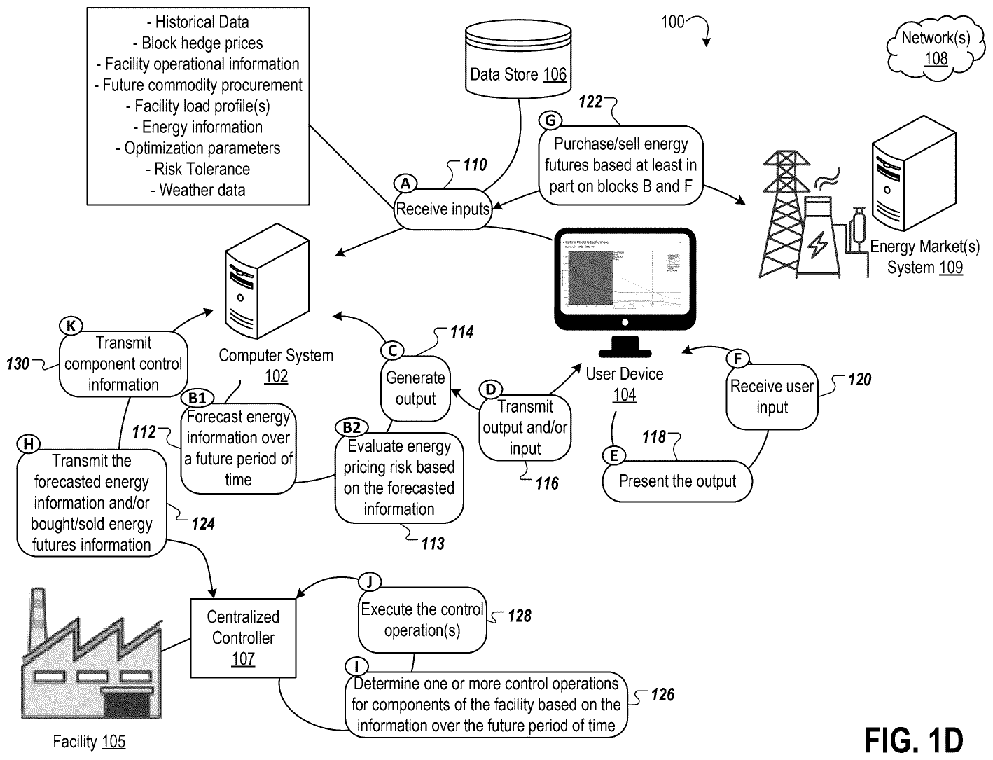

Referring to the figures, FIG. 1A is a conceptual diagram of a system 100 for forecasting, purchasing, and selling block energy hedges. The system 100 can include a computer system 102, a user device 104, a data store 106, and an energy market(s) system 109, all of which may communicate with each other (e.g., wired, wireless) via network(s) 108.

The computer system 102 can be any type of computing system, computer, computing device, cloud-based computing system, and/or network of computing systems and/or devices. The computer system 102 can be physically located in a facility (see facility 105 described in at least FIGS. 1B, 1C, and 1D) or remote from the facility. In some implementations, the computer system 102 can be configured to forecast conditions in one or more energy markets for one or more different facilities. In some implementations, each facility can have a corresponding computer system that can forecast conditions in the energy market(s) for that particular facility.

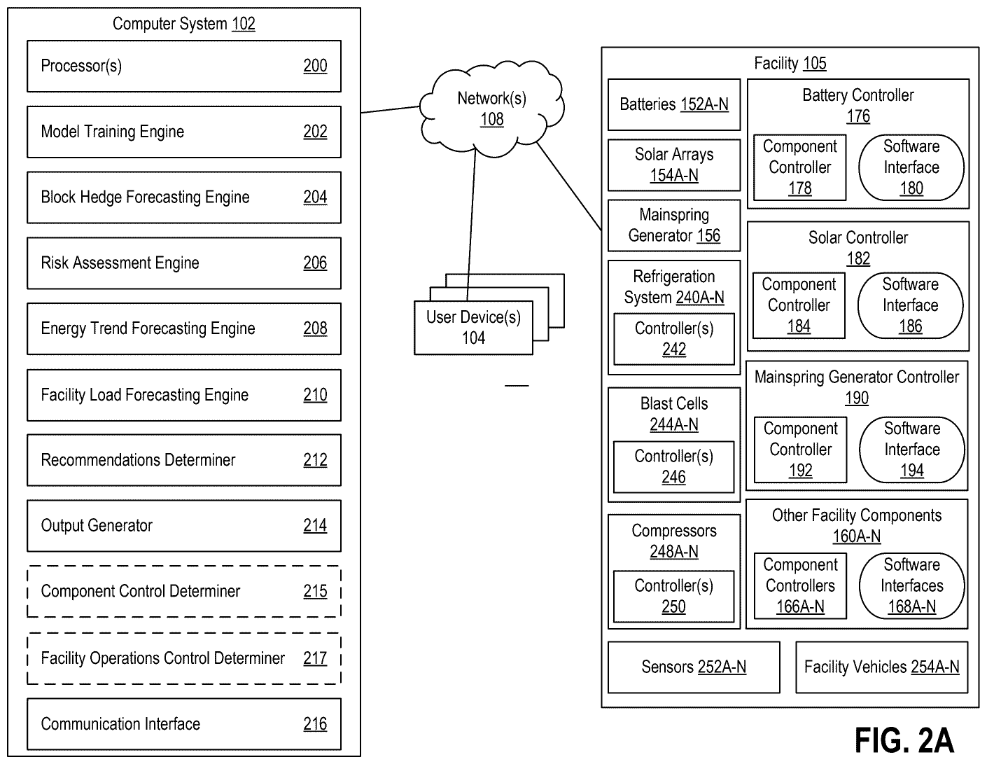

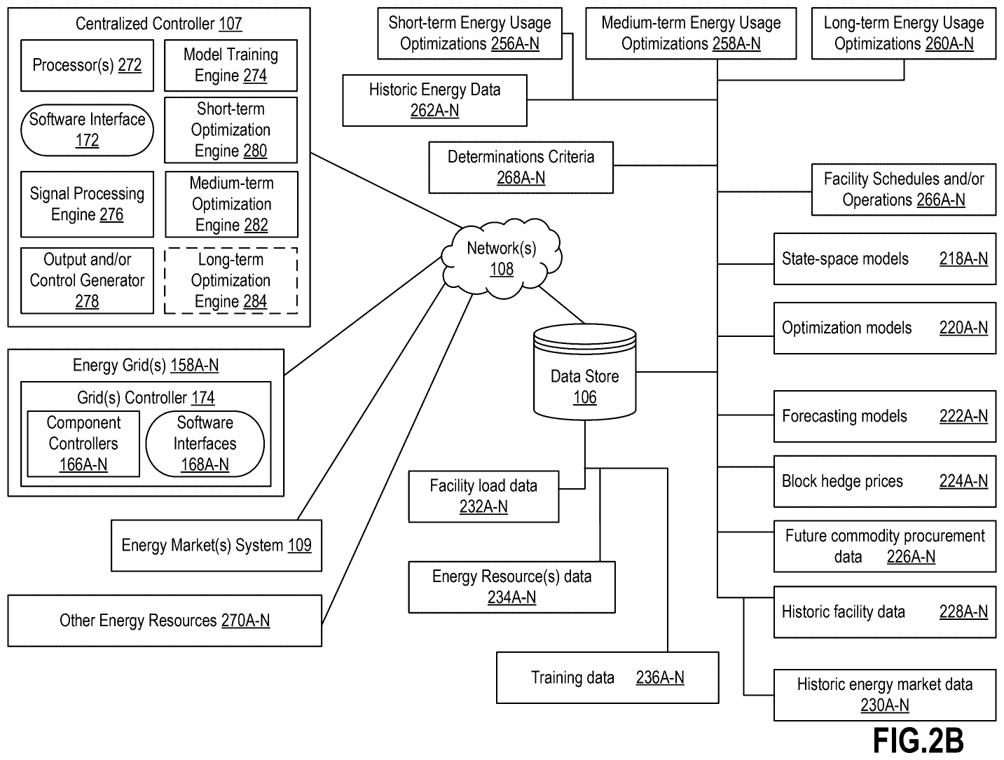

Refer to FIGS. 2A and 2B for further discussion about the user device 104 and the data store 106. In some implementations, one or more of the user device 104 and the data store 106 may be part of or the same as one or more of the computer system 102 and the centralized controller 107. Various other configurations of the system components described herein are also possible.

The energy market(s) system 109 can be any type of computing system, computer, computing device, cloud-based computing system, and/or network of computing systems and/or devices. The system 109 can be configured to Still referring to FIG. 1A, the computer system 102 can receive inputs in block A (110). The inputs can be received from a variety of sources, including but not limited to the data store 106, the user device 104, and/or the energy market(s) system 109. The inputs can include, but are not limited to, historical data, block hedge prices, facility operational information, future commodity procurement, facility load profile(s), energy information, optimization parameters, risk tolerance information, and/or weather data. One or more additional or fewer information can also be received in block A (110). The information received can be specific to a particular facility, a geographic location or region where the particular facility is located, an energy market associated with the particular facility (e.g., the energy market from which the facility purchases and sells energy), and/or generic to a population of facilities, geographic locations, and/or energy markets. As another example, the information received can include user input indicating a time period for which to optimize procurement. A relevant user can provide input indicating a set of continuous months or other groups of time during which they desire to optimize their procurement. As an illustrative example, the time period can include any one or more days, weeks, months, and/or combination thereof over a 3 year period of time into the future. Sometimes, the time period can be any grouping of days, weeks, and/or months over a shorter or longer period of time into the future (e.g., 1 year period into the future, 2 year period into the future, 4 year period into the future, 5 year period into the future, 10 year period into the future). As another illustrative example, the user can provide input such as quarterly and/or seasonable procurement schedules (e.g., a summer season, winter season).

The historical data can include information about the facility, about energy market conditions, about energy resource availability, about weather patterns and/or conditions, etc.

The block hedge prices can include but are not limited to current, projected, previous or historic block hedge prices. The future commodity procurement can include energy market information, including but not limited to historic, past, current, projected, and/or upcoming availability of energy resources, energy supply, energy demand, energy prices, etc. The energy information can include similar information as described above. For example, the energy information can include information about historic, present, upcoming, and/or projected energy production, consumption, supply, and/or demand (e.g., renewable energy resources such as wind and solar, grid energy, mixed energy/fuel sources) for the particular facility, a group of facilities, a geographic location/region, a particular energy market, a group of energy markets, etc.

The facility operational information can include but are not limited to historic or previous facility schedules, current and/or upcoming facility schedules, human workers on previous, current, and/or upcoming facility schedules, automated warehouse vehicles and other facility vehicles available/working during previous, current, and/or upcoming facility schedules, inbound order information, outbound order information, expected pallets and other inbound items, facility operating conditions, expected blast cell cycles, loads, and/or operational schedules, etc. The facility load profile(s) can include historic, past, current, upcoming, and/or projected information about energy loads for the particular facility, busyness of the facility, etc.

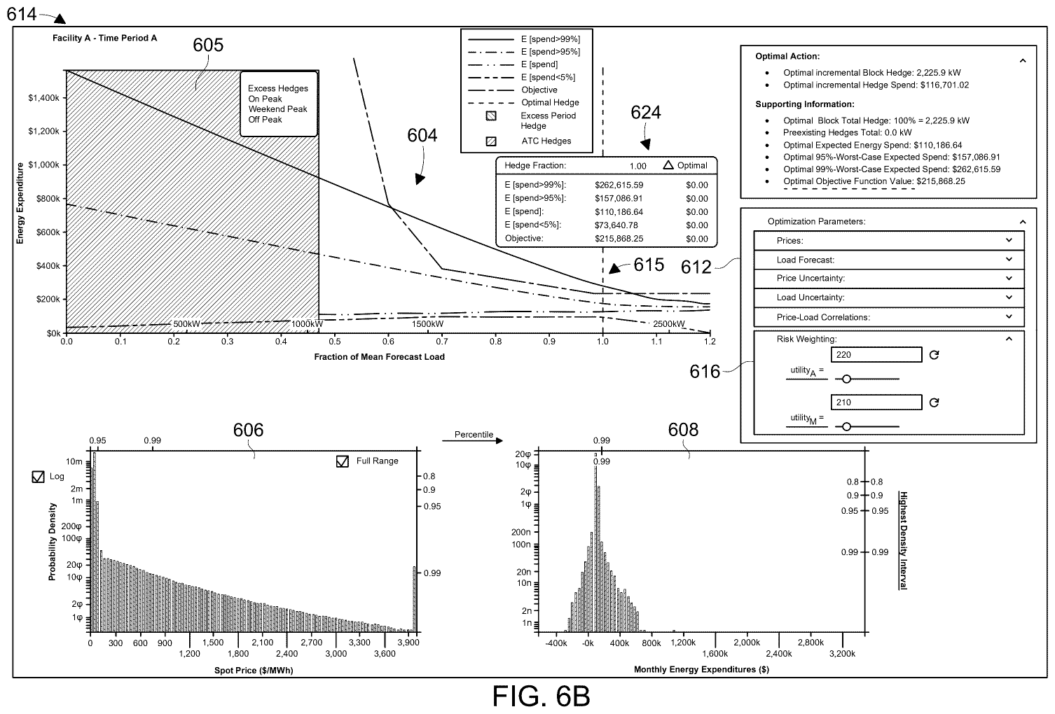

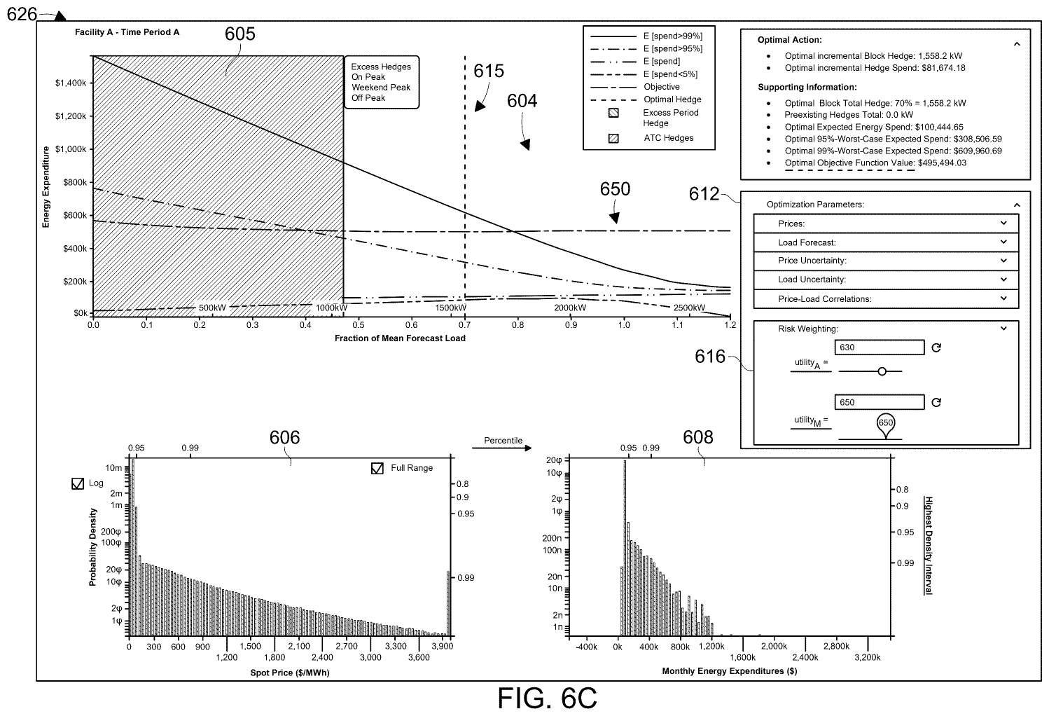

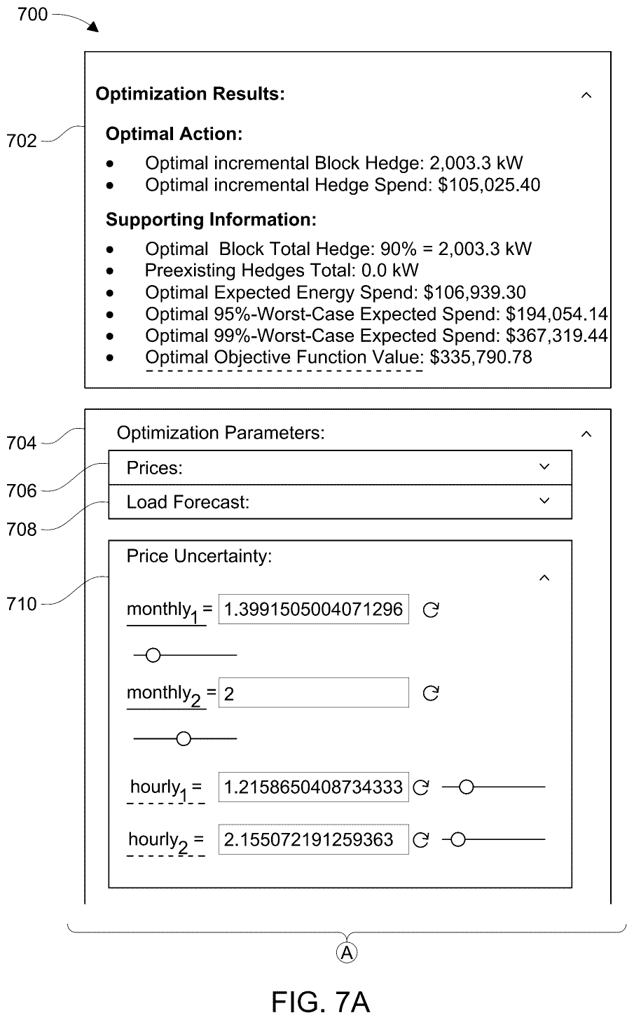

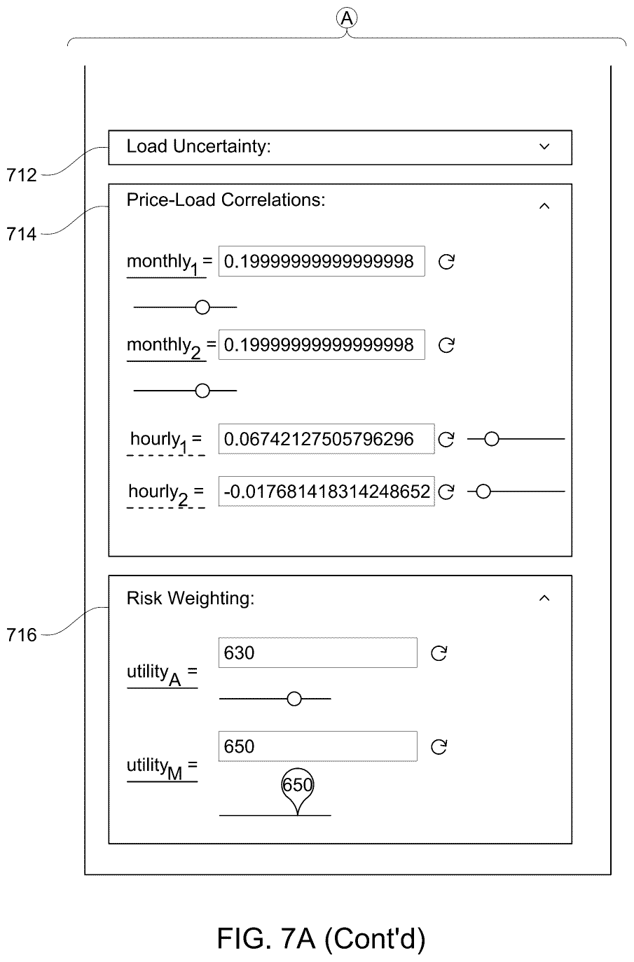

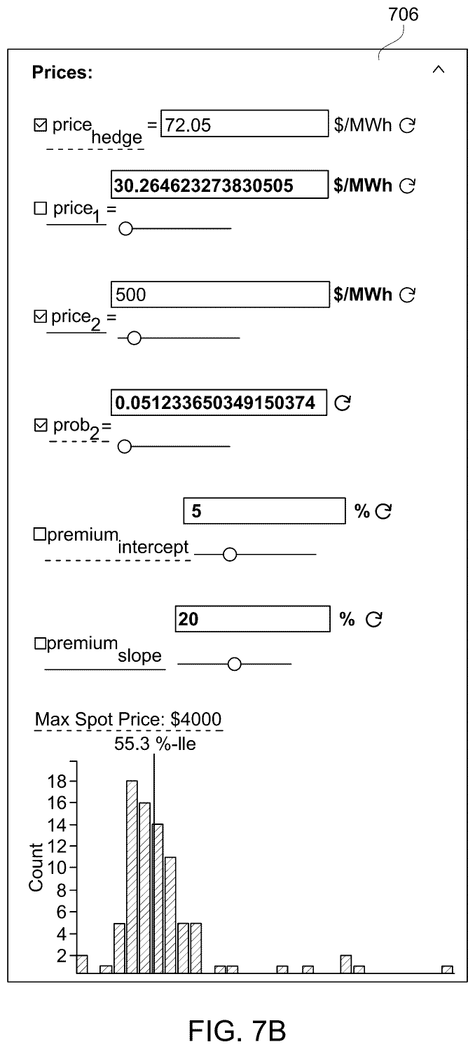

The optimization parameters can include one or more user-defined inputs provided by the relevant user at the user device 104 (or another computing system in communication with the computer system 102). The optimization parameters, as described further in reference to FIGS. 7A and 7B, can include price, load, and/or risk adjustments or tolerance levels for the particular facility. Similarly, the risk tolerance information can include user-defined levels or risk tolerance of the particular facility As described further in reference to FIGS. 6B and 6C, the race tolerance information can indicate levels of risk in price and/or energy availability that the particular facility is willing to take on regarding energy purchase and/or sale decisions.

The weather data can include historic, current, projected, and/or upcoming weather-related data for the particular facility and/or a geographic region associated with the particular facility and/or an energy market that the particular facility purchases and sells energy from. The weather data can include but is not limited to amounts of sunshine throughout one or more periods of time (e.g., hourly, during a day, during multiple days, during a week, during a month), amounts of wind during the one or more periods of time, rain storms, cloud coverage, temperatures, and/or other weather-related conditions during the one or more periods of time.

In block B1 (112), the computer system 102 can forecast energy information over a future period of time. Although data can be continuously received in block A (110), the energy information can be forecasted at predetermined time intervals and/or according to a predetermined schedule. For example, the energy information can be forecasted on a quarterly basis. The energy information can be forecasted on a monthly basis. The monthly basis can represent a minimum term for which to purchase energy blocks. Sometimes, the block B1 (112) may be performed in response to receiving user input from the user device 104 indicating that a relevant user desires to run a forecast of the energy information. Such user input can be received, as illustrative examples, monthly and/or quarterly.

In some implementations, the information received in block A (110) can include indications of energy hedges that have already been procured for the facility. In block B1 (112), the computer system 102 can then forecast energy information based on the already-procured energy hedges. The computer system 102 can, for example, generate recommendations about additional quantities of energy hedges to purchase and when next to purchase those quantities, in light of energy already purchased and potential risks in purchasing the additional energy hedges over future time periods.

As described further below, the computer system 102 can provide one or more of the inputs to a machine learning model (e.g., state-space model, statistical model, time-series model, forecasting model). The model can be trained to project energy information, such as block energy hedges, energy prices, energy availability, energy demand, energy supply over the future period of time. The future period of time can be determined by the relevant user. For example, the user can provide input at their respective user device 104 indicating that they desire to view projected block energy hedges for an upcoming 3 months. The user can provide input indicating any other future period of time (e.g., a next day, a next week, a next month, a next 6 months, a next year). In some implementations, forecasting the energy information can also include generating one or more recommendations indicated preferred or suggested times to purchase block energy hedges, sell block energy hedges, and/or quantities of block energy hedges to purchase and/or sell.

The computer system 102 can also evaluate energy pricing risks based on the forecasted energy information in block B2 (113). Evaluating the energy pricing risks can include quantifying risk associated with purchasing the block energy hedges at one or more future time periods. Evaluating the energy pricing risks may also include assessing how the risk may impact operations and/or energy efficiency of the facility. Evaluating the risks can include measuring the risks to identify how the facility can avoid being impacted by the risk. As a result, the computer system 102 may generate recommendations for purchasing the block energy hedges based on the risk evaluation performed in block B2 (113).

The computer system 102 can generate output in block C (114) based on the forecasted energy information and/or the evaluated energy pricing risks. The output can include GUIs to be presented at the user device 104. The GUIs can present graphs or other visual elements indicating the forecasted energy information and/or recommendations indicating risks associated with various projected block energy hedges and/or recommendations to purchase and/or sell block energy hedges. Refer to FIGS. 6-12 for further discussion about the GUIs. In some implementations, the output can include targets indicating quantities of energy to buy and/or best or preferred times to buy the quantities of energy.

The output can be transmitted to the user device 104 (block D, 116). In some implementations, the output can be transmitted to the data store 106 and/or one or more other computing systems described herein (e.g., a centralized controller of the facility, the energy market(s) system 109, etc.).

The output can be presented at the user device 104 (block E, 118). The user device 104 can also receive user input in block F (120). The user input can include one or more adjustments to the optimization parameters and/or risk tolerance information. The user input can include any other information provided by the relevant user, which can be used by the computer system 102 to forecast the energy information over the future period of time or other periods of time. The user input can also be used by the computer system to generate one or more recommendations for adjusting schedules, operations, and/or other aspects of the facility as described throughout this disclosure. In some implementations, the user input can include information indicating that the user desires to purchase and/or sell block energy hedges during one or more time periods in the future. The user input can then be transmitted back to the computer system 102 (block D, 116).

Once the computer system 102 receives the user input, one or more different actions can be performed. For example, the computer system 102 can transmit information and/or instructions to the energy market(s) system 109 to purchase and/or sell energy futures (e.g., block energy hedges) (block G, 122). Sometimes, the user device 104 can communicate directly with the energy market(s) system 109 to perform block G (122). Purchasing and/or selling the energy futures can be based at least in part on the forecasted energy information in block B1 (112) and/or the user input in block F (120). As an example of block G (122), a relevant user at the user device 104 can have a contractual conversation with an energy provider at the energy market(s) system 109 to perform actions related to energy hedging (e.g., purchasing or selling block energy hedges according to recommendations or other information generated by the computer system 102). In some implementations, an automated contract can be established between the user device 104 and the energy market(s) system 109 such that the actions related to energy hedging can be automatically executed (without the communication between the user and the energy provider). Sometimes, a third party may exist between components of the facility (e.g., the computer system 102) and the energy market(s) system 109, which can communicate, on behalf of the facility, with the energy market(s) system 109 to procure desired energy blocks.

Any one or more of the blocks A-G described herein can be continuously performed to determine and/or update predictions and determinations that are made by the computer system 102.

FIG. 1B is a conceptual diagram of the system 100 for forecasting block energy hedges and optionally determining facility controls based on the forecasting. One or more blocks in FIG. 1B are similar to blocks performed and described above in reference to FIG. 1A. As shown, the system 100 can also include a facility 105. The facility 105 can be any type of facility, including but not limited to a storage facility, a warehouse, a cold storage facility, and/or a distribution center. The facility 105 can be configured to receive items (e.g., pallets of items, cases of items, produce, frozen goods, different types of products or goods) for storage in the facility 105. The facility 105 can also be configured to prepare and send out items to various customers or other third parties.

The facility 105 can include a centralized controller 107. The centralized controller 107 can be configured to control components in the facility 105 that perform operations according to facility schedules. The centralized controller 107 can be physically located in the facility 105. In some implementations, the centralized controller 107 can be remote from the facility 105. For example, the centralized controller 107 can be a cloud-based computing system. The centralized controller 107 can also be any other type of computing system, computer, computing device, and/or network of computing systems and/or devices. In some implementations, the centralized controller 107 can be the same as the computer system 102. In some implementations, the centralized controller 107 and the computer system 102 can perform some of the same operations and/or processes described throughout this disclosure. Refer to FIGS. 2A and 2B for further discussion about the facility 105, components of the facility 105, and the centralized controller 107.

The computer system 102 can receive inputs in block A (132) from at least one of the data store 106 and/or the user device 104. Block A (132) is similar to block A (110) in FIG. 1A.

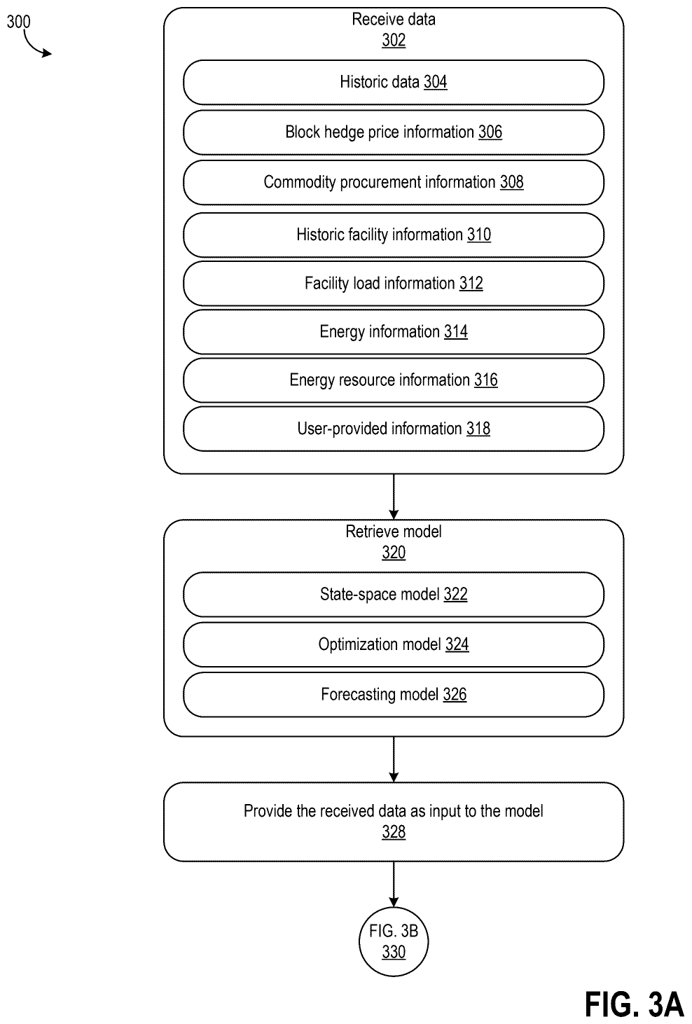

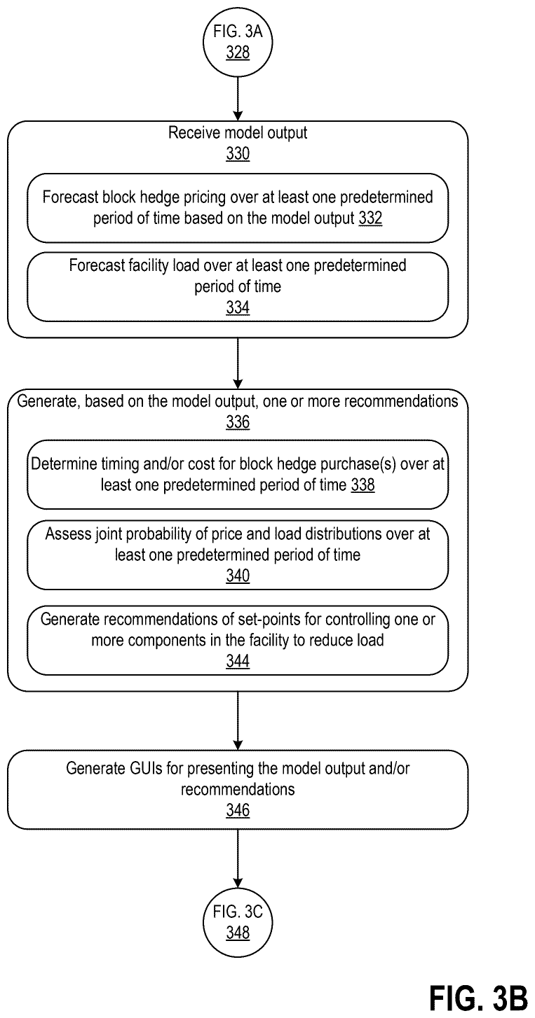

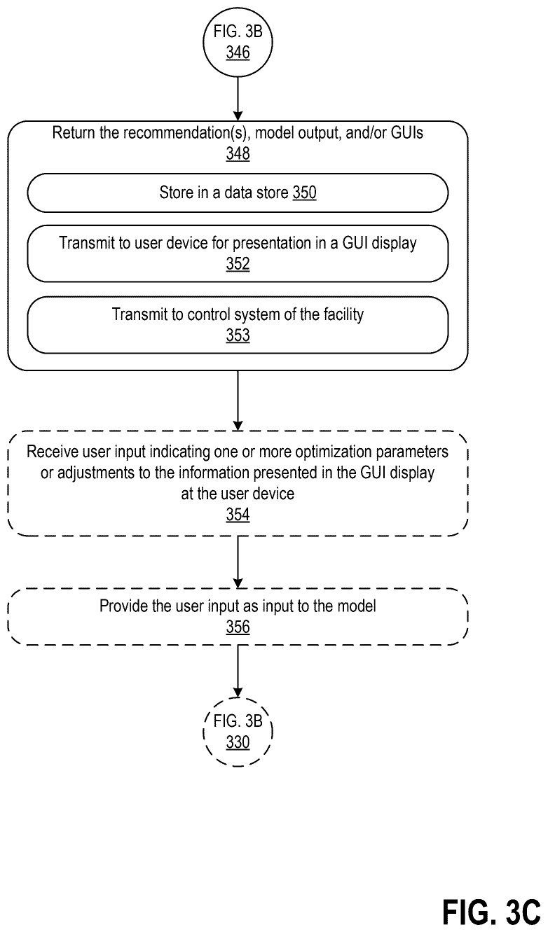

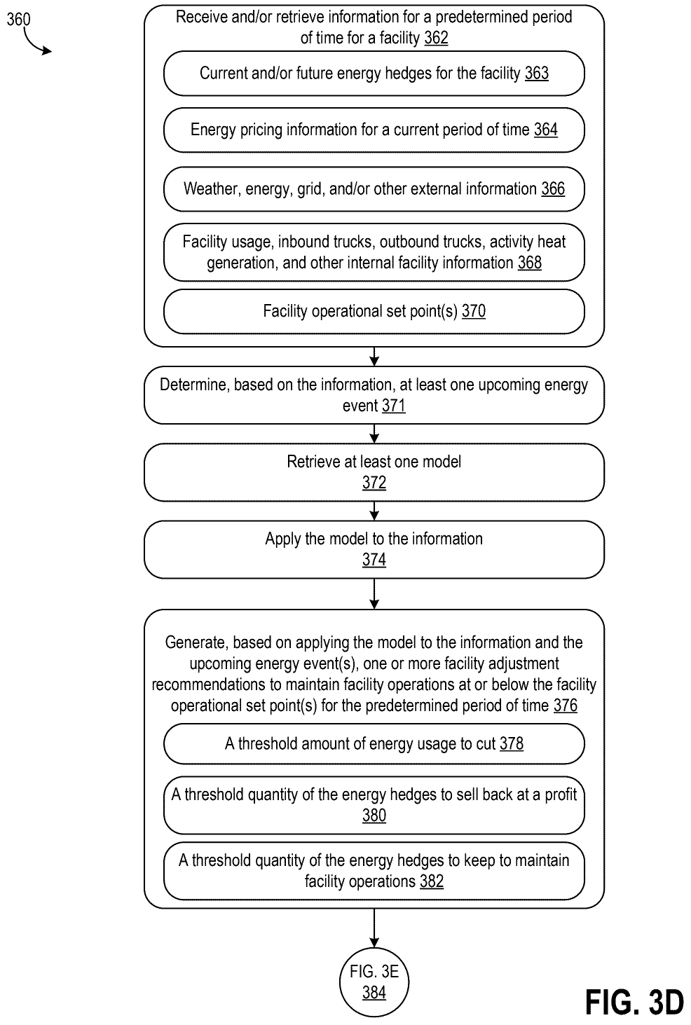

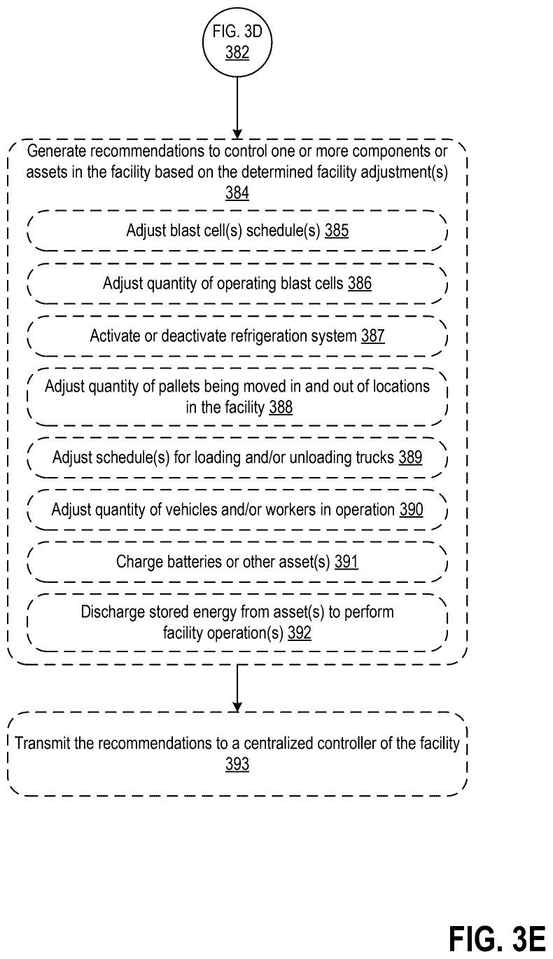

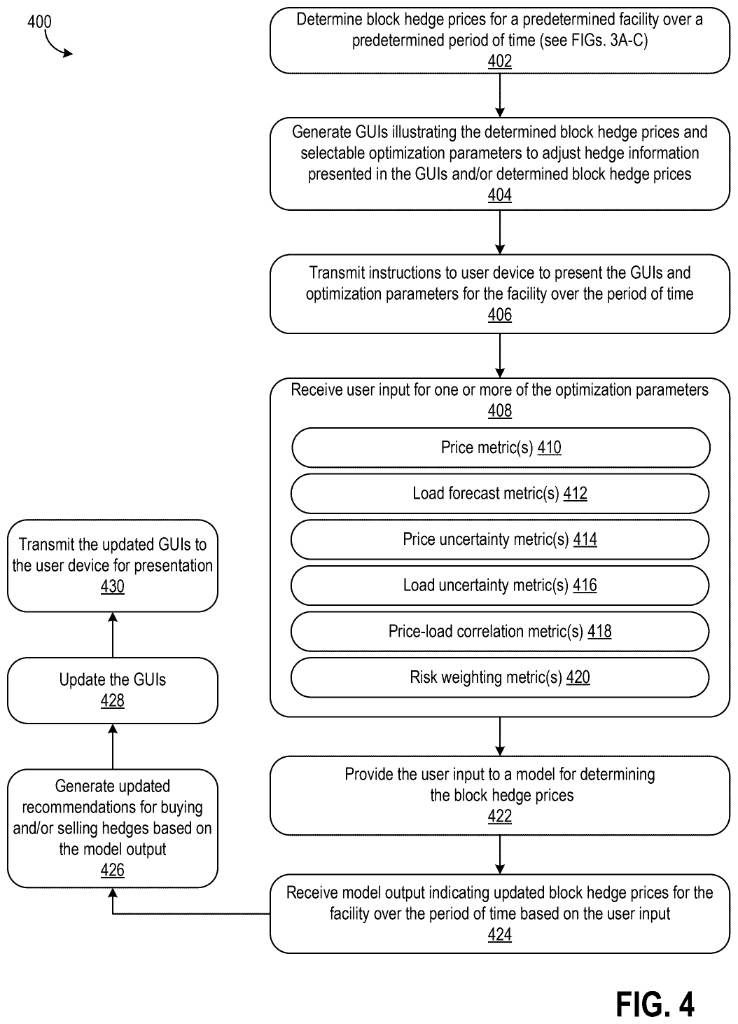

The computer system 102 can apply at least one model to the received inputs in block B, 134. Refer to at least block B1, 112, in FIG. 1A and process 300 in FIGS. 3A-C.

In block C (136), the computer system 102 can determine forecasted energy costs over a future period of time based on model output. As described herein, the model can generate output indicating the forecasted or projected energy costs over the future period of time. In some implementations, the model can generate output indicating likelihoods and/or probabilities of forecasted energy costs and the computer system 102 can generate the forecasted energy costs based on those likelihoods and/or probabilities. Refer to at least block B1, 112, in FIG. 1A for further discussion.

The computer system 102 can also generate at least one recommendation for block energy hedge purchases based on the forecasted energy costs (block D1, 138). Refer to at least blocks B1 and B2, 112 and 113 respectively, in FIG. 1A and the process 300 in FIGS. 3A-C for further discussion. In some implementations, not using an entire block energy hedge that is purchased can implicitly or passively result in a sale of the unused block energy hedge.

In block D2 (139), the computer system 102 can implement the recommendation(s) to purchase the block energy hedge with a third party system. The third party system can include any computing system that interacts with other systems such as the energy market(s) system 109 described in FIG. 1A.

In block E (140), the computer system 102 can optionally determine recommended controls for components of the facility 105 based on the recommendations for block energy hedge purchases. In some implementations, the recommended controls can be determined by another computer system associated with the facility 105, including but not limited to the centralized controller 107. The controls can be determined based on flexibility of the facility 105 to adjust operations, schedules, use of resources and/or components in the facility 105, etc. In some implementations, a conservative approach to determining the recommended controls can be taken, in which the computer system 102 may operate under an assumption that procurement in the facility 105 may not guarantee flexibility. As a result, controls can be determined that may allow the facility 105 to operate as efficiently as possible under particular circumstances and/or flexibility of the facility 105. The determined controls can include, as merely illustrative examples, raising one or more set points in one or more locations, areas, and/or rooms in the facility 105 (e.g., raising a temperature set point in a docking area of the facility 105 to a temperature closer to an ambient temperature outside of the facility 105 when energy prices are projected to be high such that A/Cs, refrigeration systems, fans, and other cooling components in the facility 105 may be turned off to not consume energy or to consume less energy) and/or temporarily stopping, slowing down, or delaying one or more energy-consuming processes in the facility 105 (e.g., temporarily stopping or delaying one or more blast freezing cycles). Thus, the controls can be determined in block E (140) to allow components of the facility 105 to relax, consume less energy, and reduce facility load while still allowing efficient and/or on-time completion of facility operational schedules (e.g., packing, prepping, and/or unpacking pallets/cases of items to be delivered to customers and/or stored for customers). Refer to at least process 360 in FIGS. 3D-E for further discussion.

In some implementations, blocks C, D1, D2, and E (136, 138, 139, and 140, respectively) in FIG. 1B can be performed in any order and/or simultaneously. In some implementations, one or more of the determinations made in blocks C, D1, D2, and/or E (136, 138, 139, and 140) can be generated as part of the model output in block B (134).

The computer system 102 can generate output in block F, 142. The output can include one or more GUIs for display at the user device 104, as described further in reference to at least block C, 114, in FIG. 1A.

The computer system 102 can transmit the output to the user device 104 in block G, 144. The user device 104 can present the output in block H(146). Refer to at least blocks D and E (116 and 118, respectively) in FIG. 1A for further discussion.

The computer system 102 can optionally transmit inputs for a control strategy to the centralized controller 107 of the facility 105 in block I (148). The inputs can include any one or more of the recommendations for block hedge purchases and/or recommended controls for components of the facility 105. The centralized controller 107 can optionally generate one or more controls based on the inputs in block J (150). Refer to at least the process 300 in FIGS. 3A, 3B, and 3C, and the process 360 in FIGS. 3D and 3E for further discussion about generating controls and controlling the components of the facility 105, based at least in part on the determined forecasted energy costs over the future period of time (block C, 136), the generated recommendations for block hedge purchases (block D1, 138), and/or the recommended controls (block E, 140).

Blocks E (140), I (148), and J (150) can be optionally performed to control the facility 105 in a way that may allow for reduction of energy consumption for the future period of time (or other periods of upcoming time). As a result, the facility 105 may operate with less energy for a limited period of time to avoid purchasing energy from the grid or other energy markets during forecasted spikes or peaks in energy demand and/or energy cost. As described herein, the computer system 102 can determine preferred hedging strategies for the facility 105 and/or energy market risk the facility 105 has exposure to. The computer system 102 can also provide insights into energy pricing that can be leveraged and/or communicated to sites, including but not limited to the facility 105. The insights from the computer system 102 may then be provided to other computer systems associated with the sites, such as the facility 105, to be used in making changes to a control system of the facility 105.

In some implementations, the recommendations generated in block D1 (138) and the determined controls in block E (140) can be made by the computer system 102 to assist the facility 105 in consuming less energy and selling back excess energy (e.g., unused energy) during the projected spikes or peaks in energy demand and/or energy cost. A future purchase price of block energy hedges can be used to determine a difference in energy to sell back to the energy grid or other market, thereby causing the facility 105 to profit during the projected spikes or peaks in the market and also efficiently operate.

FIG. 1C is a conceptual diagram of the system 100 for automated control and assessment of operations in the facility 105 to achieve performance optimization objectives of the facility 105. The facility 105 can be a storage facility, as described herein. Various components within the facility 105 can communicate (e.g., wired, wirelessly) with each other and the centralized controller 107 via network(s) 108. The facility 105 can be any type of storage facility, warehouse, distribution center, or other facility, structure, or building having various components that consume, produce, and/or store energy. The components can include but are not limited to batteries 152A-N, solar arrays 154A-N, mainspring generator(s) 156, and other facility components 160A-N(e.g., blast cells, compressors, refrigeration systems, cooling systems). The components of the facility 105 can also communicate or otherwise interact with components external the facility 105, including but not limited to energy grid(s) 158A-N. Refer to FIGS. 2A and 2B for further discussion about the components of the facility 105.

As described herein, the disclosed techniques may be used to determine hedging strategies and generate insights into energy pricing that can be leveraged and/or communicated to a variety of sites, including but not limited to the facility 105. Such strategies and insights may then be provided to computer systems associated with the sites, such as the centralized controller 107, and used as inputs to those systems to determine changes to be made to respective control systems. FIG. 1C illustrates example components that may be part of the facility 105, and used by the centralized controller 107 to adjust control operations of the components based on the hedging strategies and insights generated using the disclosed technology.

Each of the components may include respective controllers configured to independently and selectively control the component as well as interface with the other controllers and/or centralized controller 107. For example, the batteries 152A-N can be controlled by a battery controller 176. The solar arrays 154A-N can be controlled by a solar controller 182. The mainspring generator 156 can be controlled by a mainspring generator controller 190. The other facility components 160A-N can each of their respective component controllers 162A-N and their respective software interfaces 164A-N(e.g., for interfacing with other controllers described herein). The energy grid(s) 158A-N can be controlled by grid(s) controller 174.

In brief, the battery controller 176 can include at least a component controller 178 and a software interface 180. The component controller 178 can be hardware, such as a native controller, that operates to control operations of the batteries 152A-N in real-time, near real-time, and/or over one or more other periods of time. The software interface 180 can be a separate software component of the battery controller 176 configured to communicate with the centralized controller 107 and/or one or more other controllers described herein.

Similarly, the solar controller 182 can include a component controller 184 and a software interface 186. The mainspring generator controller 190 can include a component controller 192 and a software interface 194. The grid(s) controller 174 can include component controllers 166A-N and software interfaces 168A-N. As mentioned above, each of the other facility components 160A-N can also include respective component controllers 162A-N and software interfaces 164A-N.

The centralized controller 107 can be a computing system, cloud-based system, network of computing devices and/or systems, edge computing device, and/or other controller or computer associated with the facility 105. In some implementations, the centralized controller 107 can be the same as the computer system 102 described herein. The centralized controller 107 can be in a same network of computing devices and/or systems as the computer system 102. The centralized controller 107 can be physically located at the facility 105. The centralized controller 107 can be physically remote from a location of the facility 105. The centralized controller 107 can be a higher-level controller that is configured to read and interpret states of the various components in the facility 105 in real-time and/or near real-time. Reading the states of the components can include receiving signals and other information from the controllers of the components described herein.

More particularly, any of controllers and/or components of the facility 105 described herein can transmit energy usage information/data to the centralized controller 107, which can then use the received information to determine optimized controls of one or more of the components of the facility 105 over one or more timeframes in order to achieve one or more energy optimization objectives (e.g., reduced carbon footprint, reduced carbon emissions, reduced energy costs, reduced energy consumption). The centralized controller 107 and/or the computer system 102 described herein can also determine the optimized controls based at least in part on energy hedges that are bought and/or sold by the facility 105 and/or predictions that are made by the computer system 102 regarding energy hedges and the energy market more generally. Refer to FIGS. 3-5 for further discussion.

The centralized controller 107 can also interface or communicate with the data store 106, which can be configured to store a plurality of machine learning-trained models for use by the centralized controller 107 in processing the information/data received from the controllers and/or components of the facility 105. The models can be generated and trained by the centralized controller 107 and/or the computer system 102 described herein. In some implementations, the models can be trained by another or different remote computing system, stored in the data store 106 (or another data store), then accessible by the centralized controller 107 and/or the computer system 102 for runtime use. The data store 106 can be any type of data repository, database, cloud-based data storage system, or other data storage system.

The centralized controller 107 may also communicate with energy market(s) computing system(s) 109 and/or the energy grid(s) controller(s) 174 for the energy grids 158A-N to receive energy grid state information/signals and/or pricing market information/signals. In some implementations, such communication can exist between the computer system 102 and the energy market(s) computing system(s) 109 as described in reference to at least FIGS. 1A-B.

Information/signals received from the energy market system 109 and/or the grid controller 174 can be processed, assessed, and/or interpreted by the centralized controller 107 and/or the computer system 102 to determine one or more control actions that can be implemented at the facility 105 in order to achieve performance optimization objectives over one or more periods of time while also efficiently utilizing energy resources in light of energy market conditions, energy supply, energy demand, weather conditions, other factors, current energy prices, and/or expected energy prices. The information received from the energy market system 109 and/or the grid controller 174 can be processed in combination with the information/signals received from the controllers to generate optimal component and/or asset controls for any given period of time (e.g., current, future).

Whereas controllers of the components in the facility 105 handle real-time and/or near real-time control of the respective components, the centralized controller 107 (and/or the computer system 102 described herein) can determine higher-level facility-wide decisions to optimize how energy is produced, consumed, and/or made available to components in the facility 105 over various different periods of time. Thus, the centralized controller 107 can include decision engines 170A-N and a software interface 172. The decision engines 170A-N can be configured to process any of the signals received from the components described herein and determine operations and energy usage optimizations for the facility over the different periods of time. The software interface 172 can be configured to provide for communication between the centralized controller 102 and the other controllers described herein.

As an illustrative example, the centralized controller 107 can process and assess the above-described signals and/or information to determine how much energy to store in the batteries 152A-N over one or more timeframes. The centralized controller 107 can determine, based on processing the received signals with one or more models retrieved from the data store 106, that an extra 10% of energy should be stored in the batteries 152A-N because the centralized controller 107 (or the computer system 102) predicts that solar energy production will be low (e.g., less than some threshold level, less than historic solar energy production levels) over a next predetermined timeframe (e.g., next 5 hours, 10 hours, 15 hours, 20 hours, 24 hours, or other short, medium, and/or long-term timeframes) and/or that energy costs are going to increase at the energy grids 158A-N (e.g., by more than a threshold amount, by more than historic price increases) over a next predetermined timeframe (e.g., next 5 hours, 10 hours, 15 hours, 20 hours, 24 hours, or other short, medium, and/or long-term timeframes). As a result, the centralized controller 107 can determine that leveraging battery energy production and retention over the next predetermined timeframe can help the facility 105 achieve its short, medium, and/or long-term energy and performance optimization objectives. Similarly, the centralized controller 107's determinations can be transmitted to the computer system 102 and used by the computer system 102 to determine whether and how much energy can be sold back to the energy grid(s) 158A-N or other energy market system 109 when the solar energy production is likely to be low and/or the energy costs are likely to increase. As a result, not only can the facility 105 achieve its short, medium, and/or long-term energy and performance optimization objectives with proactive actions described above, the facility 105 may also profit from the predicted fluctuations in the energy market by selling back stored or otherwise unused energy to the energy grid(s) 158A-N and/or the energy market system 109 when the solar production is low and/or energy costs increase.

The determinations described above in the illustrative example that are made by the centralized controller 107 can more specifically be determined at one of the decision engines 170A-N, which can transmit instructions to the battery controller 176 via the software interface 172 of the centralized controller 107. The battery controller 176 can receive the instructions via the respective software interface 180 and transmit the instructions to the component controller 178 of the battery controller 176 for automated execution. The centralized controller 107 can continue to receive signals from the battery controller 176 after execution of the instructions and signals from other controllers as well to iteratively and continuously determine how to improve energy usage, consumption, and/or retention operations in the facility 105 over the different periods of time. Furthermore, the centralized controller 107 can generate controls that leverage various different components in the facility 105 itself as an active energy asset, thereby treating the facility 105 and its components as thermal batteries to charge and discharge within safe operating temperatures and other operating conditions. The centralized controller 107 can therefore communicate with the components in the facility 105 as described herein to transform each room, location, or other portion or component of the facility 105 into an energy prosumer (an entity that both consumes and produces power). Adapting components of the facility 105 to become energy prosumers can help the facility 105 achieve performance and energy objectives over current and/or future periods of time. Although FIG. 1C is described in reference to controlling the batteries 152A-N, this is merely an illustrative example. The same or similar techniques can also be performed to control the other components and/or assets associated with the facility 105.

The computer system 102, described further in reference to FIGS. 1A and 1B, can be configured to provide inputs to update or modify information transmitted between the grid controller 174 and the centralized controller 107 and information transmitted between the energy market(s) system 109 and the centralized controller 107. Therefore, the computer system 102 can provide inputs (e.g., recommendations for block energy hedges) that change or manipulate the information transmitted by the grid controller 174 and/or the energy market(s) system 109 before that information is ingested into the centralized controller 107.

FIG. 1D is a conceptual diagram of the system 100 controlling the facility 105 based on forecasting, purchasing, and selling block energy hedges. As described herein, the computer system 102 can be configured to generate energy hedging strategies and insights into energy pricing. Such strategies and/or insights can be provided to a computing system associated with the facility 105 (which may include the computer system 102, the centralized controller 107, or other computing systems) and used by that system to determine whether and what control operations can be modified or otherwise updated.

In the system 100 of FIG. 1D, the blocks A-G (110-120) are the same as described earlier. Refer to FIG. 1A for further discussion about the blocks A-G (110-120).

In addition, the computer system 102 can transmit the forecasted energy information and/or the bought/sold energy futures information to the centralized controller 107 of the facility 105 (block H, 124). Block H(124) can be performed before, during, and/or after one or more of the blocks described above, such as block F (120) and/or block G (122).

The centralized controller 107 can determine one or more control operations for components of the facility 105 based on the transmitted information over the future period of time (block I, 126). The centralized controller 107 can determine control operations that cause the facility 105 to operate at a lower capacity during forecasted or projected energy spikes to ensure that the facility 105 has extra energy that can be used to efficiently and timely perform operations at the facility 105 during the energy spikes (and/or so that extra energy can be sold back to the energy market during the energy spikes to make profit at the facility 105). Thus, block I (126) can be performed to determine good and/or preferred options for operating the facility 105 during the forecasted energy spikes.

As an illustrative example, if the transmitted information includes a recommendation to sell back block energy hedges during a projected future time when energy prices are at a predetermined threshold high (or other information indicating the user's desire to sell the block energy hedges during the projected future time), then the centralized controller 107 can determine, in block I (126), controls to cause one or more batteries of the facility 105 to charge for a predetermined amount of time before the projected future time when the block energy hedges will be sold in the market. Therefore, during the projected future time, the facility 105 can perform operations using the energy that is reserved in the batteries. As another example, the centralized controller 107 can determine to operate one or more blast cells during periods of time before or after the projected future time when the energy prices are projected to be high. One or more other control determinations can also be made by the centralized controller 107.

In some implementations, block I (126) can be performed by the computer system 102. The determined control operations can then be transmitted to the centralized controller 107 for execution.

The centralized controller 107 can execute the control operation(s) in block J (128). As described herein, the centralized controller 107 can transmit the instructions to one or more sub-controllers in the facility 105 to then execute the instructions. In some implementations, the control operation(s) may be executed by the computer system 102.

The centralized controller 107 can transmit component control information to the computer system 102 in block K (130). Block K (130) can be performed during block I (126) and/or before block J (128). The component control information can include the one or more control operations that are determined based on the forecasted energy information and/or the user input. The component control information can include, in some implementations, sensor signals and other signals that are generated by controllers and/or components in the facility 105 during operation (e.g., past operation, current operation) and/or in response to the control operations being executed in block J (128). Block K (130) can be performed as part of an iterative feedback loop to continuously update energy forecasts and other output determined by the computer system 102 using the disclosed techniques.

Sometimes, the component control information can be stored in the data store 106. In some implementations, the component control information can be used by the computer system 102 to perform one or more of the blocks described herein. For example, the component control information can be used to iteratively train and improve one or more of the models described herein, the models being used for forecasting the energy information in block B1 (112). The component control information can be used to forecast the energy information over one or more other future periods of time or otherwise update the forecasted energy information that was previously determined (block B1, 112). The component control information can be used to determine and/or generate one or more of the control operations for the components of the facility 105 (block I, 126).

FIGS. 2A and 2B are system diagrams of one or more components that can be used to perform the disclosed techniques. Referring to both FIGS. 2A and 2B, the computer system 102, the user device(s) 104, the facility 105, the data store 106, the centralized controller 107, the energy grid(s) 158A-N, the energy market(s) system 109, and other energy resources 270A-N can communicate (e.g., wired, wireless) via the network(s) 108.

The computer system 102 can include a processor(s) 200, a model training engine 202, a block hedge forecasting engine 204, a risk assessment engine 206, an energy trend forecasting engine 208, a facility load forecasting engine 210, a recommendations determiner 212, an output generator 214, an optional component control determiner 215, an optional facility operations control determiner 217, and a communication interface 216. The processor(s) 200 can be configured to execute instructions for performing the operations described herein. The communication interface 216 can be configured to provide communication (e.g., wired and/or wireless) between system components described and depicted in FIGS. 2A and 2B.

The model training engine 202 can be configured to generate, train, and iteratively improve models such as state-space models 218A-N, optimization models 220A-N, and/or forecasting models 220A-N. The engine 202 can retrieve training data 236A-N and/or other data that is stored in the data store 106. The state-space models 218A-N can be trained and used to predict and forecast conditions in the energy market.

In some implementations, the state-space models 218A-N can include a load model, in which a predicted load can be a sum of several components that may not be directly observed (e.g., the predicted load can depend on a state of the system in a parameter space that may not be readily observed). More specifically, the load can be defined at a given time as a sum of (e.g., a ‘trend’ term that can be increasing or decreasing with time, with a rate of increase or decrease also varying with time) plus (a ‘month-of-the-year effect’ that can change with time) plus (an ‘error’ term that can change with time). Accordingly, a single data point—an average load in a given month or other timeframe—can be written as a sum of three terms.

Additional structure can be added to the model, which can lead to a fully determined model in which probabilities can be assigned to each set of numbers). The structure can be added using prior distributions in a Bayesian model. The ‘month-of-the-year’ effect in the model, which can also be referred to a ‘month effect’, can capture patterns in the load that tend to recur in a same month every year. If a facility with a blast freezer uses a lot of energy in March and April to freeze strawberries, for example, that facility may have a high load every year during those particular months. The ‘March effect’ can therefore be expected as high every year, although it may not be equally high every year. Similar reasoning can be applied to the trend term. As an illustrative example, the mean monthly load at a facility can have an increasing trend: the load in each month in a particular year can be higher than in a corresponding month last year. Such a trend may not be perfectly linear and may not continue forever, but it is expected that the trend may not change very quickly. In some implementations, the model can assume that the expected magnitude of a trend in a given month can be a constant multiplied by a weighted mean of the trend over the previous few months, where the constant can be estimated from historical data. The actual trend for the given month can be drawn from a distribution centered on the expected magnitude; the width of this distribution can also be estimated from historical data. In some implementations, the model can also assume that for a given month there can be some underlying predicted price that takes the trend and the month into account, but that the actual realized price for the month can differ from this quantity.

Accordingly, the model may have flexibility in the functional form of this relationship; for example, it can be assumed that the difference can be a sample from a long-tailed distribution.

Moreover, the model can be fitted to get estimates of model parameters at the end of a dataset. Such parameters can then be used to simulate possible future time series. The model output can include thousands of realizations of the model, representing different combinations of parameters that are more or less compatible with the data and the model. The model can be defined such that y_hat[t] has to closely track y[t], but there may also be different ways this can be achieved. Sometimes, the month effects may change by a very small amount from year to year (corresponding to a small value of sigma_seas), whereas a sigma_level term may be rather large; in other realizations, these magnitudes may be be reversed. Nevertheless, the model can closely match the actual data for the past, but simulations into the future will look different. Moreover, future simulations can include random variability: the slope and the month effects both take a random walk once the time t is beyond the end of the data, so some simulations can lead to ever-increasing load, others can lead to ever-decreasing load, and most may fluctuate up and down in future years. If the training data (e.g., historical data) constitutes a long time series of values that don't change much from year to year, simulated futures may also tend to be stable. However, when working with just a few years of historical data, the data may change quite a bit from year to year, in which case the simulated futures may also be highly variable. For instance, some forecasted values might be below 0 kWh, or might be so high that they couldn't possibly occur (e.g. they could exceed the amount of energy that the facility could use even if it operated at full capacity around the clock). Sometimes, to address this, limits can be imposed, potentially at a facility-by-facility level. For example, at a given facility, load in the next 2 years may not fall below half a lowest value it has been historically, nor may it exceed twice of a highest value the facility has seen historically. Any simulated future time series that go outside of these limits may be discarded. In some implementations, quantitative information that may be related to expected future electricity demand can be added to the model. Examples may also include growth forecasts for a number of trucks to be served and/or tonnage of food to be stored in a facility. Handling of constraints may also be improved, such as by imposing stronger prior distributions concerning rate of change of the load and/or number of months for which it can quickly increase or decrease.

State-space modeling advantageously can assume unobserved variables interact with outcomes and/or dependent variables. Therefore, state-space modeling can acknowledge that certain variables may not be used as inputs up front during training and/or runtime use, but that a linking function and/or model can still be developed based on what the model determines and/or how the model performs over time. More specifically, the state-space models 218A-N can be used as mathematical models in control engineering that provide a state-space representation of a physical system of a set of inputs and outputs along with some set of state variables that can be related by first-order differential equations. State variables in this model can be a type of variable whose value changes over time and depends on the values that have been given as input variables to the model. The value of the output variables can depend on the value of the state and input variables. Putting a model into state-space representation can be a basis for control analysis and dynamics processes.

The optimization and forecasting models 220A-N and 222A-N can also be used to provide similar advantages in predicting and forecasting market conditions and/or determining facility operations and/or adjustments. The optimization models 220A-N, for example, can be trained to determine or otherwise generate recommendations for actions to be taken in the facility 105 that take into consideration predicted or forecasted energy market conditions. The optimization models 220A-N can be trained to determine optimal operations to be performed by components in the facility 105 that achieve optimization and/or performance objectives of the facility 105 but also efficiently and proactively utilize available energy resources.

The forecasting models 222A-N, like the state-space models 218A-N can be trained to predict or otherwise forecast energy market conditions over one or more periods of time. The models 222A-N can be trained to predict block hedge prices, changes in weather patterns, changes in energy supply and/or demand, or other conditions that may arise in the energy market or impact operations in the facility 105.

In some implementations, the forecasting models 222A-N may include seasonal autoregressive integrated moving average with exogenous variables models (SARIMAX models). A statistical distribution of monthly mean spot prices can be forecasted by forecasting the price distribution if a month is a typical month and/or forecasting the distribution of the month if the month is atypical. Sometimes, at least for some facilities, there can be a monthly mean price that can be an outlier compared to all or almost all of the months before or since. In a typical month, for example, factors that may affect prices can include cost of natural gas, effects of weather on electricity demand, etc. In an atypical month, there can be either additional factors that may not come into play normally or some of the usual factors that may be outside their typical range. Accordingly, price data from most months can provide information about prices in typical months, but risk that the price will be extremely high, which can be motivation for buying a hedge—can mostly be due to the atypical months. By definition, atypical months may be rare, so there may not be sufficient data on them to accurately characterize their statistical distribution. Accordingly, the model can be a mixture model that can assume there is a probability of a given month being atypical. The modeling may include estimating that probability.

The hedge price for a future month can be assumed to represent the market's assessment of the entire risk distribution. Accordingly, the market has assigned a probability that the month may be atypical and that this is factored into the price. There may also be some probability w that the month may be atypical, in which case the monthly mean price can be drawn from a distribution with a high arithmetic mean. There may also be some probability (1-w) that the month may be typical, in which case the price will be drawn from a distribution with a lower arithmetic mean. The mode can be a time-series model, trained on data from typical months, to generate a predictive distribution for the mean spot price during typical months. The model can also be trained based on the notion that the atypical month has a price that can be drawn from a distribution with high mean and very high variance. The hedge price can be considered fair, in the sense that it can represent the expected value of the mean of the mixture, albeit with a premium. Given the mean forecast for a typical month, the mean of the distribution for an atypical month, the hedge price, and the premium, the model can be trained and used to determine the probability that the month may be atypical.

As an illustrative example for forecasting the price distribution for a typical month, a model such as the SARIMAX model can be trained. The monthly mean spot price can be defined as above 0, so the model can be fit in log space rather than untransformed space. As an explanatory variable, a function of the hedge price can be used. For example, if trying to forecast the price six months ahead, a function of six-month-ahead hedge prices can be used as an exogenous variable in both fitting the model and making the forecasts. The cube root of the hedge price can be used. Even with the transformation of the exogenous variable, problems may arise if the historical data includes one or more atypical months. To remedy this issue, the price data that goes into the model can be censored so that they have a ceiling.

As described herein, a forecast distribution for a monthly mean price can be determined if the future month is a typical month, and there can also be a distribution for the price if the month is atypical. The hedge price (e.g., market price for buying electricity in the month being forecast) can be used to quantify tail risk. The hedge price can represent both the market's expectation of what is likely to happen (the typical price) and the market's assessment of the risk that the month will have an atypically high price. If the hedge price were a forecast of the mean of the price distribution, then that probability of the month being atypical can be defined as: hedge price=(1−w)*(mean of ‘typical’ month distribution)+w (mean of ‘atypical’ distribution), where w is the probability that the month will be atypical.

However, the hedge price may not always represent the market's estimate of the mean of the future price distribution because the hedge price can include a premium, especially when the market assesses that there is a high risk of an atypical month. The absolute premium can be defined as: (hedge price)−(spot price), e.g., P=H−s, and the relative premium can be the absolute premium divided by the spot price, e.g., p=P/S=(H−S)/S, or, equivalently, S=H/(1+p) and H=(1+p) S. With the premium taken into account, the following relationship can exist: hedge price=(1+p)*[(1−w)*(mean of typical month distribution)+w*(mean of atypical distribution)]. Solving for w, which is the probability of an atypical month, the following can result: w=(H/(1+p)−T)/(A−T). Where H is the hedge price, A is the arithmetic mean of the price distribution if the month is atypical, and T is the arithmetic mean of the price distribution if the month is typical.

Another consideration is determining the expected premium, p. Sometimes where a hedge seller takes larger risks than a hedge buyer, there can be a premium in order to compensate the seller for taking that risk. It can be expected that the cost of a hedge should include a premium on average. The absolute premium (e.g., hedge price minus spot price) can be assessed rather than the relative premium. In dollar terms (for example) a relative premium of −0.9 can be hugely different from a relative premium of +0.9: for a $100/MWh hedge the former represents a $1000/MWh spot price, while the latter represents a $52/MWh spot price. If one didn't buy a hedge at $100/MWh and the premium turned out to be −0.9 then they may regret it since they're paying $900/MWh more than if they had bought the hedge. But if they bought the hedge and the premium turned out to be +0.9 then they ‘only’ paid an extra $48/MWh by buying the hedge. There can be a general tendency for the premium to be higher when the hedge price greatly exceeds a forecast price than when the hedge price is close to the forecast price.

Relative premium can be given by p=a+b(H−F)/H, where a and b are constants, H is the hedge price, and F is the forecast price conditional on the month being a typical month. a can be a premium intercept and b can be a premium slope. Accordingly, the absolute premium can be given by: P=p*S=[a+b(H−F)/H]S, where H and F are known at the time the hedge purchase is being considered, but the spot price S is not. However, given the estimate of p, a forecast for S can be derived by using the following: S=H/(1+p). Inserting this into the equation above can result in a predicted absolute premium of: P=H(aH+b(H−F)/(1+aH+b(H−F). In some implementations during runtime use, a=plus or minus 1 of 0.05 and b=plus or minus 1 of 0.15 can be used.

In addition to or instead of the SARIMAX model for forecasting price distribution for the typical month, a Bayesian hidden variables and/or state-space model may be trained and used. Such a model can allow increased flexibility, including the ability to have the model's parameters sampled from distributions rather than set to specific values, and to have the model narrow the distributions of those parameters in order to better fit the historical data.

For forecasting the price distribution for an atypical month, statistical distribution of monthly-average prices for typical months can be determined/assumed. Additional information can be modeled to separate tail risk from a main part of the distribution and/or better characterize the statistical distribution for an atypical month. For example, the price of an option to buy or sell electricity at a later date can indicate the probability of a high price, as opposed to a hedge price, which can primarily indicate the expected price (e.g., the average of the possibilities). Reasonable default parameters, may also be used, for lognormal distribution that may represent monthly mean prices during atypical months. In some implementations, a relevant user described herein can change those parameters.

The block hedge forecasting engine 204 can be configured to predict or otherwise forecast block energy hedge prices over one or more periods of time. Such predictions can be stored in the data store 106 as block hedge prices 224A-N. The engine 204 can retrieve information from the data store 106 including but not limited to any of the models 218A-N, 220A-N, and 222A-N to predict or forecast the block energy hedge prices. The engine 204 can also retrieve or receive other information from the data store 106, including but not limited to historic energy data 262A-N, facility schedules and/or operations 266A-N, future commodity procurement data 226A-N, historic facility data 228A-N, historic energy market data 230A-N, energy resource(s) data 234A-N, and/or facility load data 232A-N. Any of this information can be used by the engine 204 to predict or forecast the block energy hedge prices. The engine 204 may also receive information from the energy market(s) system 109, other energy resources 270A-N(e.g., renewable energy resources, grid energy, mixed resources, natural gas, solar, wind, nuclear, coal), the energy grid(s) 158A-N, the centralized controller 107, the user device(s) 104, and/or components of the facility 105. Any of the retrieved or received information can be provided as input to the model(s). The model(s) can then output forecasted block energy hedge prices. The engine 204 can receive information from the user device(s) 104 indicating one or more periods of time at which to forecast the block energy hedge prices. The engine 204 can therefore forecast block energy hedge prices based on a variety of factors, including but not limited to historic or prior energy market data indicating prices, fluctuations in supply and demand, historic weather conditions and patterns, upcoming or forecasted weather conditions and patterns, current schedules and/or operations in a particular facility or a group of facilities, expected schedules and/or operations in the facility or the group of facilities, and other information described herein.

The risk assessment engine 206 can be configured to predict, forecast, and/or adjust predictions or forecasts based on user risk levels. For example, a user at the user device(s) 104 can provide user input indicating their risk tolerance level for buying and/or selling block energy hedges with the energy market(s) system 109. The engine 206 can then receive or request block hedge forecasting determinations made by the engine 204 and adjust those determinations based on the user-inputted risk tolerance level. In some implementations, for example, the engine 206 can retrieve one or more of the models 218A-N, 220A-N, and/or 222A-N from the data store 106 and provide the determinations from the engine 204 and the user-inputted risk tolerance level as inputs to the model(s). The model(s) can generate output indicating adjusting block hedge prices according to the user-inputted risk tolerance level. Refer to FIGS. 6B-6C for additional discussion about adjusting the block hedge prices based on user risk tolerance.

The energy trend forecasting engine 208 can be configured to project how various aspects of energy markets may trend over one or more periods of time. The projections can be made using any of the models described herein (e.g., the forecasting models 222A-N). The projections can be made using determinations made by the block hedge forecasting engine 204, the risk assessment engine 206, the facility load forecasting engine 210, and/or the recommendations determiner 212. The engine 208 can also receive or retrieve any of the other data described herein from other system components (e.g., weather data, historic energy market data, historic weather conditions, historic supply and demand information, current supply and demand information, projected supply and demand information, etc.) to be used by the models to forecast the energy trends. In some implementations, the engine 208 can receive information from the user device(s) 104 indicating time periods for which to forecast the energy trends and other user-defined criteria for which to forecast the energy trends.

The facility load forecasting engine 210 can be configured to forecast or predict how facility load (e.g., activity, busyness, number of orders, number of deliveries and/or delivery trucks, availability of workers and/or facility vehicles, etc.) may trend over one or more periods of time. The periods of time can be defined by the relevant user and provided as input at their user device(s) 104. The engine 210 can retrieve or receive any of the information and data described herein from the system components of FIGS. 2A-B. The engine 210 can provide that information and data as input to one or more of the models, which can be trained to predict the facility load over some period of time. The engine 210 can also predict the facility load over time based on factors external to the facility 105, including but not limited to energy market conditions, weather conditions, activities and/or load in other facilities, etc. The determinations made by the engine 210 can be stored in the data store 106 as the facility load data 232A-N.

The recommendations determiner 212 can be configured to generate one or more facility operation recommendations based on determinations made by any one or more of the block hedge forecasting engine 204, the risk assessment engine 206, the energy trend forecasting engine 208, the facility load forecasting engine 210, the component control determiner 215, and/or the facility operations control determiner 217. As described throughout this disclosure, the recommendations can be made in light of or otherwise based on optimization and efficiency criteria associated with the facility 105. The recommendations can take into consideration spikes or drops in energy prices, upcoming weather conditions, current or expected schedules or busyness in the facility, expected energy needed to complete current or expected orders on time, etc. The recommendations can be transmitted to components in the facility 105 and/or the centralized controller 107. For example, the centralized controller 107 can automatically determine whether one or more of the recommendations should be implemented in the facility 105. If the centralized controller 107 determines that the recommendation(s) should be implemented, the centralized controller 107 can generate controls that are then transmitted to a controller of the respective component in the facility 105 to perform one or more actions associated with the recommendation(s). In some implementations, the engine 212 can automatically determine that a particular recommendation should be performed, and then can transmit instructions to a controller of the respective component in the facility 105 to perform the action(s) associated with the recommendation(s). Recommendations made by the engine 212 can also be stored in the data store 106.

The output generator 214 can be configured to generate one or more GUIs for presentation at the user device(s) 104 based on the determinations made by any one or more of the block hedge forecasting engine 204, the risk assessment engine 206, the energy trend forecasting engine 208, the facility load forecasting engine 210, the recommendations determiner 212, the component control determiner 215, and/or the facility operations control determiner 217. Refer to FIGS. 6-12 for illustrative examples of the GUIs that can be generated at the output generator 214.

The optional component control determiner 215 can be configured to generate one or more facility component controls based on the determinations made by any one or more of the block hedge forecasting engine 204, the risk assessment engine 206, the energy trend forecasting engine 208, the facility load forecasting engine 210, the recommendations determiner 212, the component control determiner 215, and/or the facility operations control determiner 217. In some implementations, the component controls can be determined by the centralized controller 107 or one or more of the controllers of components in the facility 105. Controls generated by the determiner 215 can then be transmitted to the centralized controller 107 or directly to the controllers of the respective facility components. If the controls are sent to the centralized controller 107, the centralized controller 107 can then communicate directly with the respective controllers to execute the determined controls.

The optional facility operations control determiner 217 can be configured to generate one or more overall facility operational control updates based on the determinations made by any one or more of the block hedge forecasting engine 204, the risk assessment engine 206, the energy trend forecasting engine 208, the facility load forecasting engine 210, the recommendations determiner 212, and/or the component control determiner 215. In some implementations, the facility operational updates/modifications/changes can be determined by the centralized controller 107. Facility operational changes can be generated by the determiner 215 can then be transmitted to the centralized controller 107 or directly to controllers of respective facility components. If the controls are sent to the centralized controller 107, the centralized controller 107 can then communicate directly with the respective controllers to execute controls to implement the facility operational changes.

The user device(s) 104 can be any type of computing device including but not limited to laptops, tablets, computers, mobile phones, cellphones, etc. The user device(s) 104 can include input devices (e.g., keyboards, mice, touch screens, microphones) and/or output devices (e.g., speakers, display screens, haptic feedback). The input devices can be used by the relevant users to provide user-generated information, which can then be used by components of the computer system 102 to predict or forecast block energy hedge prices, energy load information, facility load information, facility operations, scheduling of facility tasks and/or operations, etc. The output devices can be used to present information to the relevant users, the information being any of the determinations made by the system components described herein. The user device(s) 104, for example, can launch a webpage in a web browser or a mobile application providing various GUIs for the relevant users to interact with the disclosed technology. The relevant users can navigate through the various GUIs to view different information in various different graphical or other visual elements, the information including but not limited to block hedge forecasts, risk assessments, energy trend forecasts, facility load forecasts, recommendations for purchasing and/or selling block energy hedges, recommendations for adjusting facility operations, schedules, and/or component controls, etc. Accordingly, the user device(s) 104 can present, in graphical displays, any of the output that is generated by the output generator 214 of the computer system 102. In some implementations, the user device(s) 104 can also receive information and/or controls from the centralized controller 107, any of the components in the facility 105, and/or the energy market(s) system 108, which can then be outputted in the graphical displays of the user device(s) 104 for viewing and interaction with by the relevant users.

The facility 105 can include the batteries 152A-N, the battery controller 176, the solar arrays 154A-N, the solar controller 182, the mainspring generator 156, the mainspring generator controller 190, the other facility components 160A-N, refrigeration systems 240A-N and their respective controller(s) 242, blast cells 244A-N and their respective controller(s) 246, compressors 248A-N and their respective controller(s) 250, sensors 252A-N, and/or facility vehicles 254A-N. The facility 105 can include one or more additional, fewer, or other components.

The batteries 152A-N can be any type of battery, batteries, arrays and/or grids of batteries that may be used by the facility 105 to provide and store energy for performance of facility operations. For example, the batteries 152A-N can include lithium-ion phosphate batteries.

The battery controller 176 can be configured to control operations of the batteries 152A-N as described herein. Accordingly, the battery controller 176 can include the component controller 178 and the software interface 180 described in reference to FIG. 1C.

The solar arrays 154A-N can include any quantity and/or type of solar panels and/or arrays that may be used by the facility 105 to generate, use, and/or store energy for operations at the facility 105. The solar arrays 154A-N can be part of the facility 105, such as on a roof of the facility 105. The solar arrays 154A-N can also be external or remote from the facility 105 and in electrical communication with the facility 105, components of the facility 105, and/or storage units (e.g., batteries 152A-N).

The solar controller 182 can be configured to control operations of the solar arrays 154A-N as described herein. Accordingly, the solar controller 182 can include the component controller 184 and the software interface 186 described in reference to FIG. 1C.

The mainspring generator 156 can be a linear generator, in which 2 pistons are aligned against each other in linear alignment. When the pistons come together, they can ignite gas in a chamber without sparking a gas, thereby resulting in less emissions. Natural gas can be used for the mainspring generator, although the mainspring generator can be fuel agnostic, and may use biofuels, hydrogen, or other types of fuels. The mainspring generator 156 can be used to provide energy to components in the facility 105 in real-time. The mainspring generator 156 can also be used in scenarios when the batteries 152A-N and/or the solar arrays 154A-N may not be producing and/or providing sufficient levels of energy to components that perform operations in the facility 105 (e.g., at a present or current time, at one or more future periods of time).

The mainspring generator controller 190 can be configured to control operation (e.g., activation, deactivation, load tracking across components in the facility 105) of the mainspring generator 156. Accordingly, the mainspring generator controller 190 can include the component controller 192 and the software interface 194 described in reference to FIG. 1C.

The other facility components 160A-N can include other types of machines, devices, energy sources, energy storage units, energy production units, etc. that may be part of or associated with the facility 105. The other facility components 160A-N can include the respective component controllers 166A-N and software interfaces 168A-N, as described in reference to FIG. 1C. In some implementations, the other facility components 160A-N may include the refrigeration system 240A-N, blast cells 244A-N, compressors 248A-N, sensors 252A-N, and/or facility vehicles 254A-N.

The refrigeration systems 240A-N can include fans, heating, ventilation, and air conditioning (HVAC) units, or other types of cooling or freezing systems in the facility 105. The refrigeration systems 240A-N can be configured to adjust ambient conditions (e.g., temperature, humidity, barometric pressure) in one or more locations in the facility 105. For example, a first refrigeration system 240A can be configured to adjust and maintain temperature in a first set of storage locations/rooms in the facility 105 at a first predetermined temperature range while an nth refrigeration system 240N can be configured to adjust and maintain temperature in an nth set of storage locations/rooms in the facility 105 at an nth predetermined temperature range. Sometimes, one refrigeration system 240 can be used to control ambient conditions in the entire facility 105. In some implementations, the facility 105 can utilize a refrigeration system for each storage location, room, and/or zone in the facility 105. The refrigeration systems 240A-N can draw energy from one or more components described herein, such as the batteries 152A-N, the solar arrays 154A-N, the mainspring generator 156, the other facility components 160A-N, and/or the energy grid(s) 158A-N to perform operations in maintaining the ambient conditions in the facility 105, especially in anticipation of and/or during predicted times of energy shortages, poor weather conditions, and/or high energy prices. The refrigeration systems 240A-N can each be controlled by their respective controller(s) 242, which can be similar to the controllers described herein.

The blast cells 244A-N can include rooms and/or structures that are configured for freezing or chilling large quantities of items in the facility 105. For example, the blast cells 244a-N can be used to freeze pallets of food items once they enter the facility 105. The frozen pallets can then be routed to storage locations in the facility 105 until they are ready to be shipped to customers, consumers, or other relevant parties in a supply chain. The blast cells 244A-N can include any variety of components for freezing the items therein, including but not limited to storage racks or other frame structures for receiving the items to be frozen, fans, cooling or refrigeration units, evaporator units, vanes, air passages/channels, and/or other assemblies for guiding airflow to the items stacked/positioned inside the blast cells 244A-N. Each of the blast cells 244A-N can be controlled by their respective controller(s) 246. In some implementations, multiple blast cells 244A-N can be controlled by a single controller 246. The controller(s) 246 can be similar to the controllers described herein.

The compressors 248A-N can be air compressors that are configured to cool and dehumidify air in the facility 105, and/or in specific locations, rooms, zones, or other portions of the facility 105. The compressors 248A-N can include various components used for cooling and dehumidifying air in the facility 105, including but not limited to air ducts and filters throughout the facility 105. Operations of the compressors 248A-N can be controlled by the respective controller(s) 250. In some implementations, each of the compressors 248A-N can be controlled by an individual controller 250. Sometimes, at least a plurality or set of the compressors 248A-N can be controlled by a single controller 250. The controller(s) 250 can be similar to the controllers described herein.

The sensors 252A-N can be positioned throughout the facility 105. The sensors 252A-N can include temperature, humidity, motion, and/or image sensors. One or more other types of sensors can also be used in the facility 105. In some implementations, one or more of the sensors 252A-N can be configured to or otherwise part of components in the facility 105, such as the batteries 152A-N, the solar arrays 154A-N, the mainspring generator 156, the refrigeration systems 240A-N, the blast cells 244A-N, the compressors 248A-N, and/or the facility vehicles 254A-N.

As an illustrative example, the batteries 152A-N can include one or more types of sensors that are configured to measure current battery capacity, charge, discharge, production, storage, etc. The solar arrays 154A-N can include solar radiation sensors (e.g., pyranometers). Such sensors can be configured to measure broadband solar irradiance and/or solar radiation flux density. In other words, such sensors can measure power of light and/or heat from the sun, which can provide signals about how much solar energy is produced by the solar arrays 154A-N. The mainspring generator 156 can include one or more sensors for measuring current production. The refrigeration systems 240A-N can include temperature, humidity, and/or pressure sensors configured to measure ambient conditions and/or performance of the refrigeration systems 240A-N's components. The blast cells 244A-N can include temperature sensors, for example, configured to measure temperature values inside the blast cells 244A-N for use in determining whether blast cell operations and/or cycles should be performed or modified. Similarly, the compressors 248A-N may include inline ambient condition sensing devices to capture signals indicating temperature, pressure, and/or humidity levels throughout the facility 105. As another illustrative example, the facility vehicles 254A-N, such as forklifts, can include motion sensors, temperature sensors, and/or image sensors, all of which can capture and record various signals that can be used by the centralized controller 107 and/or the computer system 102 to determine energy performance optimizations and control decisions for the facility 105.

The facility vehicles 254A-N can include forklifts, robots, autonomous vehicles, cranes, and/or other types of vehicles or machinery that may be used in the facility 106 to perform operations therein. The facility vehicles 254A-N can be semi-automated and/or fully-automated vehicles and devices. The facility vehicles 254A-N can, in some implementations, be controlled or manually operated by human workers in the facility 105.

The other energy resources 270A-N can include other types of energy resources that may be used by the facility 105, including but not limited to mixed fuel sources, grid sources, and/or renewable energy sources, such as wind turbines, windmills, hydroelectric energy sources, nuclear energy sources, etc. Any of these energy resources 270A-N can be part of the facility 105 and/or remote from the facility 105. If remote, the energy resources 270A-N can be in electrical communication with the facility 105 to provide power/energy to components therein. In some implementations, the other energy resources 270A-N may also be controlled by controllers similar to the controllers described herein.

The centralized controller 107 can include processor(s) 272, the software interface 172, a model training engine 274, a signal processing engine 276, an output and/or control generator 278, a short-term optimization engine 280, a medium-term optimization engine 282, and/or an optional long-term optimization engine 284. As described herein, in some implementations the centralized controller 107 can be part of the computer system 102. In some implementations, the centralized controller 107 can be the same as the computer system 102. The processor(s) 272 can be configured to perform operations at the centralized controller 107 as described herein. The software interface 172 can provide communication between the centralized controller 107 and other components and controllers described throughout this disclosure. In some implementations one or more of the components 276, 278, 274, 280, 282, and/or 284 can be part of the computer system 102 described herein.

The model training engine 274 can be configured to generate, train, and iteratively improve one or more of the models described herein. For example, the model training engine 274 can retrieve training data 236A-N from the data store 106 to generate and train each of the models described herein. The model training engine 274 can also receive signals generated by one or more of the controllers described herein and/or determinations made by engines of the centralized controller 107 and/or the computer system 102 to be used in generating and training the models. The models generated by the model training engine 274 can be stored in the data store 106 as any one or more of state-space models 218A-N, optimization models 220A-N, and/or forecasting models 222A-N. One or more of the models can then be retrieved by the centralized controller 107 and/or the computer system 102 during runtime and used in determining performance optimizations, control operations, and/or energy sale and/or purchase decisions over one or more timeframes (e.g., current, future).

The signal processing engine 276 can be configured to process any one or more of the signals received from the controllers described herein. For example, the signal processing engine 276 can retrieve one or more of the models from the data store 106 and provide the signals as input to the retrieved models. The retrieved models can generate output indicating energy performance information (e.g., consumption, production, storage) of one or more components in the facility 105 over some period of time (e.g., a current time, real-time, near real-time, a projected future amount of time). In some implementations, the signal processing engine 276 can retrieve data from the data store 106, such as historic facility data 228A-N, facility schedules and/or operations 266A-N, and/or historic energy data 262A-N to further process the signals and determine the energy performance information over some period of time.

The short-term optimization engine 280 can be configured to determine one or more control operations that can be performed in a short-term timeframe in order to achieve energy performance optimization objectives of the facility 105 in the short-term, especially in light of predicted or forecasted energy market conditions made by the computer system 102. The engine 280 can receive the energy performance information generated by the signal processing engine 276. The engine 280 can also retrieve one or more of the models from the data store 106. The engine 280 can retrieve other data from the data store 106, such as the historic facility data 228A-N, facility schedules and/or operations 266A-N, historic energy data 262A-N, medium-term energy usage optimizations 258A-N, and/or long-term energy usage optimizations 260A-N. The engine 280 can also receive predictions and/or recommendations made by the computer system 102 for the short-term timeframe, such as predictions that energy prices are going to increase in the short-term timeframe and recommendations that batteries should be charged now so that the stored energy can be accessed during the short-term timeframe when energy prices in the energy market are unreasonably high for purchase.

The engine 280 can provide one or more of the received/retrieved data to the retrieved models in order to determine and generate component control instructions for execution in the short-term timeframe. In some implementations, the engine 280 can also retrieve one or more determinations criteria 268A-N from the data store 106, which can include criteria for determining how to achieve short-term energy performance optimization objectives for the particular facility 105 (e.g., expected and/or desired emission levels during the short-term timeframe, expected and/or desired energy production and/or energy storage levels during the short-term timeframe). The retrieved determinations criteria 268A-N can then be used by the engine 280 to determine and/or generate the component control instructions for execution in the short-term timeframe. Determinations made by the engine 280 can be stored in the data store 106 as short-term energy usage optimizations 256A-N.

The medium-term optimization engine 282 can be configured to determine one or more control operations that can be performed in a medium-term timeframe in order to achieve energy performance optimization objectives of the facility 105 in the medium-term. Determinations made by the engine 282 can be stored in the data store 106 as medium-term energy usage optimizations 258A-N. Refer to the short-term optimization engine 280 for further discussion. The centralized controller 107 can be configured to perform optimizations using the short-term optimization engine 280 and the medium-term optimization engine 282. The short-term optimization engine 280 can operate to re-optimize in an order of seconds, minutes, and up to 10 to 15 minute intervals. One or more other intervals that are less than 24 hours can also be possible. The medium-term optimization engine 282 can operate to re-optimize every 24 hours.

The optional long-term optimization engine 284 can be configured to determine one or more control operations that can be performed in a long-term timeframe in order to achieve energy performance optimization objectives of the facility 105 in the long-term. Determinations made by the engine 284 can be stored in the data store 106 as long-term energy usage optimizations 260A-N. The engine 284 can operate to re-optimize every 1 week. Refer to the short-term optimization engine 280 for further discussion.

In some implementations, the engines 280, 282, and 284 can collaborate and share determinations to iteratively improve their determinations made during runtime. For example, determinations made by the optional long-term optimization engine 284 can be fed back to the short-term optimization engine 280. The short-term optimization engine 280 can then determine updated short-term component control operations that may better achieve short-term energy performance optimization objectives of the facility 105, medium-term objectives, and/or long-term objectives.

The output and/or control generator 278 can be configured to generate instructions or other types of output based on determinations made at the centralized controller 102. For example, the generator 278 can receive determinations made by the engines 280, 282, and/or 284 and then generate component control instructions based on those determinations. The generator 278 can transmit the component control instructions to the respective controllers in the facility 105 for execution during the short, medium, and/or long-term timeframes. In some implementations, the generator 278 can retrieve the short-term energy usage optimizations 256A-N, the medium-term energy usage optimizations 258A-N, and/or the long-term energy usage optimizations 260A-N from the data store 106 to be used in generating the instructions and/or other output.

In some implementations, the generator 278 can generate output to be presented at a computing device of a relevant user in the facility 105. For example, the generator 278 can generate reports or other information about energy performance in the facility 105 per component and/or over one or more periods of time (e.g., current period of time, short-term, medium-term, long-term). The generator 278 can also generate information indicating recommended actions and/or controls to take in the facility 105 to achieve one or more short, medium, and/or long-term objectives in the facility. The relevant user can provide user input at the computing device (e.g., the user device 104) indicating selection of one or more recommended actions/controls to be executed in the facility 105. The relevant user can also provide other user input at the computing device, including but not limited to user-generated actions or controls to be performed by one or more components in the facility 105 (e.g., which may override current control operations for the one or more components).

As mentioned above, the data store 106 can be configured to store information such as the training data 236A-N and/or the models 218A-N, 220A-N, and 222A-N. The training data 236A-N can include any variety of data that may be used for generating and training the models. For example, the training data 236A-N can include determinations made by one or more of the controllers and/or the computer system described herein. The training data 236A-N can include one or more signals from the sensors 252A-N or any other signals and/or information generated by the other components of the facility 105. The training data 236A-N may also include any of the historic data, prior control determinations and/or performance indicators for the facility 105, or other data stored in the data store 106.

FIGS. 3A, 3B, and 3C is a flowchart of a process 300 for forecasting block energy hedges and generating recommended facility controls based on the forecasting. The process 300 can be performed by the computer system 102. The process 300 can also be performed by one or more other computing systems, devices, computers, networks, cloud-based systems, and/or cloud-based services (e.g., the centralized controller 107). For illustrative purposes, the process 300 is described from the perspective of a computer system.

Referring to the process 300 in FIGS. 3A-C, the computer system can receive data in block 302. The data may include but is not limited to historic data (block 304), block hedge price information (block 306), commodity procurement information (block 308), historic facility information (block 310), facility load information (block 312), energy information (block 314), energy resource information (block 316), and/or user-provided information (block 318). The information received in blocks 302-318 can be related to historical and real-time/forward-looking time periods. For example, the historical information can include but is not limited to energy market data, hedge price data, facility load data, natural gas price data, and/or additional user-provided info. The computer system may also generate statistically-derived relationship variables of any of these inputs. As another example, the current/forward-looking information can include but is not limited to energy market prices, futures hedge prices, natural gas futures and options prices, user-defined changes to facility operations or risk tolerance, etc.

Refer to at least block A (110) in FIG. 1A for further discussion about the types of data received in blocks 302-318. Any of the data described in blocks 302-318 can be received simultaneously or at different times.

Moreover, the data described in blocks 302-318 can correspond to same or different time periods in relation to a particular facility, a particular energy market, a particular type of energy, a particular geographic region (e.g., relevant to the facility and/or energy market). As an illustrative example, historic facility information (block 310) can be received for a past year that the facility was in operation while energy information (block 314) and/or energy resource information (block 316) can be received for a current time period and/or a past 1 month. As another illustrative example, any of the data received in blocks 302-318 can correspond to a same time period. If, for example, the user provides information (block 318) in a GUI display at their respective computing device that indicates a particular facility and a request for load forecasting for an upcoming 6 months, the computer system can retrieve any of the data in blocks 304-318 for a past 6 months and/or a 6 month period from the prior year that corresponds to the upcoming 6 months in the present year.

In block 320, the computer system can retrieve at least one model. The model(s) can be retrieved from a data store, as described herein. In some implementations, the model(s) can be locally stored at the computer system and then retrieve the model(s) using less compute resources and processing power. The model can include, but is not limited to, a state-space model (block 322), an optimization model (block 324), and/or a forecasting model (block 326). As described herein, the model can also include but is not limited to statistical and/or time-series models. Any one or more of the models can be used to perform the techniques described herein.

The computer system may provide the received data as input to the model in block 328. A subset of the received data can be provided as input. In some implementations, all of the received data can be provided as input.

The computer system can receive model output in block 330. For example, the model can be trained to forecast block hedge pricing over at least one predetermined period of time and provide that information as the model output (block 332). Sometimes, forecasting block hedge pricing can include quantifying risk associated with the various forecasted block edge prices. The output can include the forecasted block hedge prices over the predetermined period of time(s). The output can additionally or alternatively include graphs, charts, or other visual or graphical elements that visually depict the forecasted block hedge pricing determined by the model. The predetermined period of time can be provided by the user, such as in the user-provided information (block 318). For example, the user can provide input indicating a desire to view block hedge prices for an upcoming 2 weeks, 1 month, 6 months, 1 year, etc. The computer system can then provide the received data to the model(s) along with the user input, which the model(s) can be used to forecast the block hedge pricing for the period of time identified in the user input. The predetermined period of time can be determined by the computer system, for example based on periods of time corresponding to the received data (e.g., if the received data corresponds to a current period of time, the model can generate block hedge prices for the current period of time and/or a future period of time immediately following the current period of time).

As another example, the computer system can forecast the block hedge pricing over the at least one predetermined period of time based on the model output in block 332. In other words, the model can generate output indicating potential block hedge prices based on the provided inputs. The model output can include, for example, forecasted block hedge prices for 1 year following a current time period. The computer system can then process the model output to generate information about a particular period of time of interest to the user, such as 3 months following the current time period, a time period that is 1 year from the current time period, etc. Various other implementations are also possible.

The model can additionally or alternatively be trained to forecast facility load over at least one predetermined period of time in block 334. This information can then be provided as the model output. In some implementations, the computer system can forecast the facility load based on the model output in block 334. Similar to block 332, the model can generate output indicating potential facility loads over the at least one predetermined period of time (or one or more other periods of time) based on the provided inputs.

In some implementations, the forecasted block hedge pricing in block 332 can be determined at least in part based on the forecasted facility load information in block 334. In yet some implementations, the forecasted facility load information in block 334 can be determined at least in part based on the forecasted block hedge pricing in block 332. Sometimes, one or more of the forecasts described in blocks 332 and 334 can be determined based on other predictions, forecasts, or outputs generated by any of the models described throughout this disclosure. Refer to at least block B1 (112) in FIG. 1A for further discussion about forecasting energy and/or facility load information.

The computer system can generate, based on the model output (e.g., blocks 332 and/or 334), one or more recommendations for the particular facility (block 336). The recommendations can be generated to improve energy consumption and/or preservation for the facility. The recommendations can be generated to ensure the facility is able to complete one or more schedules of operations efficiently and on-time. In some implementations, the recommendations can be generated at least in part based on the forecasted block hedge pricing and/or facility load information in blocks 332 and 334, respectively, facility operational information, facility schedules, expected inbound and/or outbound deliveries for the facility over one or more periods of times (e.g., a current period of time, an immediate couple of hours, an immediate day, an immediate week, an immediate month). Operational and/or scheduling information about the facility can be received from one or more computing systems described herein, including but not limited to computing devices of relevant users (e.g., facility managers, facility workers, facility customers, delivery companies or other delivery workers), data stores, and/or warehouse management systems (WMSs) associated with the facility. Refer to at least block I (126) in FIG. 1A for further discussion about generating the recommendation(s) for the facility.

As illustrative examples of generating recommendations for the facility, the computer system can determine timing and/or cost for block hedge purchases over at least one predetermined period of time (block 338). The computer system can assess joint probability of price and/or load distributions over at least one predetermined period of time (block 340).

In reference to blocks 338, and 340, the computer system can assess the forecasted block hedge prices of block 332 in relation to the forecasted facility load information of block 334 to determine when the block hedge prices may be lower and more affordable to purchase at a time when facility load may be above a threshold value and/or higher than usual. As another example, the computer system can compare the forecasts of blocks 332 and 334 to determine when the facility load is expected to be below a threshold value and/or less than usual while block hedge prices are higher such that the facility could sell back blocks of energy to the energy market at the higher block hedge price. The computer system can accordingly generate recommendations for when the facility can purchase block hedges and/or when the facility can sell block hedges. In some implementations, the computer system can generate recommendations indicating how many block hedges the facility can purchase and/or sell at one or more periods of time based on analysis of the model output or other information described in blocks 332 and 334.

As yet another example, the computer system can determine recommendations of one or more set points for controlling one or more components in the facility to reduce load (block 344). Similar to blocks 338-340, the computer system can assess forecasted information as described in blocks 332 and 334 and other information/data described herein to determine when and for how long the facility should reduce load (e.g., because energy prices are above a threshold value or higher than usual, there is an expected energy supply shortage, there is an expected energy demand increase, there is an expected change in weather such as hotter temperatures than usual or increased cloud coverage or no wind, etc.). Based on determining when and for how long the facility should reduce load, the computer system can determine recommendations to control components in the facility that can be adjusted to achieve the reduced load without compromising on efficiency of the facility and/or ability of the facility to complete operational schedules. For example, the computer system can determine that to reduce load during an afternoon time period when hotter temperatures than usual are expected, the computer system can recommend that the facility delay blast cell cycle operations (e.g., turn off blast cell cycle operations for a predetermined quantity of blast cells for a predetermined period of time) and then restart those operations during a night time period when temperatures are cooler (therefore less energy can be consumed by the facility during the afternoon time period). The computer system can also generate recommendations for the facility to perform less load-intensive operations during the afternoon time period, such as putaway and/or pallet picking tasks performed manually or automatically by human workers and/or vehicles in the facility (e.g., forklifts, autonomous vehicles, robots). The computer system can balance operations and energy load usage for the facility to ensure that the facility efficiently performs operations and, more generally, efficiently utilizes energy resources. In some implementations, the computer system may simply provide the model output to a centralized controller of the facility in block 344, which can then determine the controls based on the provided output.

In some implementations, as described above, the computer system can also assess the information described herein to determine when and for how long the facility should increase load (e.g., because energy prices are less than a threshold value or lower than usual, there is an expected energy supply surplus, there is an expected decrease in energy demand across the energy market, there is an expected change in weather such as cooler temperatures or decreased cloud coverage or increased wind, etc.).

One or more other recommendations may also be generated, as described throughout this disclosure. In some implementations, one or more of the recommendations described in blocks 336-344 can be determined by other components, including but not limited to the centralized controller 107 as described in at least FIG. 1A.

In block 346, the computer system can generate one or more GUIs for presenting the model output and/or recommendations to a relevant user associated with the facility. The computer system can also return the recommendation(s), model output, and/or GUIs in block 348. For example, the computer system can store the returned information in a data store (block 350). The computer system can transmit the returned information to a user device for presentation in a GUI display (block 352). The computer system can transmit the returned information to a control system of the facility (block 353). Refer to at least FIGS. 1A, 1B, and 6-11 for further discussion.

Optionally, the computer system may receive user input indicating one or more optimization parameters or adjustments to the information presented in the GUI display at the user device (block 354). For example, the user may review the recommendations and/or forecasted information presented in the GUI display and decide that the user would like to purchase one or more block hedges over one or more upcoming periods of time. The user can provide input indicating when to purchase the block hedges and/or how many block hedges to purchase. As another illustrative example, the user may decide to ramp up refrigeration system(s) and/or fan(s) usage during a period of time when energy prices are expected or forecasted to be lower than usual or less than a threshold level. The user can provide input indicating a desire to adjust the refrigeration system(s) and/or fan(s), which the computer system can use to generate instructions to control the components accordingly. As another example, a centralized controller of the facility and/or controllers of the particular components can generate the instructions. The computer system, centralized controller, and/or controllers of the particular components can also be configured to execute the instructions during the period of time indicated by the user input. For further discussion, refer to at least blocks D-J (116-128) in FIG. 1A and blocks D1-I (138-148) in FIG. 1B.

The computer system may then optionally provide the user input as input or additional input to the model in block 356 and return to block 330. In some implementations, the user input can be used to iteratively train the model so that the model improves its processing of received inputs and output generation. As a result, the model can generate outputs over time that are increasingly aligned with information, operations, and/or efficiencies associated with the particular facility. Returning to block 330 allows the computer system to adjust the determined recommendations and/or projected conditions in the energy market according to the user input. In some implementations, instead of returning to block 330 and/or providing the user input as input to the model in block 356, the computer system may use the user input as weights to dynamically adjust one or more of the forecasting block hedge prices (block 332), the forecasted facility load (block 334), and/or the one or more recommendations (blocks 336-344). Using the user input as weights can advantageously and efficiently utilize available compute resources and processing power so that determinations can be made in real-time or near real-time. In other words, determinations can be made and/or updated/adjusted in real-time or near real-time as conditions change in the facility, energy grid, and/or energy markets. As a result, the facility can readily adapt to such changes to continue operating as best and as efficiently as possible.

In some implementations, the process 300, or one or more blocks of the process 300, can be iteratively and/or continuously performed. In some implementations, the process 300 can be performed at predetermined times (e.g., once a day, every other day, every 3 days, every week, once a month, twice a month, etc.). The process 300 can be performed as a result of one or more predefined triggers. For example, the process 300 can be automatically triggered when weather data is received that indicates a heatwave or other condition that may adversely impact energy production, supply, and/or prices. As another example, the process 300 can be triggered when user input is received that indicates the user's desire to determine and/or view forecasted block energy hedge prices, forecasted facility load(s), changes to the facility operations and/or component schedules or controls, etc. One or more other triggers are also possible.

FIGS. 3D and 3E is a flowchart of a process 360 for controlling a facility based on forecasted block energy hedges. The process 360 can be performed by the computer system 102. The process 360 can also be performed by one or more other computing systems, devices, computers, networks, cloud-based systems, and/or cloud-based services (e.g., the centralized controller 107). In some implementations, the computer system 102 can also function as the centralized controller 107 of a particular facility and thus perform the process 360. For illustrative purposes, the process 360 is described from the perspective of a computer system.

Referring to both FIGS. 3D and 3E, the computer system can receive and/or retrieve information for a predetermined period of time for a facility in block 362. For example, the computer system can receive and/or retrieve current and/or future energy hedges for the facility (block 363), energy pricing information for a current period of time (block 364), weather, energy, grid, and/or other external information (block 366), facility usage, inbound trucks (e.g., quantity, frequency), outbound trucks (e.g., quantity, frequency), activity heat generation (e.g., in response to performing one or more operational schedules in the facility such as moving forklifts and/or autonomous vehicles around the facility to put items away and/or pull items for customer deliveries), and/or other internal facility information (block 368), and/or facility operational set point(s) (block 370). Refer to at least FIG. 1A for further discussion about the information.

The predetermined period of time can be a current, past, and/or upcoming period of time or multiple periods of time. In some implementations, the computer system can receive and/or retrieve information from various different periods of time. For example, the computer system can retrieve energy hedge prices corresponding to a past period of time that is similar to an upcoming period of time (e.g., similar as in the sense that surrounding external conditions, such as weather and/or market conditions, are similar between the past period of time and the upcoming period of time). The computer system can also retrieve weather information for the upcoming period of time and/or the current period of time.

As described herein, the information can be retrieved and/or received from various different computing systems. For example, the information can be retrieved from one or more data stores. The information can be received from one or more user devices described herein. The information can be received from one or more warehouse management systems (WMSs), facility control systems, facility controllers, facility sub-controllers, controllers of one or more components or assets in the facility, etc. The information can be received from computing systems associated with one or more energy grids, energy markets, energy resources, components or assets in the facility, or other energy resources in communication and/or association with the facility. The information may be received from one or more other computing systems that may correspond to external and/or third party providers or parties, including but not limited to weather reporting systems and/or entities, energy reporting systems and/or entities, other facilities, customers of the facility, etc.

Based on the information, the computer system can determine at least one upcoming energy event (block 371). For example, the computer system can provide at least some of the information to a machine learning model that was trained to determine or otherwise project upcoming energy events. In some implementations, block 371 can be performed as part of blocks 372-376 described further below.

In block 371, the model can be trained to project one or more different types of energy events that may occur based on processing of the information. The model can be trained to project or forecast a likelihood of weather conditions occurring during the predetermined period of time that may impact (e.g., negative impact, positive impact) ability of one or more types of energy to be produced, stored, and/or consumed. For example, the model can be trained to project that during the predetermined period of time, cloud coverage may increase from 45% to 90%, thereby causing solar energy production to reduce or otherwise slow down during the predetermined period of time. In turn, the model can be trained to classify these projected weather conditions as an energy event in block 371. As another example, the model can be trained to project that during the predetermined period of time, demand for energy by the particular facility may decrease (e.g., because the facility will be receiving less than a threshold amount of inbound and/or outbound trucks and/or deliveries, because fewer items will need to be chilled and therefore fewer blast cell cycles may be performed, because more human workers will be working at the facility and therefore requiring less energy for use by autonomous vehicles or other facility components to complete facility operations). Because the model projects that demand for the energy may decrease, the model can generate output identifying a likely hood of increased supply of energy and lower energy prices during the predetermined period of time. In other words, the model may classify this scenario of increased energy supply as an energy event in block 371.

The computer system can retrieve at least one model in block 372. The computer system can apply the model to the information in block 374. As described herein, the computer system can retrieve the model(s) from one or more data stores. The model can be any one or more of a state-space model, statistical model, time-series model, forecasting model, or any other type of machine learning model described herein.

In block 376, the computer system can determine, based on applying the model to the information and the upcoming energy event(s), one or more facility adjustment recommendations to maintain facility operations at or below the facility operational set point(s) for the predetermined period of time. For example, the computer system can apply a set of rules to the model output to determine, for one or more predetermined periods of time, (i) whether and when to cut energy usage in the facility and/or (ii) what portion of the facility's future energy hedges can be sold back to an energy market at a profit while maintaining the facility's operations at or below the facility's predetermined set point. Refer to at least block I (126) in FIG. 1A, blocks D1-E (138-140) in FIG. 1B, and blocks 336-344 in the process 300 of FIGS. 3A-C for further discussion.

In block 378, the computer system can determine, for example, a threshold amount of energy usage to cut. This determination can be made based on, for example, assessing historic facility information. The historic facility information can indicate what energy usage levels the facility has been able to operate at in the past while still completing scheduled operations on-time and/or efficiently. This determination can also be made based on assessing projected energy supply of the energy market, energy usage by the facility, market conditions, weather conditions, block energy hedge prices, etc. to determine how much energy usage to cut for the facility while still maintaining the facility at desired or expected operational levels.

Additionally or alternatively, the computer system can determine a threshold quantity of the energy hedges to sell back at a profit (block 380). Additionally or alternatively, the computer system can determine a threshold quantity of the energy hedges to keep to maintain facility operations (block 382). Refer to blocks 338-340 in the process 300 of FIGS. 3A-C for further discussion.

In block 384, the computer system can optionally generate recommendations to control one or more components or assets in the facility based on the determined facility adjustment(s). Sometimes, the recommendations may be generated in a different process and/or by a different computer system associated with a particular facility. For example, the energy hedging strategies, events, and/or pricing can be determined by the computer system using the processes described herein. Such information can be determined for a plurality of facilities, then transmitted to computing systems associated with each of the facilities. The respective computing systems may then use the transmitted information to generate the recommendations for controlling components or assets in the respective facilities. In some implementations, the controls can be determined by a centralized controller of the facility and/or individual component controllers, as described in reference to FIGS. 1-2. The centralized controller can then control respective facility components according to the generated controls to reduce consumption for the future period of time.

For example, the computer system (or the centralized controller) can optionally adjust one or more blast cell schedules (block 385). As another example, the centralized controller can optionally adjust a quantity of operating blast cells (block 386). To reduce load during a period of peak energy prices, the centralized controller can generate controls that cause at least one blast cell in the facility to pause or stop blast operations during the period of peak energy prices, so long as such a schedule adjustment is balanced against other operations in the facility to ensure that facility tasks are performed on time and/or food safety regulations associated with food items that would be blast cooled according to the blast cell schedules.

As another example, to reduce load during a period of peak energy prices, the centralized controller can optionally generate controls that cause a threshold quantity of the blast cells (e.g., all blast cells, blast cells that are partially full or filled to at least a predetermined threshold capacity, completely filled blast cells) in the facility to perform blast operations for a period of time before the peak energy prices and/or a period of time after the peak energy prices. As yet another example, to reduce load during a period of peak energy prices, the centralized controller can optionally generate controls that cause a threshold quantity of the blast cells to operate at cooler temperatures, with more fans, and/or at a level that requires greater energy consumption than current controls and/or typical controls for the blast cell(s). As another example, to address a period of time of expected increased facility load, the centralized controller can generate controls that cause at least one blast cell to be operated once the blast cell is filled to capacity. Sometimes, the centralized controller can generate controls that cause multiple blast cells to operate so long as each blast cell is filled to at least a threshold capacity level during or before the period of time of increased facility load. The centralized controller can optionally generate any of these controls based on assessment of the data or information described herein in reference to the facility and/or energy market(s) as well as model determinations/output.

The computer system/centralized controller can optionally determine to activate or deactivate a refrigeration system (block 387). For example, to reduce load during a period of peak energy prices, the centralized controller can generate controls that cause at least one refrigeration system to operate at lower, power-saving settings and/or pause operations. The centralized controller can generate controls that cause the at least one refrigeration system to operate at higher power settings during a period of time before the peak energy prices so that the facility can be cooled to a facility set point by the time the peak energy prices occur. Then, when the peak energy prices occur, the refrigeration system can be stopped or caused to operate at lower power-saving settings. The centralized controller can determine individual controls for each refrigeration system in the facility. The centralized controller can determine controls that apply to all or a subset of the refrigeration systems in the facility.

The computer system/centralized controller can optionally generate controls that include adjusting a quantity of pallets being moved in and/or out of one or more locations in the facility (block 388). For example, to reduce load during periods of time of forecasted high energy prices and/or forecasted high facility loads, the centralized controller can generate controls that cause human workers and/or facility vehicles to move fewer quantities of pallets (e.g., less than a threshold quantity) in the facility during the identified periods of time or increase the quantity of pallets moved before or after the identified periods of time. The centralized controller can also generate controls that adjust how many pallets are moved based on whether the pallets are being moved in and/or out of cold storage rooms (in which fewer quantities of pallets may be moved to avoid causing fluctuations in temperature in the cold storage rooms during the identified periods of time when other components, such as refrigeration systems, may be operating at lower power settings) and/or distances that the pallets are being moved (e.g., the greater the distances, the fewer pallets that may be moved during the identified periods of time).

The computer system/centralized controller can optionally generate controls that include adjusting one or more schedules for loading and/or unloading trucks or other delivery vehicles at the facility (block 389). For example, to reduce load during an afternoon of forecasted high energy prices, the centralized controller can generate instructions that, when transmitted to computing devices of relevant users (e.g., facility operators, facility workers, facility vehicles, delivery workers, facility customers), instruct the relevant users to deliver (e.g., load and/or unload) one or more delivery vehicles during the evening, night time, or early morning (e.g., when energy prices are forecasted to be lower or less than a threshold value, when ambient temperature is expected to be lower than the afternoon temperatures) instead of during the afternoon.

The computer system/centralized controller can optionally generate controls that include adjusting a quantity of vehicles and/or workers in operation in the facility (block 390). For example, to reduce load during forecasted high energy prices, the centralized controller can generate instructions that, when transmitted to computing devices of relevant users (e.g., facility operators, facility workers, facility vehicles, delivery workers, facility customers), instruct the relevant users to reduce the quantity of vehicles and/or workers in operation below a threshold quantity. The centralized controller can generate instructions to increase the quantity of vehicles and/or workers in operation above the threshold quantity during a time of forecasted low energy prices, before the forecasted high energy prices, and/or after the forecasted high energy prices.

The computer system/centralized controller can optionally generate controls that include charging one or more batteries or other assets in the facility (block 391). The centralized controller can optionally generate controls that include discharging stored energy from one or more assets to perform current facility operations and/or upcoming/future facility operations (block 392). For example, to compensate for a period of projected high energy prices, the centralized controller can generate controls that cause one or more batteries to charge during forecasted low energy prices and/or forecasted low facility loads. Therefore, stored energy from the batteries can be used during the period of projected high energy prices so that the facility can continue to operate efficiently without requiring purchases of block energy hedges at the high energy prices. Although charging and discharging is described from the perspective of batteries, one or more other energy sources can be used for blocks 391 and 392, including but not limited to solar arrays, wind turbines, mainspring generators, and/or other energy resources described herein.

In block 393, the computer system can optionally transmit the recommendations and other information described herein to the centralized controller of the facility. The centralized controller may then generate and/or execute one or more of the controls described herein.

FIG. 4 is a flowchart of a process 400 for forecasting block energy hedges based on user-inputted optimization parameters. The process 400 can be performed by the computer system 102. The process 400 can also be performed by one or more other computing systems, devices, computers, networks, cloud-based systems, and/or cloud-based services (e.g., the centralized controller 107). For illustrative purposes, the process 400 is described from the perspective of a computer system.

Referring to the process 400 in FIG. 4, the computer system can determine block hedge prices for a predetermined facility over a predetermined period of time (block 402). Refer to the process 300 in FIGS. 3A-C for further discussion.

In block 404, the computer system can generate one or more GUIs illustrating the determined block hedge prices and selectable optimization parameters to adjust hedge information presented in the GUIs and/or determined block hedge prices. Refer to FIGS. 6A-C for further discussion about the GUIs that illustrate the determined block hedge prices. Refer to FIGS. 7A-B for further discussion about the GUIs that include selectable optimization parameters to adjust the hedge information presented in the GUIs.

The computer system can, in block 406, transmit instructions to a user device to present the GUIs and optimization parameters for the facility over the period of time. The period of time can be determined and selected by the user, according to user input that they provide in the GUI presented at their user device. In some implementations, block 406 can be performed in response to receiving user input from the user device indicating a desire of the user to view the determined block hedge prices for the user-determined period of time.

The computer system may also receive user input for one or more of the optimization parameters in block 408. For example, the user input can include one or more price metric(s) (block 410), load forecast metric(s) (block 412), price uncertainty metric(s) (block 414), load uncertainty metric(s) (block 416), price-load correlation metric(s) (block 418), and/or risk weighting metric(s) (block 420). Refer to FIGS. 7A-B for further discussion about the abovementioned optimization parameters.

In block 422, the computer system can apply the user input to a model for determining the block hedge prices. The computer system can receive model output indicating updated block hedge prices for the facility over the period of time based on the user input in block 424. The optimization parameters defined by the user can be provided as model inputs to adjust the block hedge prices that are forecasted for the predetermined period of time. The same model can be used to determine the block hedge prices in block 402 and then adjust the block hedge price determinations based on the user input in block 422. In some implementations, different models can be used for performing blocks 402 and 422.

In some implementations, the computer system may use the user input as one or more weights to adjust the block hedge prices that were determined in block 402 and/or modify the GUIs illustrating the block hedge prices and/or the hedge information presented in the GUIs. Therefore, the user input may not be provided as input to the model in block 422. Instead, the computer system can adjust the model output from block 402 according to the user input. For example, in block 402, the model output can indicate forecasted high energy prices over the period of time and a recommendation to purchase more block energy hedges in advance of the period of time. The user can provide input indicating that the facility is less risk adverse when energy prices fluctuate as identified in block 402. Based on this input, the computer system may determine that the facility can purchase fewer blocks in advance of the period of time than what was initially recommended in block 402.

In block 426, the computer system can generate updated recommendations for buying and/or selling hedges based on the model output, as described above. The computer system can generate recommendations indicating when hedges can be bought and/or sold. The computer system can generate recommendations indicating how many hedges can be bought and/or sold. The computer system can also generate recommendations indicating adjustments to facility operations and/or components in the facility. Refer to FIGS. 1-3 for further discussion.

Accordingly, the computer system can update the GUIs in block 428. The computer system can then transmit the updated GUIs to the user device for presentation in block 430. Refer to FIGS. 6B and 6C for further discussion about an illustrative example in which forecasted block hedge prices are adjusted when the user provides input indicating lower risk tolerance (FIG. 6B) versus higher risk tolerance (FIG. 6C).

The process 400 may then stop. The process 400 or blocks in the process 400 may be repeated. For example, if the user views the updated GUIs and decides to perform one of the recommendations presented therein, the user can provide input indicating such. The computer system can then perform or transmit instructions to components and/or systems in the facility to perform the user-identified recommendations. The computer system may also use the user input as a weight to adjust one or more of the hedge information presented in the updated GUIs. The hedge information can be continuously updated in real-time or near real-time such that the user can view relevant up-to-date information about the facility for efficiently controlling the facility.

In some implementations, the user input can be used to iteratively train and improve the model(s) described herein. The model can learn preferred optimization parameters of the facility (e.g., the facility's level of risk tolerance) and use those learnings to better forecast energy hedge prices, facility load, or other information for the particular facility. The model can also learn the preferred optimization parameters of the facility to better generate recommendations for adjusting operations in the facility that optimize facility performance and energy consumption.

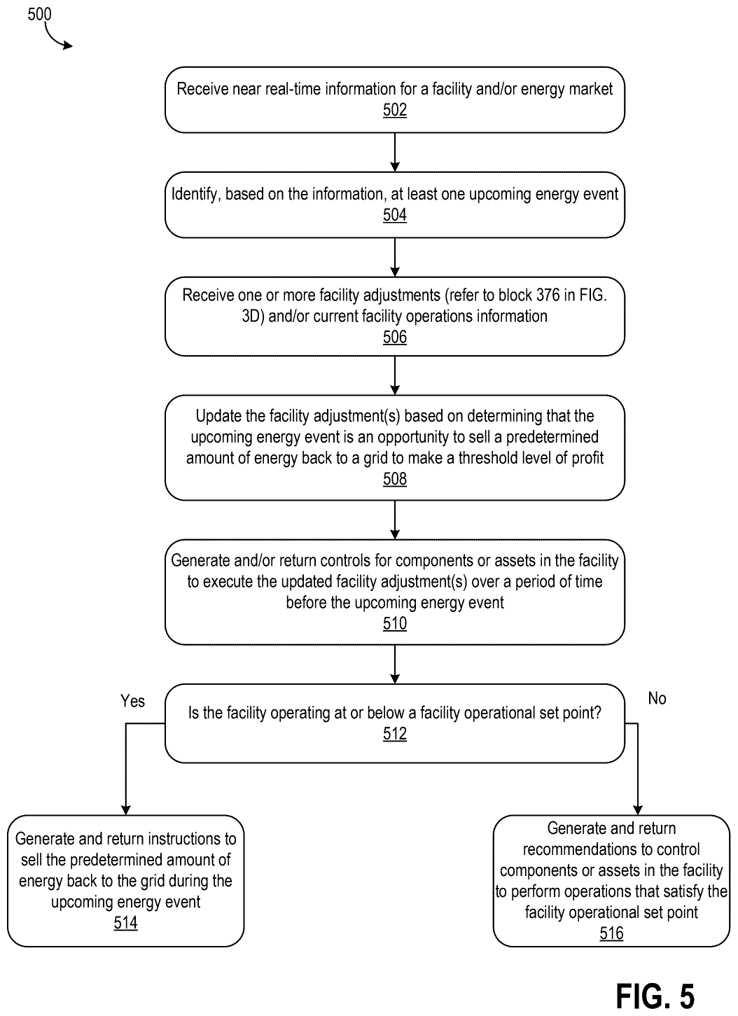

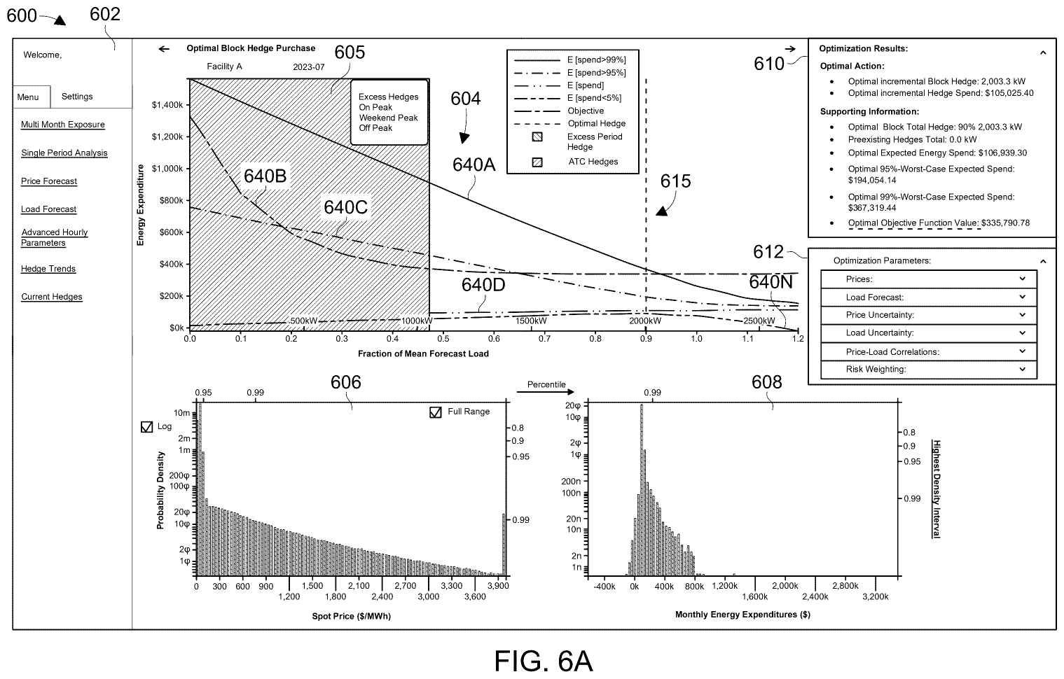

FIG. 5 is a flowchart of a process 500 for adjusting schedules for purchasing and selling block energy hedges based on continuous identification of current and/or upcoming events associated with a facility. As an illustrative example, the process 500 can be performed in a scenario in which the facility may not want to reduce their energy consumption and sell back energy for 1 hour but an energy event (e.g., an energy shortage, increased energy demand, increased energy prices) persists for 2 hours. After all, if the facility cut back their consumption for 1 hour and sold back energy to make profit during the energy event, they may have to purchase energy at a higher energy price for the remaining 1 hour of the energy event. In such a scenario, the process 500 can be performed to determine (i) when the facility can sell back energy and, if an energy event is forecasted, (ii) how to get the facility into an operational position to sell back energy during the forecasted energy event to make profit. To get the facility into an operational position to sell back energy and profit during the forecasted energy event, the process 500 can be performed to adjust blast cell schedules, loading and unloading operations in the facility, refrigeration system activation/deactivation, battery charging/discharging, etc.

The process 500 can be performed by the computer system 102. The process 500 can also be performed by one or more other computing systems, devices, computers, networks, cloud-based systems, and/or cloud-based services (e.g., the centralized controller 107). For illustrative purposes, the process 500 is described from the perspective of a computer system.

Referring to the process 500 in FIG. 5, the computer system can receive near real-time information for a facility and/or energy market (block 502). The information can be received from computing systems associated with the facility and/or the energy market (e.g., WMSs, user devices, controllers, data stores, etc.). Refer to FIGS. 1C and 2A-B for further discussion. The computer system can receive real-time information in block 502. In some implementations, the computer system can receive information for a past period of time (e.g., a past 15 minutes, a past hour, a past 12 hours, a past day, a past 2 days, a past week, a past month, etc.).

The facility information can include, as illustrative examples, operational schedules, expected deliveries and/or pick ups of items (e.g., pallets, cases), schedules for moving the items in and out of locations in the facility, schedules for facility workers and/or vehicles that will be working/operating at one or more periods of time, schedules for blast cell operations, schedules for refrigeration system operations, schedules for collecting energy from resources described herein, schedules for charging facility batteries, schedules for discharging saved energy from facility batteries or other energy sources, inbound and/or outbound customer orders, inbound and/or outbound delivery information, pallet or other item information, etc. The energy market information can include, as illustrative examples, energy demand, energy supply, energy availability, weather conditions impacting energy collection, storage, and/or discharge, energy prices, grid conditions, blackout information, brownout information, etc.

The computer system can identify, based on the information, at least one upcoming energy event (block 504). The energy event can be, for example, an energy shortage, an increase in energy demand, an increase in energy prices, a blackout, a brownout, higher ambient temperatures, decreased windy conditions, decreased sun conditions etc. In some implementations, the energy event can be an energy surplus, a decrease in energy demand, a decrease in energy prices, lower ambient temperatures, increased windy conditions, increased sun conditions, etc. The computer system can identify the energy event based on applying one or more rules to the received information.

The computer system can identify the energy event by providing the received information as input to a machine learning model described herein. The model can be trained to forecast the energy event based on any combination of the received information. In some implementations, the model can generate a confidence value indicating a likelihood that an energy event and/or a particular type of energy event will occur. The computer system can then determine whether the energy event will occur based on comparing the confidence value to one or more threshold levels and/or ranges of values. The computer system can identify the energy event based on the confidence value being above a threshold level.

The computer system can also identify the particular type of energy event based on the confidence value determined by the model as to a type of the energy event. For example, if the confidence value for an energy shortage is above a first threshold value and a confidence value for an energy surplus is less than a second threshold value, the computer system can identify the energy event as an energy shortage. Similarly, if in the aggregate, one or more confidence levels satisfy one or more criteria for identifying a particular type of the energy event, then the computer system can identify the particular type of the energy event. For example, if the model generates confidence values for types of energy events such as energy shortage, poor weather conditions, and increased energy prices, the computer system can aggregate (e.g., summate, average, find the median and/or mean) these values and compare the aggregate value to a threshold value or level. If the aggregate value exceeds the threshold value, the computer system can identify the energy event as a negative energy event. On the other hand, if the aggregate value is less than the threshold value, the computer system can identify the energy event as a positive energy event and/or a neutral energy event. Various different ranges and/or threshold levels can be used to measure and identify the energy event.

In block 506, the computer system can receive one or more facility adjustments (refer to block 376 in FIG. 3D) and/or current facility operations information. The facility adjustments and/or operations information can be received from components in the facility, such as controllers described at least in reference to FIGS. 1-2. The facility adjustments can include adjustments to operational schedules and/or controls of one or more components or assets in the facility, as described further in reference to block 376 in FIG. 3D. The facility operations information can indicate tasks that are being performed and/or about to be performed, quantities of workers and/or vehicles working in the facility, quantity of items being moved in and out of locations in the facility, inbound and/or outbound delivery vehicle operations, blast cell cycles and other operational information, etc.

The computer system can update the facility adjustment(s) based on determining that the upcoming energy event is an opportunity to sell a predetermined amount of energy back to a grid to make a threshold level of profit (block 508). For example, the facility adjustments can include turning on a blast cell over the period of time of the energy event (when energy can be sold back to the grid for profit). At that time, the blast cell may be at near or full capacity. The computer system can determine, as described above, that that the blast cell may be filled to at least a threshold capacity (e.g., a capacity that, for the particular facility, may be enough to run the blast cell efficiently) some time before the energy event and that the blast cell can be operated before the energy event. The blast cell can consume energy at lower energy prices before the energy event such that when the energy event occurs, the blast cell can be turned off and the facility can sell back excess energy, and/or the predetermined amount of energy which can be more or less than the excess energy, to the energy grid. Accordingly, the computer system can update the facility adjustments so that the blast cell operates during a particular period of time before the energy event and is turned off or paused during the energy event.

In some implementations, the computer system can determine the amount of energy to sell back to the grid based on current energy usage and/or expected or forecasted energy usage of the facility during the time period leading up to the energy event. The computer system can also determine the amount of energy to sell back based on expected energy usage of the facility during the energy event (e.g., if the facility needs more energy and the facility does not have sufficient amount of stored energy, then the facility may sell back less of their energy to the grid during the energy event). The computer system can determine the amount of energy to sell back based on expected energy usage for some period of time after the energy event. In some implementations, the computer system can determine the amount of energy to sell back based on optimization parameters that are provided by a relevant user, as described further in reference to FIGS. 7A-B. For example, the user can provide input indicating that the facility is willing to take on more risk. As a result, the computer system can determine that the facility should sell back a larger amount of their energy during the energy event to make more profit than if the facility were less risky. This determination can be made even if, for example, the computer system forecasts that the facility may not have enough stored energy during the energy event to complete its operations because the facility may be efficient at bouncing back and efficiently completing operations after experiencing energy shortages.

In some implementations, the computer system can determine the amount of energy to sell back based on the predetermined level of profit sought. The user can provide input indicating how much profit the facility would like to make in a scenario in which the facility sells energy back to the grid. The computer system can determine the level of profit to make based on processing and analyzing the different types of information and data described herein. The computer system can apply rules and/or criteria to the information and data to determine how much profit should be realized to compensate for potential loss in efficiency over the period of time that the energy event occurs. Various other considerations can also go into determining how much profit should be made to make selling back energy rather than using it a good decision for the facility.

The computer system can generate and/or return controls for components or assets in the facility to execute the updated facility adjustment(s) over a period of time before the upcoming energy event (block 510). In some implementations, as described at least in reference to FIG. 1A, a component in the facility, such as a centralized controller, can determine controls for the components in the facility based on the updated facility adjustments in block 508.

As part of updating the facility adjustments in block 508, the computer system can determine for how long the updated adjustments should be performed. As an illustrative example, if the computer system forecasts that the energy event will occur for a short period of time (e.g., 15 minutes to 1 hour) and the computer system determines that facility operations and efficiency will not be compromised during that period of time should operations be paused, the computer system can generate controls to cause the blast cell(s) in the facility to pause or stop for the period of time that the energy event occurs. The computer system can determine that the blast cells do not need to be run some period of time before the energy event. The computer system can also determine that during the energy event, minimal energy can be used to load the blast cells with more items so that once the energy event ends, the blast cells can be turned on to freeze a larger quantity of items than had the blast cells been turned on as originally instructed during the energy event.

As another illustrative example, the computer system can forecast that the energy event may last a long time (e.g., days, weeks). The computer system can determine that during that time, facility operations must continue, but by consuming lower amounts of energy than during normal operational times. The computer system can determine and generate controls that cause refrigeration systems and/or fans to operate continuously and/or at higher rates during a short term leading up to the energy event so that the facility can be brought down to a predetermined set point (e.g., temperature, humidity, other ambient conditions) for that facility. The computer system can additionally or alternatively generate controls that cause batteries and other energy resources described herein to charge and/or store greater quantities of energy than during normal operational times. The charging and storing controls can be executed a period of time before the energy event that is long enough to cause the facility to build up a sufficient amount of stored energy to operate normally or at some predetermined facility set point during the energy event. The further out the computer system projects the energy event, the earlier on the computer system can generate and execute controls that affect operations in the facility to help the facility during the energy event.

The computer system can additionally or alternatively modify loading and/or unloading schedules in the facility so that more energy-intensive tasks (e.g., moving items in and out of cold storage rooms) are performed during normal operational times and less energy-intensive tasks (e.g., picking items in a room, building a pallet in a room, loading or unloading a delivery truck) are performed during the energy event. The computer system can also determine and generate controls based on assessing facility information described herein and identifying baseline operations that can be performed by the facility during the energy event to ensure the facility meets scheduling goals and other efficiency targets while also profiting off sell-back of some quantity of excess energy. Any of the models described herein, such as a forecasting model, can be used to determine a balance of operations, energy consumption, and energy selling for the particular facility.

Sometimes, the process can stop after block 510. Sometimes, after block 510, the controls can be executed by the respective facility components at a time indicated by the controls. Sometimes, the process 500 can continue to block 512, described below.

In block 512, the computer system can determine whether the facility is operating at or below a facility operational set point. Block 512 can be performed to determine if and when it may be time to sell energy back to the grid. Block 512 can be performed immediately after block 510 or some time after block 510. For example, block 512 can be performed immediately before the time of the energy event. Block 512 can be performed during the time of the energy event. In some implementations, block 512 can be performed iteratively, continuously, and/or at predetermined time intervals (e.g., every 15 minutes, every 30 minutes, every 1 hour, every 5 hours, every 10 hours, every 12 hours).

The determination can be made in block 512 based on data that is received or retrieved by the computer system. For example, the computer system can receive real-time or near real-time operational data or information from components in the facility (e.g., temperature sensors throughout the facility, refrigeration or other cooling systems, sensors in and around blast cells, user-inputted information provided by facility workers, sensor data collected by sensors attached to facility vehicles or positioned throughout the facility, WMSs, controllers of components or assets in the facility, centralized controller of the facility, etc.). This information can indicate current or near real-time temperature values in the facility, energy consumption, usage, and/or wattage information (e.g., on a facility component level, on a facility level, on a task level, on a customer level, on an item level, on a facility vehicle level, on a facility worker level), task schedules, statuses of task completion (e.g., on a facility level, on a customer level, on a pallet or item level, on a facility worker level, on a facility vehicle level), etc.

The facility operational set point can be determined by a relevant user of the facility, such as a facility or warehouse manager. In some implementations, the facility operational set point can be determined by the computer system or a computing system associated with the facility, such as a WMS. The facility operational set point can be determined based on analysis of historic facility operational information. This analysis can also be made in light of historic energy market information. In other words, the computer system can assess how the facility has been able to perform over time during various different energy market conditions. The computer system can assess the above mentioned information to determine what may be considered normal operational conditions of the facility in which the facility completes scheduling tasks efficiently, timely, in a profitable way, and while efficiently consuming energy or other resources. The facility operational set point can include one or more different values, including but not limited to temperature values at which the facility (or rooms or other locations in the facility) should be maintained, quantity of facility vehicles and/or human workers that should be working during a given time, quantity of inbound and/or outbound tasks that can be performed during the given time, quantity of unloading and loading truck tasks that can be performed during the given time, quantity of items to be put into blast cells, temperature values and/or capacity levels for operating blast cells, power consumption levels for operating refrigeration systems, charging and/or energy storing levels for batteries and other resources, etc. Any of the above mentioned values can be determined for the given time and/or under conditions in which the facility is operating efficiently, consuming power efficiently, and completing scheduling tasks on time.

Still referring to block 512, the set point can indicate preferred or optimal conditions at which the facility can operate to efficiently complete scheduling tasks and/or achieve/maintain preferred energy consumption levels. If the facility is operating at or below the set point, then the facility may be operating efficiently. If, on the other hand, the facility is operating above the set point, then the facility may not be operating as efficiently as desired or preferred. For example, if the set point is a temperature at which to maintain the facility for food safety and other regulatory compliance measures and the facility is operating at a temperature that exceeds the temperature set point, then food may be spoiled and/or the facility may not be operating efficiently. Operations may need to be adjusted in the facility, such as increasing energy usage of refrigeration systems to reduce the temperature in the facility, activating fans (e.g., at normal power, at higher power settings) to disburse cooler air throughout the facility to reduce the facility temperature(s), etc. in order to lower the facility to the set point. Since such operations need to be performed and consume energy, energy cannot be sold back to the grid at this time. Excess energy, however, can be sold back to the grid at some point in time after the facility is brought to or below the facility set point.

If the facility is operating at or below the set point, the computer system can generate and return instructions to sell the predetermined amount of energy back to the grid during the upcoming energy event (block 514). In other words, the computer system may determine that the facility is operating efficiently and has excess energy that it can sell back to the grid during the energy event to make profit. In some implementations, the computer system can determine that the facility is operating efficiently enough that some portion of the excess energy can be sold back to the grid (e.g., the facility is operating at the set point and has been maintaining the set point value(s) for an extended period of time or at least some threshold period of time). The computer system can determine that the facility is operating at least a threshold amount below the set point, which can cause the computer system to generate and return instructions indicating that the facility can sell back a greater amount of energy to the grid than if the facility were operating at the set point or less than a threshold amount below the set point. The instructions can be transmitted to a computing device of the relevant user, such as a facility manager. The instructions can be presented in one or more of the GUIs described herein. The instructions can be presented as a recommendation in the GUIs, which the user can then select, ignore, or reject. The user can decide whether and how much energy to sell back to the grid based on the instructions and other information presented in the GUIs. In some implementations, the computer system can automatically perform the instructions based on the user selecting the instructions or otherwise accepting the instructions that are presented in the GUIs.

If the facility is operating above the set point, the computer system can generate and return recommendations to control components or assets in the facility to perform operations that satisfy the facility operational set point (block 516). As mentioned above, if the facility is above the set point, then the facility may not be operating efficiently. For example, ambient temperature in the facility may be higher than recommended or required for food safety regulations and/or other requirements associated with items being stored in the facility. As another example, too many vehicles may be operating in aisles, lanes, and other locations in the facility, thereby causing traffic jams and delays in completing scheduling tasks. As yet another example, too few workers and/or vehicles may be operating in the facility, thereby causing delays in task completion. The computer system or a centralized controller of the facility can determine what actions can be performed in the facility to improve facility operations and bring the facility to the set point or below the set point. The computer system can identify which components in the facility can perform those actions and then generate instructions for controlling the components to perform the actions. The computer system can transmit the instructions to the identified components for execution. In some implementations, the computer system can transmit the instructions to a centralized controller of the facility, which can then manage controlling the identified components (e.g., generate and transmit the instructions to controllers of the components, execute the instructions to control the components).

Optionally, the computer system can return or iterate back to block 512. The computer system can continue to monitor conditions in the facility to determine when and if the facility reaches or goes below the set point. Once the computer system determines that the facility has at least reached the set point, the computer system can perform block 514 and provide instructions to sell back energy to the grid (assuming that prices in the energy market are still high and/or the facility can receive profit by selling some portion of their energy back to the grid). In some implementations, if the computer system determines that the facility has at least reached the set point, the computer system can perform one or more of the blocks 502-510. As a result, the computer system can assess whether the facility can profit from selling energy back to the energy grid in light of current energy market and/or facility operational conditions and/or whether modifications can be made to control of facility components in order to improve performance, operations, and/or energy consumption efficiency in the facility.

FIGS. 6A, 6B, and 6C illustrate example graphical user interfaces (GUIs) that can be generated and provided at relevant users' computing devices to present information about forecasted block energy hedges.

FIG. 6A illustrates an example GUI 600, which presents information about forecasted block energy hedges over a predetermined period of time for a particular facility, Facility A. The GUI 600, for example, can display optimal block hedge purchase information for the predetermined period of time using one or more graphical elements or other visual indications. The GUI 600 also includes a menu 602, including controls (e.g., options, buttons, URLs) that the relevant user can select to view other or additional information about a particular facility. For example, the user can select any one of the following controls in the menu 602, which can cause another GUI to be presented at the user's device with the relevant information: Multi Month Exposure, Single Period Analysis, Price Forecast, Load Forecast, Advanced Hourly Parameters, Hedge Trends, and Current Hedges. One or more other selectable controls can also be presented in the menu 602 in the GUI 600 or any other GUIs described herein.

Still referring to FIG. 6A, the GUI 600 can include graphs 604, 606, and 608. The graph 604 can indicate fraction(s) of mean forecasted energy load (e.g., size of a block energy hedge) across an X axis and expected or forecasted energy expenditure(s) across a Y axis. The graph 604 can be generated using the disclosed techniques. For example, energy prices, weather data, historic energy market data, facility data, and other information described herein can be provided as input to a machine learning model, such as a state-space model and/or statistical/time-series model. The state-space model can be constrained by a utility function. The utility function can be determined based on user-inputted optimization parameters, including but not limited to a risk tolerance determined by the user. Refer to FIGS. 6B and 6C for further discussion about the risk tolerance. The model can generate output indicating preferred, recommended, and/or optimal block energy hedge amounts to purchase for the predetermined period of time for the particular facility (e.g., a current month, an upcoming 1 month, an upcoming 2 months, 3 months, 1 week, 2 weeks, 3 weeks, etc.). The preferred block energy hedge to purchase for the predetermined period of time can be visually depicted in the graph 604 with a dashed line 615.

The dashed line 615 can indicate the optimal, preferred, or recommended energy hedge amount to purchase for the predetermined period of time, which can be determined using the disclosed technology and based on a variety of factors described herein. The preferred energy hedge amount can be indicated as a kilowatt amount of energy to purchase. The preferred energy hedge amount can also be indicated in one or more other numeric values, scales, integers, energy values, and/or currencies. In the example of FIG. 6A, the recommended energy hedge is at 0.9 of the mean forecasted energy load, which is approximately 2,000 kW. The dashed line 615 therefore indicates that Facility A should consider hedging approximately 90% of energy to achieve a preferred usage of energy load and/or energy pricing for the particular period of time.

The graph 604 also can include a portion 605 of the graph that indicates a preexisting block energy hedge for the Facility A. The portion 605 can indicate a quantity and/or price of the block energy hedge that the Facility A has already purchased for the predetermined period of time (e.g., a current month, a past month, an upcoming month, etc.). The portion 605 can be taken into consideration in determining, by the computer system 102 described herein, how much marginal energy can be added on (e.g., purchased) and/or removed (e.g., sold). The determination of the marginal amount can be represented in the graph 604 by a graphical line 640N. Various other information can also be visually represented in the graph 604 using graphical lines 640A-N or other visual indicators. For example, the graphical lines 640A and 640C may represent expected energy spends during the predetermined period of time (e.g., during worst 5% and 1% of outcomes). The line 640D can represent expected spend that the facility would pay over the predetermined period of time. The line 640B can indicate an ideal, preferred, objective, and/or optimal spend of the facility over the predetermined period of time.

The graph 606 indicates probability density, high density intervals, and spot price forecasts for the Facility A during the predetermined period of time. The graph 608 indicates probability density, high density intervals, and monthly energy expenditures for the Facility A during the predetermined period of time. The graphs 606 and 608 can illustrate joint distributions of price and/or load forecasting/predictions made using the disclosed techniques. The graph 606 can, for example, indicate lowest possible load and highest price and/or highest possible load and lowest price, information which can be used by the relevant user to determine whether and what block energy hedges to purchase for and/or over the predetermined period of time.

Still referring to FIG. 6A, the GUI 600 can include an optimization results field 610 and an optimization parameters field 612. The optimization results field 610 can include information determined by the computer system 102 using the disclosed techniques. For example, the optimization results field 210 can indicate one or more preferred, recommended, and/or optimal actions that can be taken at Facility A to benefit from forecasted changes in the energy market, energy prices, scheduling and/or operations at the facility, weather conditions, and/or other conditions that may affect the Facility A. One or more recommendations generated by the computer system 102 using the disclosed techniques can also be presented in the optimization results field 610. The field 610 may additionally include supporting information, which can further help the user make decisions about whether and when to buy and/or sell block energy hedges and/or when and how to adjust schedules, operations, and/or component controls for the Facility A. In the example of FIG. 6A, the optimization results field 610 indicates that the preferred energy hedge amount to purchase represented by the dashed line 615 in the graph 604 is approximately 2,003.3 kW at $105,025.40. The supporting information in the field 610 includes data such as a preferred block total hedge at 90% in kW, any preexisting hedge totals in kW, preferred expected energy spends for the predetermined period of time, preferred 95% worst case expected spends, preferred 99% worst case expected spend, and/or preferred objective function value(s). Any of this information can also be visualized in the graph 604, as described above.

The optimization parameters field 612 can include one or more selectable features, input fields, buttons, controls, etc., that can be used by the relevant user to adjust the forecasts and/or predictions presented in the GUI 600. As illustrative examples, the user can provide input for optimization parameters relating to prices, load forecast, price uncertainty, load uncertainty, price-load correlations, and/or risk tolerance weighting. Refer to FIGS. 7A and 7B for further discussion about the optimization parameters.

FIG. 6C illustrates a GUI 614 with block energy hedge information that is forecasted or predicted by the computer system 102 based on user-inputted risk tolerance levels. In the GUI 614, the user can select a risk weighting parameter 616 from the optimization parameters field 612. Upon selection of the parameter 616, the field 612 can present user-selectable controls for the risk weighting parameter 616. The controls can include one or more sliding scales for utility functions.

The user can provide input in the risk weighting parameter 616 to indicate what they may consider as acceptable and/or unacceptable outcomes (e.g., outcomes in energy price, outcomes in energy amount purchased, etc.). The user-inputted information can be used as a utility function or objective for the state-space model described herein. Sometimes, the user-inputted risk tolerance information can cause a preferred or recommended hedge amount to purchase to be lowered. For example, a higher the risk tolerance of the user, the more tolerant the Facility A may be to volatile or unpredictable changes in the energy market. As another example, if the Facility A has a lower risk tolerance, the model can generate output indicating that the Facility A should pre-buy a greater percentage (e.g., all) of energy needed for the facility when there is a greater likelihood of predictability in the short-run about energy costs and/or energy market volatility. Sometimes, however, different levels of risk tolerance can make it more likely that the Facility A can profit during unexpected, volatile changes in the energy market since the Facility A can sell their block energy hedges. On the other hand, in some implementations, other levels of risk tolerance can make it less likely the Facility A may be able to profit during the unexpected, volatile changes in the energy market since the Facility A may not have the ability to sell their block energy hedges. Various other scenarios are also possible.

In the example of FIG. 6B, the user has used the controls in the risk weighting parameter 616 to indicate a lower risk tolerance level. This user input can be transmitted to the computer system 102 and provided as input to the state-space model with the other information described herein. In some implementations, the user input can be used as a weight to adjust the output that is generated by the model. The computer system 102 can accordingly update the graphs 604, 606, and/or 608 in the GUI 614 and one or more other visual or graphical elements presented in at least the graph 604. For example, in the graph 604, the dashed line 615 indicating the preferred hedge amount to purchase for the predetermined period of time is larger than the preferred hedge amount to purchase that was predicted and presented in the GUI 600 of FIG. 6A.

As shown in the illustrative example of FIG. 6B, when the user lowers the risk tolerance level of Facility A, the Facility A now has more block energy hedges that can be sold back to the energy market, thereby causing the Facility A to profit at high dollar amounts. The updated graphs 606 and 608 also indicate a spike in distribution.

When the user hovers over any of the lines or other portions of the graph 604, a pop-out window 624 can be presented and overlaying at least a portion of the graph 604. In some implementations, the information presented in the pop-out window 624 can instead be presented in a separate window, GUI, and/or field in the GUI 614. The pop-out window 624 can include information about one or more of the lines or other graphical elements presented in the updated graph 604.

FIG. 6C illustrates GUI 626 in which the user has adjusted the risk weighting parameter 616 in the optimization parameters field 612 to be more risk tolerant for Facility A. This user input can be provided to the model(s) described herein. Output generated by the model can be presented in the GUI 626, as shown by the updated graphs 604, 606, and 608. Based on Facility A having a higher risk tolerance than the example in FIG. 6B, the preferred block hedge amount to purchase can be lower, as visually represented by the dashed line 615 in the graph 604.

The graph 604 also includes an objective function line 650, which is determined based at least in part on the user-inputted risk tolerance information for the risk weighting parameter 616. As mentioned above, the user-inputted risk tolerance information can be used as an objective utility function to penalize values that may exceed a predetermined threshold value or range. For example, when the risk tolerance level is dropped below a predetermined threshold value (e.g., mid 200 values), scenarios of purchasing lower block energy hedges may appear less appealing. That behavior can therefore be penalized and thus disincentivized, as shown by the updated graph 604 in FIG. 6B.

FIGS. 7A and 7B illustrate example graphical fields for optimization parameters that can be inputted by a relevant user to adjust forecasting block energy hedges. Referring to both FIGS. 7A and 7B, a graphical input field 700 can be presented in any one or more of the GUIs described herein, such as the GUIs in FIGS. 6A, 6B, and 6C. The field 700 can include an optimization results field 702 and an optimization parameters field 704, as described further in reference to FIGS. 6A, 6B, and 6C.

The optimization parameters field 704 can include selectable parameters that can be used by the relevant user to adjust forecasts/predictions that are determined for a particular facility over a predetermined period of time. In the example of FIGS. 7A and 7B, the optimization parameters field 704 includes the following selectable parameters: prices 706, load forecast 708, price uncertainty 710, load uncertainty 712, price-load correlations 714, and risk weighting 716. User selection of any one or more of the parameters 706-716 can cause the selected parameter(s) field to be expanded in the optimization parameters field 704. The expanded, selected parameter(s) field can include one or more additional user-selectable controls, buttons, sliding scales, or other features for which the user can provide input.

As illustrative examples, the user has selected the price uncertainty 710 parameter, which has been expanded to include input fields for adjusting monthly and hourly factors. As another example, the user selected the price-load correlation 714 parameter, which is expanded to include input fields for adjusting monthly and hourly factors. The price-load correlation 714 parameter can be used to determine and show historic correlations between price and load in the particular facility. Sometimes, there can be a negative correlation between price and load when load is reduced and price increased. In some implementations, a facility that increases its load when energy prices may increase may experience a positive correlation or no correlation at all. Similarly, the load certainty 712 parameter can be used to show historical loads for the facility (or other facilities that may be similar to the facility or share characteristics with the facility, such as type of items in the facility, facility customers, geographic location, types of energy used by the facility, energy markets that the facilities use, etc.) and identify how the facility loads may be affected during future time periods based on the historical loads.

As yet another example, the user selected the risk-weighting 716 parameter, which is expanded to include input fields for adjusting utility factors, as described further in reference to FIGS. 6B and 6C. As another example, the user selected the prices 706 parameter, which is expanded to include input fields for adjusting different aspects of price factors, probability, and/or premiums. The prices 706 parameter can also include a graphical depiction of pricing information based on the user-inputted information.

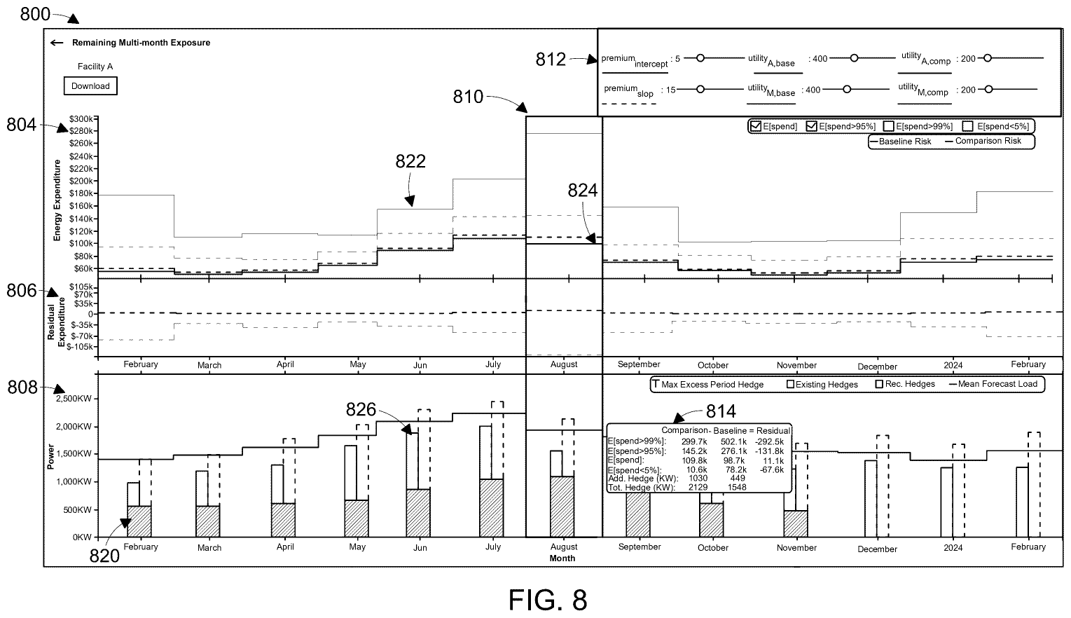

FIG. 8 illustrates an example GUI 800 for presenting forecasted multi-month energy exposure of a particular facility. The GUI 800 includes a menu 802, which is similar to or the same as the menu 602 described at least in reference to FIG. 6A. In this example, the user has selected an option for Multi Month Exposure in the menu 802. In response to the user selection, the GUI 800 can present graphs 804, 806, and/or 808 indicating predicted/forecasted remaining multi-month exposure for the particular facility, Facility A, over a predetermined period of time (e.g., a remaining year, another predetermined quantity of months).

The graph 804 can indicate projected energy expenditure in dollar amounts for the remaining multi-month period of time. The graph 806 can indicate projected residual expenditure in dollar amounts for the remaining multi-month period of time. The graph 808 can indicate projected power in kW for the remaining multi-month period of time. One or more other currencies, energy values, or other types of values can be used in the graphs 804, 806, and/or 808. The predictions that are visually presented in the graphs 804, 806, and/or 808 can be determined by the computer system 102 using the disclosed modeling techniques (e.g., state-space modeling, statistical modeling, time-series modeling). The graphs 804, 806, and/or 808 can be used to look a year into the future for the particular facility and visualize projected optimizations for Facility A during each month.

In the graph 808, solid bars, such as bar 820, can represent block energy hedge amounts that Facility A already has (or is expected to have for a month corresponding to the respective solid bar. Blocks above the solid bars, such as block 826, can represent a recommended or preferred block hedge amount to purchase for the month corresponding to the respective solid bar. In the graph 804, line 822 can represent energy outcomes and line 824 can represent expected energy outcomes. The graph 806 can provide a comparison of, for example, 2 worst case scenarios for Facility A each month over the upcoming year.

Still referring to FIG. 8, the GUI 800 can include an optimization parameters field 812. In the field 812, the user can provide one or more inputs to adjust parameters or other weights that can be used by the computer system 102 described herein to project the energy expenditures, residual expenditures, and/or power for Facility A over the remaining multi-month period of time. As merely illustrative examples, the user can provide input regarding premium and utility factors as optimization parameters. The user can provide input regarding other factors as the optimization parameters described in reference to at least FIGS. 7A and 7B.

In the GUI 800, a portion 810 has been selected or otherwise highlighted to include a portion of each of the graphs 804, 806, and 808. The portion 810 particularly shows predicted energy expenditures, residual expenditures, and preferred block energy hedge amounts for a predetermined period of time between the months of July and September. The user can select one or more other areas of the graphs 804, 806, and 808, which can cause the portion 810 to be presented over the user-selected area(s). In some implementations, a pop-out window 814 can also be presented with information about the selected area of the graphs 804, 806, and 808 in the portion 810.

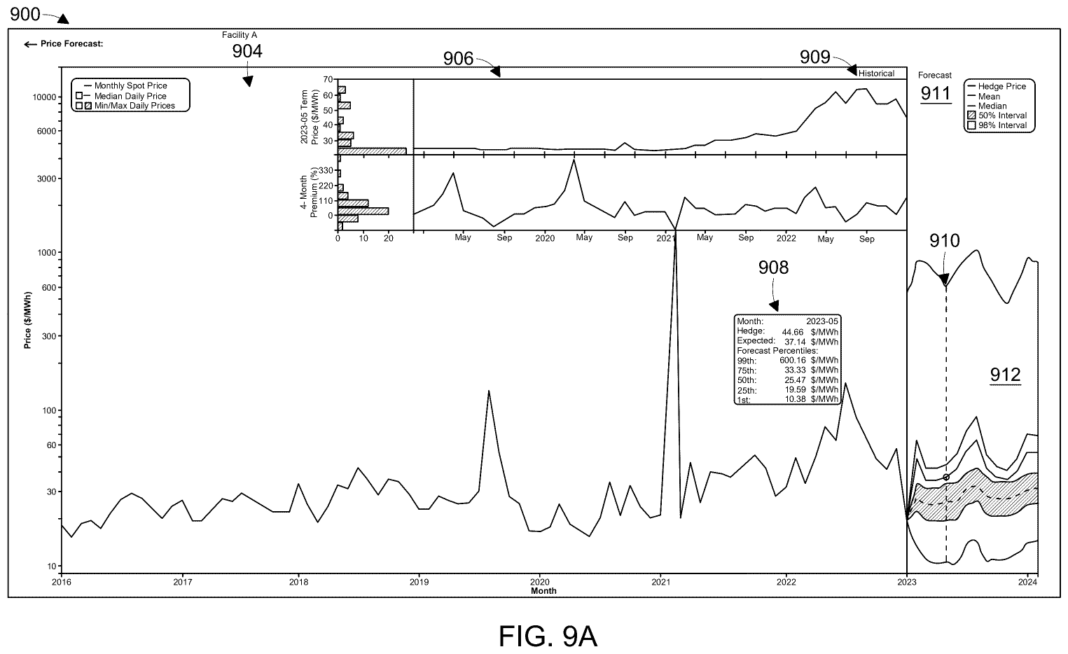

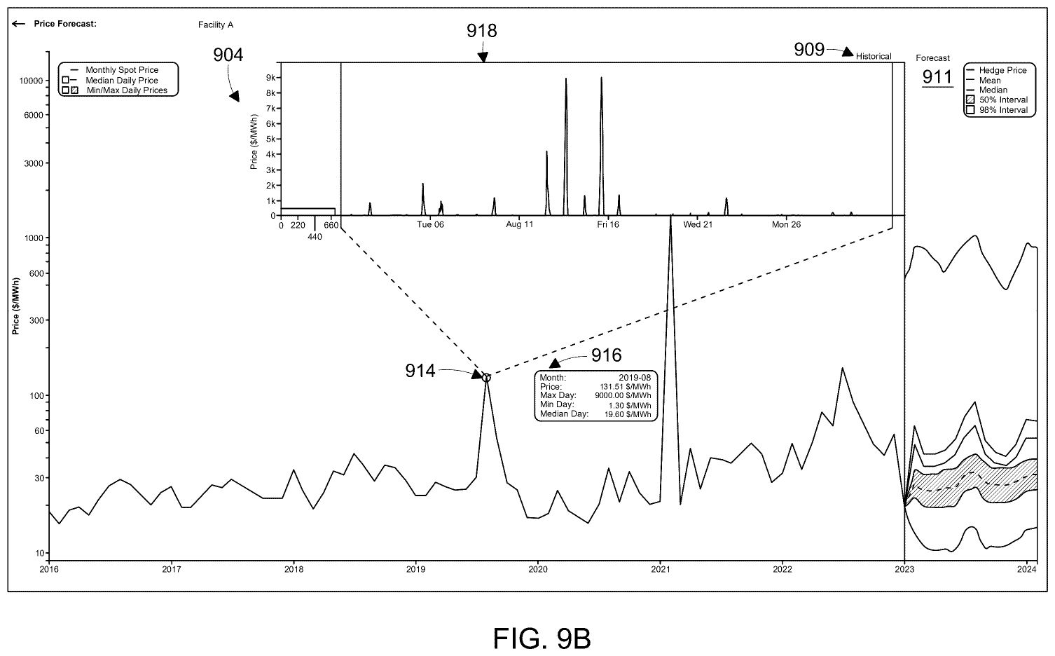

FIGS. 9A and 9B illustrate example GUIs for presenting energy price forecasts for a particular facility over a predetermined period of time. The user described herein can provide input indicating a particular facility to be modeled with the disclosed techniques. The user can also provide input indicating the predetermined period of time for modeling the particular facility. As illustrative examples, the predetermined period of time can include but is not limited to on peak times, such as 6AM-10PM during week days, weekend peak time periods, off peak time periods, such as any times including night, weekends, early mornings, and other time periods that do not include on peak times, and/or around-the-clock all-hour times, including or not including weekends and/or holidays.

As shown in at least FIG. 9A, GUI 900 can include a menu 902, which can be similar to the menus 602 and 802 described at least in reference to FIGS. 6A and 8. In the GUI 900, the user has selected a price forecast option, which causes the GUI 900 to present a graph 904. The graph 904 can indicate forecasted energy prices over a predetermined period of time (e.g., a past period of time, a current period of time, a future period of time, a predetermined quantity of months and/or years, including past, current, and/or future weeks, months, and/or years).

For example, the graph 904 includes a historical energy prices section 909 and a forecasted energy prices section 911. The section 909 can include historical energy market data that is retrieved or received by the computer system 102 using the techniques described herein. The section 911 can include energy prices that are forecasted or otherwise projected by the computer system 102 using the information and modeling techniques described herein (e.g., with state-space modeling techniques, statistical modeling techniques, time-series modeling techniques).

When the user hovers over a line or other element presented in the graph 904 (in either of the sections 909 or 911), a pop-out window 906 can be presented in the GUI 900 that includes additional information about the hovered-over portion of the graph 904. For example, the user can hover over one of the lines in the forecasted energy prices section 911 at line 910, which causes the pop-out window 906 to be presented at least partially overlaying the graph 904 in the GUI 900. The illustrative pop-out window 906 in FIG. 9A includes a graph indicating projected energy prices over a future period of time and a graph indicating projected premium over the same future period of time. The information presented in the pop-out window 906 can indicate projected information from a date corresponding to the line 910. The graphs in the pop-out window 906 can indicate that hedge premium may rise and become more expensive than that prices the real-time energy market is forecasted to settle at. In some illustrative implementations, the pop-out window 906 can display historic information about energy pricing and/or premiums, such as when and/or how much block energy hedges the predetermined facility could have purchased for a current or future operating time so that the facility would only have to pay a predetermined percentage of premium (e.g., X % premium).

Hovering over the portion of the graph 904 indicating by the line 910 can additionally or alternatively cause a second pop-out window 908 to be presented in the GUI 900 in FIG. 9A. The window 908 can include additional projected or forecasted information about the particular portion of the graph 904 that the user hovers over. For example, the window 908 can display information including but not limited to a particular month in the future, a projected block hedge amount for that month, a projected expected hedge amount for that month, and/or forecasted energy hedge amounts for one or more percentiles (e.g., 99th, 75th, 50th, 25th, 1st percentiles).

The forecasted portion 911 of the graph 904 can include a shaded portion 912 of the graph, which may represent a 98% interval for projected block hedge amounts. The forecasted portion 911 can also include projected hedge prices, a mean projected hedge price, a median projected hedge price, and a 50% interval for projected block hedge amounts. The forecasted portion 911 can include one or more additional or fewer features, which can vary based on what inputs and/or optimization parameters are provided to the models described herein for forecasting the energy prices over the future periods of time.

Thus, the forecasted portion 911 can present projected hedge and/or commodity costs for the future period of time, such as the particular month corresponding to the hovered-over portion of the graph 904 and/or a period of time before and/or after the month corresponding to the hovered-over portion of the graph 904.

FIG. 9B illustrates the graph 904 with a pop-out graph 918 displayed over at least a portion of the graph 904. The pop-out graph 918 corresponds to a point 914 on the graph 904 that the user hovers over or selects. Hovering over or selecting the point 914 can additionally or alternatively cause a pop-out window 916 to be presented in the GUI described in reference to FIG. 9A.

The pop-out graph 918 can display historic energy prices over a period of time corresponding to the point 914. The point 914 can for example, be a particular month over a historic period of time. As another example, the period of time presented in the pop-out graph 918 can be a range of dates, weeks, months, or other time period surrounding the particular month and/or date of the point 914. Information presented in the pop-out graph 918 can be used by the relevant user to analyze historic real-time pricing changes during a particular point in time to determine, for future periods of time, when to purchase block energy hedges, when to sell block energy hedges, and/or how much block energy hedges to purchase and/or sell.

The pop-out window 916 can present information about historic energy prices during the particular point in time corresponding to the point 914. For example, the pop-out window 916 can include information such as the particular point in time (e.g., a month, a date), an average, median, and/or mean price for that particular point in time, a maximum price per day during that particular point in time, a minimum price per day during that particular point in time, and/or a median price per day during that particular point in time.

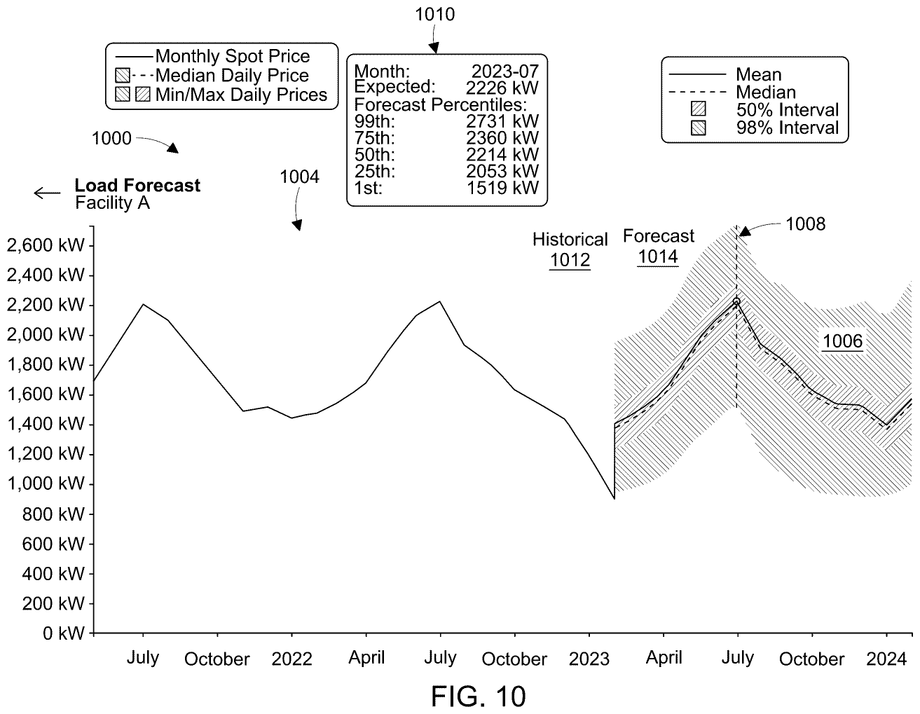

FIG. 10 illustrates an example GUI 1000 for presenting load forecasting information for a particular facility, Facility A. The GUI 1000 can include a menu 1002, which can be the same as or similar to at least the menu 602 described in FIG. 6A. The user can select a control or option in the menu 1002 for Load Forecast, which can cause the GUI 1000 to be presented at the user's computing device. The GUI 1000 can include a graph 1004, which can visually depict predicted energy load information for Facility A over a predetermined period of time. The particular facility and the predetermined period of time can be determined by the relevant user interacting with the GUI 1000, as described above. The predicted energy load information can be determined using one or more of the modeling techniques described herein, such as state-space modeling and/or statistical/time-series modeling described above.

Similar to the graphs described in reference to FIGS. 9A and 9B, the graph 1004 can include a historical section 1012 and a forecast section 1014. The historical section 1012 can indicate load data over one or more prior periods of time, such as a last 2 months, 3 months, 5 months, 6 months, 12 months, etc. The historical section 1012 can visually represent a monthly spot price, a median daily price, minimum daily prices, and/or maximum daily prices for Facility A over the prior periods of time. The computer system 102 described herein can receive or retrieve historic energy load and/or pricing information or data from the data store 106 described herein and then generate the historical section 1012 of the graph 1004 using that information or data. The computer system 102 can also use the retrieved information or data to predict or forecast energy load information over one or more future periods of time. The predicted or forecasted information is then visually presented in the forecast section 1014 of the graph 1004.

In some implementations, the computer system 102 can determine or forecast a statistical distribution of monthly mean spot prices by (i) forecasting price distribution if the month is a typical month and (ii) forecasting price distribution if the month is an atypical month.

The forecast section 1014 can visually present predicted information such as a mean energy load, a median energy load, a 50% interval, and/or a 98% interval over future periods of time. The 98% interval can be presented as a shaded portion 1006 in the forecast section 1014. The user can hover over or select a point along a graphical line (e.g., a line for the mean load, a line for the median load) or other visual element presented in the forecast section 1014 to view additional information about that point. The hovered-over or selected point can be visually represented in the forecast section 1014 as a dashed line 1008.

When the user hovers over or selects the point or any other point in the forecast section 1014 or the historical section 1012 in the graph 1004, a pop-out window 1010 can be presented as overlaying at least a portion of the graph 1004. The pop-out window 1010 can present additional information about the hovered-over or selected point in the graph 1004. In some implementations, the information in the pop-out window 1010 of FIG. 10 can instead be presented in a separate GUI or in another portion or filed in the GUI 1000. The additional information presented in the pop-out window 1010 can include but is not limited to a month or other particular period of time corresponding to the hovered-over or selected point, an expected energy load at that particular period of time, and expected or forecasted energy loads for one or more predetermined percentiles (e.g., 99th, 75th, 50th, 25th, 1st).

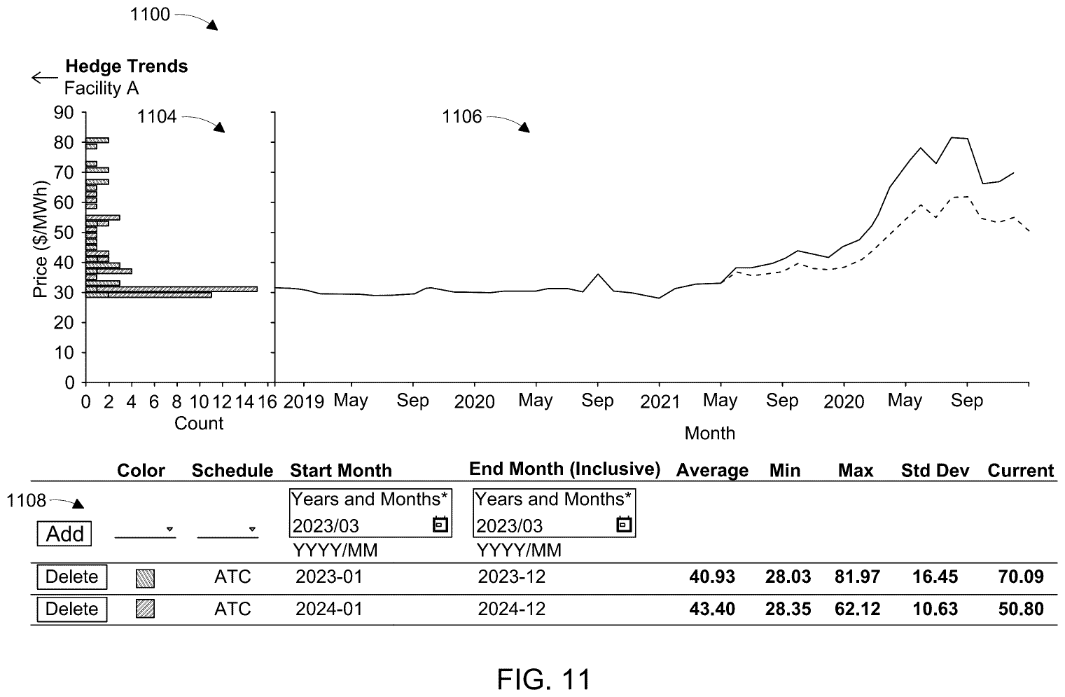

FIG. 11 illustrates an example GUI 1100 for presenting energy hedge trends for a particular facility. The GUI 1100 can include a menu 1102, which can be the same as or similar to at least the menu 602 described in FIG. 6A. The user can select a control or option in the menu 1102 for Hedge Trends, which can cause the GUI 1100 to be presented at the user's computing device.

The GUI 1100 can present graphs 1104 and 1106 that visually represent forecasted energy hedge trends for a particular facility, such as Facility A, over one or more past, current, and/or future periods of time. The GUI 1100 can additionally or alternatively present a table 1108 with information regarding one or more schedules that are presented in the graphs 1104 and/or 1106. For example, the table 1108 can indicate start and end months for one or more schedules associated with Facility A, including but not limited to average, minimum, maximum, standard deviation, and current energy hedge prices for each schedule. Such information can also be reflected in the graphs 1104 and/or 1106.

In some implementations, an end point of the graph 1106 can be an upcoming operating time of Facility A. Therefore, the graph 1106 can present projected energy hedge prices over some period of time leading up to the upcoming operating time of the Facility A. The user can view the projected energy hedge prices and determine when they should purchase and/or sell energy hedges before their upcoming operating time. In the illustrative example of FIG. 11, energy hedge prices are expected or otherwise projected to increase closer to the upcoming operating time of Facility A. The user can determine that energy hedges should be purchased farther in advance of the upcoming operating time of Facility A to avoid projected higher prices for the amount of energy needed by Facility A to complete their operations and/or schedules during the upcoming operating time. For example, the user may determine that they can purchase all of Facility A's needed energy for the year 2023 in January 2019, when the cost of an energy hedge is projected to be approximately $31.30 (see a left end of the graph 1106). On the other hand, if the user decides to wait to purchase until closer to 2023 (a right end of the graph 1106), then the energy hedge prices are projected to increase and be closer to approximately $80. In some implementations, the computer system 102 can automatically determine and recommend particular times at which the user may desire to purchase energy hedges for the year 2023, as described throughout this disclosure.

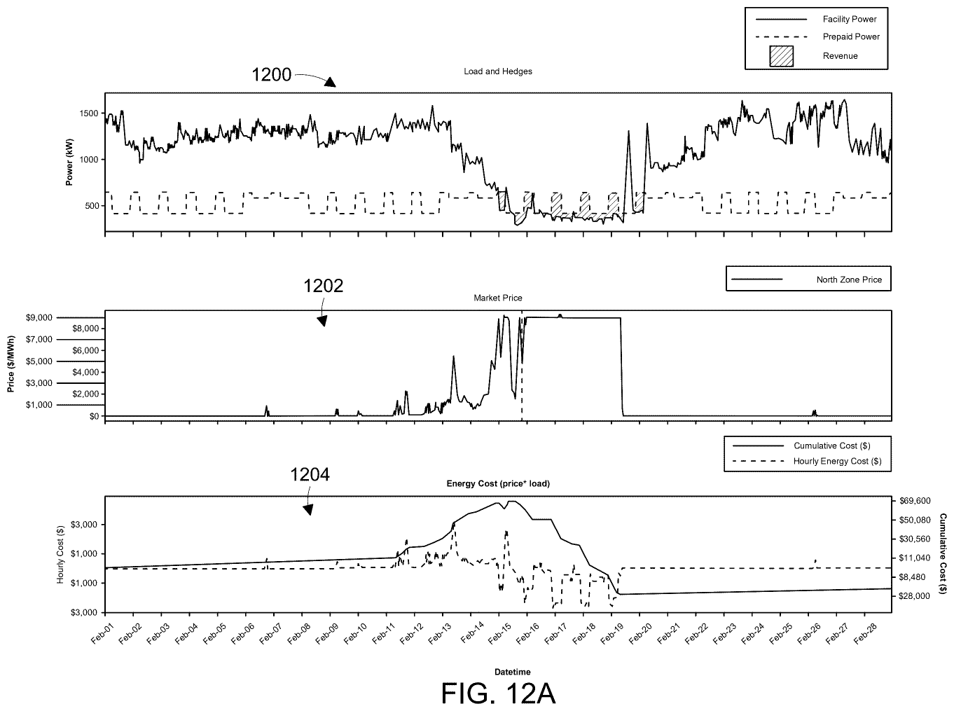

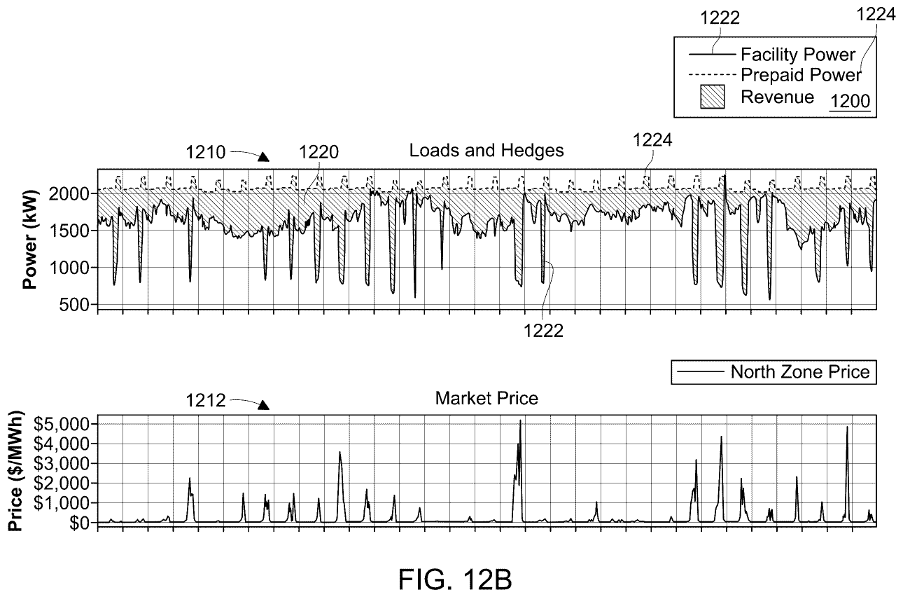

FIGS. 12A and 12B illustrate illustrative use cases of energy loads, hedges, and energy cost during an energy crisis. FIG. 12A, for example, illustrates example energy loads, hedges, and energy costs for a facility during an energy crisis. The use case is visually depicted in graphs 1200, 1202, and 1204.

The graph 1200 illustrates energy load and hedges for the particular facility measured by power (kW) over a particular month. The graph 1202 illustrates energy market prices by price ($/MWh) over the month. The graph 1204 illustrates energy cost (price multiplied by load) by hourly energy cost ($) and cumulative cost ($) over the month. As illustrated with the graphs 1200, 1202, and 1204, the facility made revenue during the days of the month (see the graph 1200) when the energy market price hit highest prices (see the graph 1202), hourly energy costs spiked up and down, rather than remaining relatively constant (see the graph 1204), and cumulative facility costs increased, rather than remaining relatively constant (see the graph 1204). The facility was able to profit during the days of the month when the energy market price hit the highest prices because the facility was able to reduce its overall consumption of power during that time period while still having prepaid power that they could sell back to the energy market at the highest prices. In other words, the facility may have efficiently utilized its prepaid power before the crisis so that when the crisis hit, the facility had remaining energy that was already purchased but not yet used by the facility, which therefore could be sold back to the energy market as a difference of what the facility originally paid and the market price at the time of selling.

By projecting the changes in energy prices shown in the graph 1202, the facility was able to proactively purchase and consume energy to satisfy its operational and/or energy objectives before the energy crisis occurred. In some implementations, the facility, relevant user, and/or computer system 102 can strategize (or recommend) to reduce overall load and/or operations in advance of or at a time of the projected energy crisis (which can sometimes include going below a block hedge amount for the facility) so that the facility can sell power back to the energy market during the crisis when the energy prices are projected to be high. In some implementations, the user or the computer system 102 described herein can weigh expected energy price premiums against a probability that energy prices may increase (e.g., skyrocket, hit all-time highs, exceed predetermined threshold energy prices or levels) so that the corresponding facility can reduce its energy load during the projected energy crisis and make profit by selling energy back to the energy market during the projected energy crisis.

As yet another example, during a different month for that facility (e.g., during summer months), energy prices can historically peak for I-6 hours during afternoons. The disclosed technology can be used to reliably and accurately predict such conditions during the summer to recommend the facility reduce or otherwise avoid using energy loads in the summer afternoons. The facility can proactively adjust its schedules, operations, and/or component controls to avoid energy usage and/or purchase during the summer afternoons. Energy market conditions, energy grid conditions, and/or energy grid outages that may be experienced in other geographic regions may cause facilities in the other geographic regions to have less flexibility and/or predictability in future energy load usage and/or pricing. Therefore, predicted future energy loads and/or prices may vary or fluctuate based on the facility, which may also cause computer-generated recommendations about when to consume, save, buy, and/or sell energy to be fine-tuned based on the unique conditions and/or information of a particular facility.

FIG. 12B similarly shows energy consumption, hedging, and market price behavior over time for a facility in graphs 1210 and 1212. More specifically, the graphs 1210 and 1212 illustrate a hedging and demand response strategy: the facility prepays for more energy than it consumes, then sells back excess energy during market spikes, thereby generating revenue while load reductions can be timed to avoid peak pricing and maximize returns.

The graph 1210 illustrates power levels over time. In the graph 1210, facility power 1222 indicates actual power usage of the illustrative facility over time. It fluctuates significantly, with several sharp drops, which can be due to demand curtailment and/or operational shutdowns. Prepaid power 1224 is a relatively steady line in the graph 1210, which represents hedged or prepaid energy for the facility. This can be a fixed amount of power contracted in advance, regardless of real-time consumption, using the disclosed techniques. Revenue 1220 is also shown in the graph 1210 as the area between the facility power 1222 and the prepaid power 1224, when the prepaid power 1224 exceeds the facility load. The revenue 1220 region of the graph suggests financial gain or profit, which can occur from selling excess prepaid energy back to energy markets at times of high pricing.

The graph 1212 illustrates example rela-time market price of energy in a specific zone or region associated with the facility in the graph 1210. Sometimes, the real-time market price can experience intermittent spikes. When the market spikes, for example, if the facility uses less than the prepaid amount of energy, the facility can benefit by selling the difference at a high price (shown by the revenue 1220 in the graph 1210). Timing of sharp facility load drops (e.g., dips in the facility power 1222 can coincide with price spikes, which suggests demand response actions, such as deliberately reducing consumption when prices are high to capitalize on selling prepaid energy or avoiding high market rates. The hedging strategy of the facility (e.g., the prepaid power 1224 in the graph 1210), which is determined using the disclosed techniques, indicates that prepaid energy is consistently above load, thereby allowing for revenue during price volatility in this illustrative example.

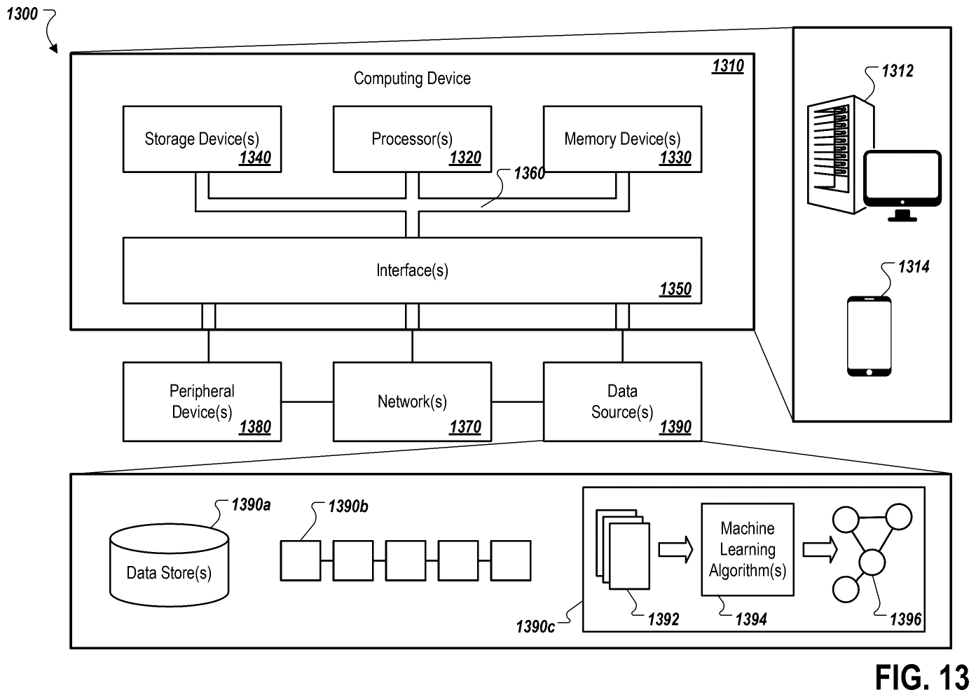

FIG. 13 shows an example of a computing device 1300 and an example of a mobile computing device that can be used to implement the techniques described here. The computing system 1300 includes one or more computing devices (e.g., computing device 1310), which can be in wired and/or wireless communication with various peripheral device(s) 1380, data source(s) 1390, and/or other computing devices (e.g., over network(s) 1370). The computing device 1310 can represent various forms of stationary computers 1312 (e.g., workstations, kiosks, servers, mainframes, edge computing devices, quantum computers, etc.) and mobile computers 1314 (e.g., laptops, tablets, mobile phones, personal digital assistants, wearable devices, etc.). In some implementations, the computing device 1310 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 1310, and an entire system can be made up of multiple devices communicating with each other. For example, the computing device 1310 can be part of a computing system that includes a network of computing devices, such as a cloud-based computing system, a computing system in an internal network, or a computing system in another sort of shared network. Processors of the computing device (1310) and other computing devices of a computing system can be optimized for different types of operations, secure computing tasks, etc. The components shown herein, and their functions, are meant to be examples, and are not meant to limit implementations of the technology described and/or claimed in this document.

The computing device 1310 includes processor(s) 1320, memory device(s) 1330, storage device(s) 1340, and interface(s) 1350. Each of the processor(s) 1320, the memory device(s) 1330, the storage device(s) 1340, and the interface(s) 1350 are interconnected using a system bus 1360. The processor(s) 1320 are capable of processing instructions for execution within the computing device 1310, and can include one or more single-threaded and/or multi-threaded processors. The processor(s) 1320 are capable of processing instructions stored in the memory device(s) 1330 and/or on the storage device(s) 1340. The memory device(s) 1330 can store data within the computing device 1310, and can include one or more computer-readable media, volatile memory units, and/or non-volatile memory units. The storage device(s) 1340 can provide mass storage for the computing device 1310, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 1350 can include various communications interfaces (e.g., USB, Near-Field Communication (NFC), Bluetooth, WiFi, Ethernet, wireless Ethernet, etc.) that can be coupled to the network(s) 1370, peripheral device(s) 1380, and/or data source(s) 1390 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 1350 can include a control interface that receives commands from an input device (e.g., operated by a user) and converts the commands for submission to the processors 1320. The interface(s) 1350 can include a display interface that includes circuitry for driving a display to present visual information to a user. The interface(s) 1350 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 1370 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 1310 can communicate with the peripheral device(s) 1380, the data source(s) 1390, and/or other computing devices over the network(s) 1370. In some implementations, the computing device 1310 can directly communicate with the peripheral device(s) 1380, the data source(s), and/or other computing devices.

The peripheral device(s) 1380 can provide input/output operations for the computing device 1310. Input devices (e.g., keyboards, pointing devices, touchscreens, microphones, cameras, scanners, sensors, etc.) can provide input to the computing device 1310 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 1310 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 1390 can provide data for use by the computing device 1310, and/or can maintain data that has been generated by the computing device 1310 and/or other devices (e.g., data collected from sensor devices, data aggregated from various different data repositories, etc.). In some implementations, one or more data sources can be hosted by the computing device 1310 (e.g., using the storage device(s) 1340). In some implementations, one or more data sources can be hosted by a different computing device. Data can be provided by the data source(s) 1390 in response to a request for data from the computing device 1310 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 1390a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 1390b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 1390c. The machine learning system(s) 1390c, for example, can be used to analyze data from various sources (e.g., data provided by the computing device 1310, data from the data store(s) 1390a, data from the blockchain(s) 1390b, and/or data from other data sources), to identify patterns in the data, and to draw inferences from the data patterns. In general, training data 1392 can be provided to one or more machine learning algorithms 1394, and the machine learning algorithm(s) can generate a machine learning model 1396. Execution of the machine learning algorithm(s) can be performed by the computing device 1310, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A system for controlling components in a facility based on energy hedges, the system comprising:
a controller configured to control the components in the facility, wherein the controller comprises processors and memory storing instructions that, when executed by the processors, causes the controller to perform a process comprising:
receiving pre-purchased energy hedge information for a period of time;
monitoring real-time energy market conditions based on real-time energy information from an energy grid data source;
generating component control instructions based on current operating conditions, energy capacity of the facility, the pre-purchased energy hedge information, and the monitored real-time energy market conditions; and
executing the component control instructions to cause the components in the facility to perform the operational tasks.

2. The system of claim 1, wherein the controller is configured to generate the pre-purchased energy hedge information based on:
receiving facility information and energy market conditions information for a predetermined period of time;
retrieving, from a data store, a model that was trained to predict energy market conditions over a future period of time;
providing, to the model, at least a portion of the received information as input;
receiving, from the model, output indicating the predicted energy market conditions over the future period of time, wherein the model was trained to predict block energy hedges over the future period of time and quantify energy prices based on the predicted block energy hedges;
generating, based on the output, recommendations for purchasing or selling a portion of the predicted block energy hedges over the future period of time; and
returning the recommendations for purchasing the portion of the predicted block energy hedges over the future period of time.

3. The system of claim 2, wherein returning the recommendations comprises:
transmitting, to a user device, the recommendations and at least a portion of the predicted energy market conditions,
wherein the user device is configured to present, in the GUIs, the recommendations, the at least portion of the predicted energy market conditions, and a recommendation to purchase a predetermined quantity of the predicted block energy hedges over the future period of time.

4. The system of claim 2, wherein based on the model output, the process further comprises:
determining, based on identifying that the facility is operating at or below a facility operational set point, (i) a quantity of the predicted block energy hedges to buy in the energy market and (ii) a segment of time over the future period of time at which to buy the quantity of the predicted block energy hedges.

5. The system of claim 2, wherein the model was further trained to generate output indicating predicted facility load over the future period of time.

6. The system of claim 2, wherein the process further comprises:
determining (i) timing, (ii) quantity, and (iii) cost for purchasing the predicted block energy hedges based at least in part on a joint probability of block energy hedge price and facility load distributions over the future period of time.

7. The system of claim 2, wherein the process further comprises:
determining at least one of (i) a facility operational setpoint to reduce facility load over the future period of time and (ii) component operational setpoints to reduce respective component loads over the future period of time.

8. The system of claim 1, wherein the process further comprises:
determining, based on monitoring the real-time energy market conditions, an upcoming energy event, the upcoming energy event being at least one of an energy shortage and an energy surplus in the energy market;
generating, based on the upcoming energy event and the current operating conditions, a recommendation for a facility adjustment to maintain facility operations at or below a predetermined facility operational setpoint during a time corresponding to the upcoming energy event; and
returning the recommendation to a centralized controller of the facility for automatic execution by components in the facility.

9. The system of claim 8, wherein generating the recommendation comprises determining a threshold amount of energy usage to cut during the time corresponding to the upcoming energy event.

10. The system of claim 8, wherein generating the recommendation comprises determining a threshold quantity of energy hedges of the facility to sell back to the energy market while maintaining execution of the facility operations at or below the predetermined facility operational setpoint.

11. The system of claim 8, wherein generating the recommendation comprises determining a threshold quantity of energy hedges to store during the time corresponding to the upcoming energy event to maintain execution of the facility operations at or below the predetermined facility operational set point.

12. The system of claim 1, wherein the pre-purchased energy hedge information is based on historic energy hedges that were purchased for the facility over a past period of time, operational tasks and facility energy consumption during the past period of time, and energy market conditions during the past period of time.

13. The system of claim 1, wherein the process further comprises determining instructions to purchase or sell energy hedges based on the current operating conditions, the energy capacity of the facility, the pre-purchased energy hedge information, and the monitored real-time energy market conditions.

14. The system of claim 1, wherein the instructions further comprise a duration of time for which the energy hedges are purchased or sold.

15. The system of claim 1, wherein generating the component control instructions further comprises determining a duration of time for controlling the components at a threshold level of the energy capacity of the facility.

16. The system of claim 1, wherein the controller is further configured to:
receive facility information and energy market conditions information, wherein the facility information indicates an amount of energy that was used to control the components in the facility to perform the operational tasks;
determine a quantity of energy hedges to sell back to the energy market based on the amount of energy that was used to control the components in the facility to perform the operational tasks and the market conditions information; and
return a recommendation to sell the quantity of the energy hedges back to an energy market over a future period of time.

17. The system of claim 1, wherein executing the component control instructions comprises adjusting a cooling unit of a refrigeration system to maintain temperature in a first set of storage locations in the facility at or below a threshold temperature level for the period of time.

18. The system of claim 17, wherein the refrigeration system is configured to draw a quantity of energy that is stored by an energy storage system of the facility based on the pre-purchased energy hedge information.

19. The system of claim 1, wherein executing the component control instructions comprises controlling a refrigeration system using energy that is stored by an energy storage system to maintain ambient threshold temperature conditions in the facility in response to predicting an energy shortage over a future period of time.

20. The system of claim 1, wherein executing the component control instructions comprises activating a blast cell to perform item freezing operations using energy that is stored by an energy storage system in response to detecting an energy surplus in the energy market.
